(19) United States
(12) Patent Application Publication
(10) Pub. No.: US 2010/0251143 A1
(43) Pub. Date: Sep. 30, 2010

(54) METHOD, SYSTEM AND COMPUTER PROGRAM FOR CREATING AND EDITING A WEBSITE

(75) Inventors: Charles M. Thomas, Bartlett, TN (US); Tim Ransom, Lakeland, TN (US)

Correspondence Address: ANTOINETTE M. TEASE, P. O. BOX 51016, BILLINGS, MT, 59105, US

(73) Assignee: The Ransom Group, Inc., Lakeland, TN (US)

(21) Appl. No.: 12/412,487

(22) Filed: Mar. 27, 2009

(51) Int. Cl. G06F 3/048

(52) U.S. Cl. 715/760; 715/769

(57) ABSTRACT

A method for creating and editing a website comprising providing an extensible website manager application that allows non-technical users to create and edit websites using website components, providing a developer registry of themes, layouts and blocks created by developers, installing the extensible website manager application on a computer storage medium, utilizing a web service as an interface between the extensible website manager application and a client application, allowing the user to add content to a webpage by dragging and dropping content onto the webpage, allowing the user to edit content on a webpage using a toolset that is physically located on the webpage itself and displaying the webpage to the user in real time during creation and/or editing of the webpage exactly as it will be displayed to end users after it is published. The present invention also encompasses a system and computer program similar to the method described above.

### BACKGROUND OF THE INVENTION

1. Field of the Invention

The present invention relates generally to the field of Websites, and more specifically, to a method, system and computer program that allows non-technical users to create and edit a website and to view their changes to the site in real time.

2. Description of the Related Art

Establishing and managing a web presence can be a frustrating and difficult problem for many people, organizations and small businesses. In most cases, the user knows what he wants to achieve but does not have the information technology (IT) training, skills or software knowledge to create, manage, control and revise his own website; therefore, most users end up retaining IT professionals to create and maintain websites for them.

Current technologies for building websites are template-based; these technologies have several limitations, however. Very few of these “do-it-yourself” website builders are manageable by a non-technical user. Most of them require some level of technical background and are not effective website self-management solutions for the long run. The current website builders are advertised as simple and easy solutions, but in reality, they do not offer an intuitive process that an average person can use effectively.

Most existing website technologies fall into one of two categories: website builders and content management systems. Existing website builders purport to allow the user to create and manage a website within an easy-to-use, point-and-click, what-you-see-is-what-you-get (WYSIWYG) environment, but they do not provide intuitive interfaces for the user to manage the website, nor do they provide a true WYSIWYG experience. In addition, they currently do not offer much flexibility in terms of the look and feel of the website.

Webpage layouts are typically fixed with dedicated slots for a logo, navigation and content, and the visual appearance of the layout cannot be altered beyond a few minor settings, such as background and text color. Furthermore, graphics included within the overall theme of the website—such as the header graphic—cannot be changed.

Typical website builders often offer “widgets” or blocks that can be added to webpages for specific tasks, such as a calendar, event list, product listing, etc. These widgets, however, are universal to the website builder itself; in other words, no matter which theme the user has chosen for his website, those blocks will always have a pre-defined look, feel and operation and will not be specifically tailored to the user's current theme or layout.

Current website builders fail to deliver a true point-and-click, WYSIWYG environment because at some point, they require the user to enter a complicated administration area to make some form of significant changes to his website or webpage. These types of changes are done using dull, confusing forms outside of the WYSIWYG environment, and may include the following (1) creating a new page and defining its properties (such as title and metatags) or the layout and/or purpose of the page; (2) managing navigational menus; (3) managing files and performing file uploads; (4) adding or removing content blocks on a webpage; (5) editing content. Because existing website builders make significant use of administration tools, they are ultimately as complex as a content management system (CMS) but do not offer the same flexibility or capabilities that a CMS does.

Moreover, existing website builders are often “locked down”; that is, there are no public documents detailing how to develop third party applications for these website builders and no way to extend functionality, add plugins, etc. They are typically not designed to facilitate growth or extensibility. Persons who use website builders, as well as third party developers, have no access to an application programming interface (API) or other interface in which to create new blocks, themes, plugins or other content for utilization by websites within the website builder. This means that there are no options for implementing custom needs for websites build within existing website builders.

Current website builders usually offer a “publish” tool for converting the editable version of the website to flat hypertext markup language (HTML) files, which are then sent by File Transfer Protocol (FTP) to the user's host. Unlike a typical website builder, a CMS dynamically constructs each webpage from the database. Although this process allows greater complexity in terms of the content of the webpage, it is not as efficient (i.e., quick to load) as a flat HTML file.

A CMS typically offers developers the ability to create and manage complex, database-driven websites quickly and easily while providing their clients a feature-rich website that allows the client to maintain and update the website via an “easy-to-use” administration toolset. A CMS is flexible and extensible in that developers can modify and extend the CMS by programming new modules, themes, plugins, etc. Developers have their own local copy of the CMS software and usually have access to all of the source code for the website. New modules can be programmed and added to the CMS with relatively little effort.

Because of the level of access given to developers, however, it is virtually impossible to provide a unified WYSIWYG toolset for managing the content of the finished website. For this reason, CMS's rely heavily on administration tools. The types of administration tools typically provided by a CMS include: (1) creating and managing webpages and their properties (such as title, metatags, etc.); (2) creating and managing categories in which webpages can be stored and from which navigation menus can be constructed; (3) managing and uploading files; (4) managing individual blocks, content and navigation that appear on any given webpage.

Websites that are properly built for a specific CMS usually support “themes” or the ability to change the entire look and feel of the website without affecting the content. The end user has two choices when it comes to themes: use an off-the-shelf theme or hire a developer to create a custom theme. In order to customize the look and feel of a theme, you must have experience with HTML and cascading style sheets (CSS) and must edit source files directly.

With a CMS, it is fairly easy to extend the features and capabilities of an administration toolset to facilitate any custom modules or features added by a developer for a specific website. The downside is that the administration tools appear outside of the WYSIWYG environment, which means that any changes made to the website are made using complex and dull forms outside of the webpage itself. The content you are editing is not displayed as it appears on the webpage, so you have to blindly make changes and hope they appear the way you anticipated. CMS's typically do not provide tools for editing content on the website/webpage itself. Generally, all of the editing takes place in administration tools, making it especially clumsy to arrange content on webpages and to ensure that everything appears the way you desire.

CMS's typically allow users to create content on webpages in the form of modules. Modules may be simple text- and image-based content, or they may be designed to perform complex, dynamic tasks. The output of modules is usually controlled by editing individual properties of the module within an administration tool. For instance, a weather module may be used to display the current temperature and weather conditions in a graphical format. The administration tool for such a module may include a property for the zip code of the locale for which the weather conditions will be displayed and a property for the unit of measurement in which the temperature is displayed.

Ordinarily, to add a module to a webpage, the user has to assign the module to a specific panel (panels make up the layout of each webpage) and then specify on which webpage(s) the module is to appear. Not only is this hard to manage for the user, but it means that the user has to know which webpages contain which panels, or else the developer of the website has to make sure that all layouts contain all the panels from which the user can select. The most significant disadvantage of this approach is that each module must appear within the same panel on every webpage, and more than one module of the same type cannot be added to the same page.

Owners of websites that use a CMS can upgrade their websites themselves by purchasing or installing add-on modules for specific tasks (such as a poll, comment form, weather widget, calendar, etc.) that are developed by third parties. These add-ons have a pre-defined output, however, making it difficult for developers to control how the add-ons appears on the website.

Another drawback of CMS's is that they do not truly “publish” the website. Instead, each webpage is constructed dynamically from the content within the CMS database each time it is requested. Changes to the website are not converted to flat HTML files but instead remain in the form of the same scripts and database that were used to create the content. As a result, performance is adversely affected because all of the administration tools, modules, scripts, etc. used to edit the website are integrated into the website itself. This also means that the website can never be segregated from the CMS. By contrast, if the website were published outside of the CMS environment (for example, as in the present invention), then only the scripts, HTML and media needed for the website would be published and could be edited directly. CMS's often employ “caching” techniques to avoid having to dynamically construct each webpage request; such techniques are equivalent to storing a published version of the webpage within the CMS database. A script is required, however, to dynamically access and deliver the webpage's cache, which is still not as efficient as a true published flat HTML file for the webpage.

The present invention combines the advantages of existing website builders and CMS's without the disadvantages of either system. The present invention offers non-technical web users the ability to create and manage a website in an easy-to-use, true WYSIWYG environment.

### BRIEF SUMMARY OF THE INVENTION

The present invention is a method for creating and editing a website comprising providing an extensible website manager application that allows non-technical users to create and edit websites using website components, wherein the website components comprise themes, layouts and blocks; providing a developer registry of themes, layouts and blocks created by developers and managed by the extensible website manager application; installing the extensible website manager application on a computer storage medium; utilizing a web service as an interface between the extensible website manager application and a client application, wherein the client application provides a graphical user interface for the web service; allowing the non-technical user to add content to a webpage by dragging and dropping content onto the webpage; allowing the non-technical user to edit content on a webpage using a toolset that is physically located on the webpage itself; and displaying the webpage to the non-technical user in real time during creation and/or editing of the webpage exactly as it will be displayed to end users after it is published. Preferably, the present invention further comprises creating a user website folder and populating it with a registry file, a webpages folder, a media folder, a media registry file, and a media tags file for each new website created by the non-technical user.

In a preferred embodiment, the present invention further comprises providing a site tools tool palette that is represented as a movable tool palette on top of other HTML elements within a webpage and is accessible to the user, wherein the site tools tool palette is a dynamic HTML element. Preferably, the site tools tool palette comprises a publish site tool that is used to publish the website.

In a preferred embodiment, each webpage within the website is associated with a set of properties, and the site tools tool palette comprises a page properties tool that retrieves the set of properties for a given webpage and allows the user to edit the webpage properties. Preferably, each webpage property has a data format, and the data format of all of the webpage properties is the same.

In a preferred embodiment, the site tools tool palette comprises a preview page tool that displays the webpage as it will appear after it is published. Preferably, a block is a dynamic HTML element, the webpage comprises panel tools and block tools, the site tools tool palette comprises an add to this page tool that allows the user to add blocks to the webpage by clicking on a block icon and releasing it on a specific portion of the webpage, and the release of the block icon creates an instance of the block within the specific portion of the webpage in which the block icon was released.

In a preferred embodiment, the site tools tool palette comprises a delete this page tool that allows the user to delete the webpage. Preferably, the site tools tool palette comprises a create new page tool that allows the user to create a new webpage. The create new page tool preferably comprises a layout chooser that lists layout definitions from which the user selects a layout definition for the website, and wherein the layout definitions are DHTML elements.

In a preferred embodiment, the website comprises multiple webpages, and the site tools tool palette comprises a go to page tool that allows the user to navigate to any webpage within the website. Preferably, the website comprises a set of website properties, and the site tools tool palette comprises a settings tool that allows the user to retrieve and edit the website properties.

In a preferred embodiment, each website property has a data format, and the data format of all of the website properties is the same. Preferably, each webpage within the website is associated with a set of properties, the site tools tool palette comprises a page properties tool that retrieves the set of properties for a given webpage and allows the user to edit the webpage properties, each webpage property has a data format, the data format of all of the webpage properties is the same, and the data format of the webpage properties is the same as the data format of the website properties. The website properties are preferably loaded into a properties dialog that allows the user to make changes to and save the website properties.

In a preferred embodiment, the present invention further comprises providing an edit tools palette that is represented as a movable tool palette on top of other HTML elements within a webpage and is accessible to the user, wherein the edit tools palette is a dynamic HTML element. Preferably, each webpage comprises one or more blocks, each block comprises properties and field values, and the edit tools palette is used to manage the properties and field values of blocks within a webpage. The webpage preferably comprises editable field tools, and when the user clicks a mouse on an editable field tool, the edit tools tool palette becomes active and visible.

In a preferred embodiment, the present invention further comprises providing block tool overlays, wherein a block tool overlay is a graphical toolset for managing a block. Preferably, each webpage has a body HTML Document Object Model element, each block corresponds to a block tool, and the block tool overlay is comprised of one or more HTML Document Object Model elements that are created dynamically using Javascript, appended to the webpage's body HTML DOM element, and configured to be positioned over the block tool that corresponds with the block that is managed by the block tool overlay.

In a preferred embodiment, the webpage comprises one or more panels, each block has a structure and appearance, each block has a block definition, each block definition contains files that describe the structure and appearance of a block, each block definition comprise one or more property files, and the property files are imported to any webpage that references the block definition in one or more of its panels. Preferably, each block comprises one or more fields, and each block is associated with a developer-defined render module that communicates to the extensible website manager application how to display the fields of the block on a webpage.

In a preferred embodiment, blocks are stored in webpage files, each block has a component property, if the component property changes from inactive to active, then the block is moved from the webpage file to a website file and becomes a component, a block instance is created and stored in the webpage file where the block was stored before it was moved to the website file, and the block instance references the component that was used to the webpage file. Preferably, the component appears on every page of the website in the form of a block instance.

In a preferred embodiment, at least one block comprises a field, the field appears on a webpage, the field comprises a css attribute, the css attribute references a CSS property with a value, and the present invention further comprises providing a toolset that allows the user to change the value of the CSS property, thereby causing the webpage on which the field appears to change in real time to reflect the value assigned by the user to the CSS property.

The present invention is also a system for creating and editing a website comprising an extensible website manager application that allows non-technical users to create and edit websites using website components, wherein the website components comprise themes, layouts and blocks, and wherein the extensible website manager application is installed on a computer storage medium; a developer registry of themes, layouts and blocks created by developers and managed by the extensible website manager application; and a web service that acts as an interface between the extensible website manager application and a client application, wherein the client application provides a graphical user interface for the web service; wherein the non-technical user adds content to a webpage by dragging and dropping content onto the webpage; wherein the non-technical user edits content on a webpage using a toolset that is physically located on the webpage itself; and wherein the webpage is displayed to the nontechnical user in real time during creation and/or editing of the webpage exactly as it will be displayed to end users after it is published. Preferably, the present invention further comprises a user website folder that is populated with a registry file, a webpages folder, a media folder, a media registry file, and a media tags file for each new website created by the non-technical user.

In a preferred embodiment, the present invention further comprises a site tools tool palette that is represented as a movable tool palette on top of other HTML elements within a webpage and is accessible to the user, wherein the site tools tool palette is a dynamic HTML element. Preferably, the site tools tool palette comprises a publish site tool that is used to publish the website.

In a preferred embodiment, each webpage within the website is associated with a set of properties, and the site tools tool palette comprises a page properties tool that retrieves the set of properties for a given webpage and allows the user to edit the webpage properties. Preferably, each webpage property has a data format, and the data format of all of the webpage properties is the same.

In a preferred embodiment, the site tools tool palette comprises a preview page tool that displays the webpage as it will appear after it is published. Preferably, a block is a dynamic HTML element, the webpage comprises panel tools and block tools, the site tools tool palette comprises an add to this page tool that allows the user to add blocks to the webpage by clicking on a block icon and releasing it on a specific portion of the webpage, and the release of the block icon creates an instance of the block within the specific portion of the webpage in which the block icon was released.

In a preferred embodiment, the site tools tool palette comprises a delete this page tool that allows the user to delete the webpage. Preferably, the site tools tool palette comprises a create new page tool that allows the user to create a new webpage. The create new page tool preferably comprises a layout chooser that lists layout definitions from which the user selects a layout definition for the website, and the layout definitions are DHTML elements.

In a preferred embodiment, the website comprises multiple webpages, and the site tools tool palette comprises a go to page tool that allows the user to navigate to any webpage within the website. Preferably, the website comprises a set of website properties, and the site tools tool palette comprises a settings tool that allows the user to retrieve and edit the website properties.

In a preferred embodiment, each website property has a data format, and the data format of all of the website properties is the same. Preferably, each webpage within the website is associated with a set of properties, the site tools tool palette comprises a page properties tool that retrieves the set of properties for a given webpage and allows the user to edit the webpage properties, each webpage property has a data format, the data format of all of the webpage properties is the same, and the data format of the webpage properties is the same as the data format of the website properties. The website properties are preferably loaded into a properties dialog that allows the user to make changes to and save the website properties.

In a preferred embodiment, the present invention further comprises an edit tools palette that is represented as a movable tool palette on top of other HTML elements within a webpage and is accessible to the user, wherein the edit tools palette is a dynamic HTML element. Preferably, each webpage comprises one or more blocks, each block comprises properties and field values, and the edit tools palette is used to manage the properties and field values of blocks within a webpage. The webpage preferably comprises editable field tools, and when the user clicks a mouse on an editable field tool, the edit tools tool palette becomes active and visible.

In a preferred embodiment, the present invention further comprises one or more block tool overlays, wherein a block tool overlay is a graphical toolset for managing a block. Preferably, each webpage has a body HTML Document Object Model element, each block corresponds to a block tool, and the block tool overlay is comprised of one or more HTML Document Object Model elements that are created dynamically using Javascript, appended to the webpage's body HTML DOM element, and configured to be positioned over the block tool that corresponds with the block that is managed by the block tool overlay.

In a preferred embodiment, the webpage comprises one or more panels, each block has a structure and appearance, each block has a block definition, each block definition contains files that describe the structure and appearance of a block, each block definition comprise one or more property files, and the property files are imported to any webpage that references the block definition in one or more of its panels. Preferably, each block comprises one or more fields, and each block is associated with a developer-defined render module that communicates to the extensible website manager application how to display the fields of the block on a webpage.

In a preferred embodiment, blocks are stored in webpage files, each block has a component property, if the component property changes from inactive to active, then the block is moved from the webpage file to a website file and becomes a component, a block instance is created and stored in the webpage file where the block was stored before it was moved to the website file, and the block instance references the component that was used to the webpage file. Preferably, the component appears on every page of the website in the form of a block instance.

In a preferred embodiment, at least one block comprises a field, the field appears on a webpage, the field comprises a css attribute, the css attribute references a CSS property with a value, and the present invention further comprises a toolset that allows the user to change the value of the CSS property, thereby causing the webpage on which the field appears to change in real time to reflect the value assigned by the user to the CSS property.

The present invention is also a computer program for creating and editing a website comprising an extensible website manager application that allows non-technical users to create and edit websites using website components, wherein the website components comprise themes, layouts and blocks, and wherein the extensible website manager application is installed on a computer storage medium; a developer registry of themes, layouts and blocks created by developers and managed by the extensible website manager application; and a web service that acts as an interface between the extensible website manager application and a client application, wherein the client application provides a graphical user interface for the web service; wherein the non-technical user adds content to a webpage by dragging and dropping content onto the webpage; wherein the non-technical user edits content on a webpage using a toolset that is physically located on the webpage itself; and wherein the webpage is displayed to the non-technical user in real time during creation and/or editing of the webpage exactly as it will be displayed to end users after it is published. Preferably, the present invention further comprises a user website folder that is populated with a registry file, a webpages folder, a media folder, a media registry file, and a media tags file for each new website created by the non-technical user.

In a preferred embodiment, the present invention further comprises a site tools tool palette that is represented as a movable tool palette on top of other HTML elements within a webpage and is accessible to the user, wherein the site tools tool palette is a dynamic HTML element. Preferably, the site tools tool palette comprises a publish site tool that is used to publish the website.

In a preferred embodiment, each webpage within the website is associated with a set of properties, and the site tools tool palette comprises a page properties tool that retrieves the set of properties for a given webpage and allows the user to edit the webpage properties. Preferably, each webpage property has a data format, and the data format of all of the webpage properties is the same.

In a preferred embodiment, the site tools tool palette comprises a preview page tool that displays the webpage as it will appear after it is published. Preferably, a block is a dynamic HTML element, the webpage comprises panel tools and block tools, the site tools tool palette comprises an add to this page tool that allows the user to add blocks to the webpage by clicking on a block icon and releasing it on a specific portion of the webpage, and the release of the block icon creates an instance of the block within the specific portion of the webpage in which the block icon was released.

In a preferred embodiment, the site tools tool palette comprises a delete this page tool that allows the user to delete the webpage. Preferably, the site tools tool palette comprises a create new page tool that allows the user to create a new webpage. The create new page tool preferably comprises a layout chooser that lists layout definitions from which the user selects a layout definition for the website, and the layout definitions are DHTML elements.

In a preferred embodiment, the website comprises multiple webpages, and the site tools tool palette comprises a go to page tool that allows the user to navigate to any webpage within the website. Preferably, the website comprises a set of website properties, and the site tools tool palette comprises a settings tool that allows the user to retrieve and edit the website properties.

In a preferred embodiment, each website property has a data format, and the data format of all of the website properties is the same. Preferably, each webpage within the website is associated with a set of properties, the site tools tool palette comprises a page properties tool that retrieves the set of properties for a given webpage and allows the user to edit the webpage properties, each webpage property has a data format, the data format of all of the webpage properties is the same, and the data format of the webpage properties is the same as the data format of the website properties. The website properties are preferably loaded into a properties dialog that allows the user to make changes to and save the website properties.

In a preferred embodiment, the present invention further comprises an edit tools palette that is represented as a movable tool palette on top of other HTML elements within a webpage and is accessible to the user, wherein the edit tools palette is a dynamic HTML element. Preferably, each webpage comprises one or more blocks, each block comprises properties and field values, and the edit tools palette is used to manage the properties and field values of blocks within a webpage. The webpage preferably comprises editable field tools, and when the user clicks a mouse on an editable field tool, the edit tools tool palette becomes active and visible.

In a preferred embodiment, the present invention further comprises one or more block tool overlays, wherein a block tool overlay is a graphical toolset for managing a block. Preferably, each webpage has a body HTML Document Object Model element, each block corresponds to a block tool, and the block tool overlay is comprised of one or more HTML Document Object Model elements that are created dynamically using Javascript, appended to the webpage's body HTML DOM element, and configured to be positioned over the block tool that corresponds with the block that is managed by the block tool overlay.

In a preferred embodiment, the webpage comprises one or more panels, each block has a structure and appearance, each block has a block definition, each block definition contains files that describe the structure and appearance of a block, each block definition comprise one or more property files, and the property files are imported to any webpage that references the block definition in one or more of its panels. Preferably, each block comprises one or more fields, and each block is associated with a developer-defined render module that communicates to the extensible website manager application how to display the fields of the block on a webpage.

In a preferred embodiment, blocks are stored in webpage files, each block has a component property, if the component property changes from inactive to active, then the block is moved from the webpage file to a website file and becomes a component, a block instance is created and stored in the webpage file where the block was stored before it was moved to the website file, and the block instance references the component that was used to the webpage file. Preferably, the component appears on every page of the website in the form of a block instance.

In a preferred embodiment, at least one block comprises a field, the field appears on a webpage, the field comprises a css attribute, the css attribute references a CSS property with a value, and the present invention further comprises a toolset that allows the user to change the value of the CSS property, thereby causing the webpage on which the field appears to change in real time to reflect the value assigned by the user to the CSS property.

### BRIEF DESCRIPTION OF THE DRAWINGS

FIG. 1 is a diagram of the main components of the present invention.

FIG. 2 is a diagram of the components of the account management system of the present invention.

FIG. 3 is a diagram of the components of the client graphical user interface of the present invention.

FIG. 4 is an illustration of the site tools tool palette.

FIG. 5 is an illustration of the edit tools tool palette.

FIG. 6 is an illustration of a block tool overlay.

FIG. 7 is an illustration of a dialog window containing tools that allow the user to create a new webpage.

FIG. 8 is an illustration of a dialog window containing tools that allow the user to navigate to any webpage within the current website.

FIG. 9 is an illustration of a dialog window containing tools that allow the user to edit one or more properties.

FIG. 10 is an illustration of the toolset for managing the general properties of a website.

FIG. 11 is an illustration of the toolset for managing the publishing properties of a website.

FIG. 12 is an illustration of the toolset for managing the general properties of a webpage.

FIG. 13 is an illustration of the toolset for selecting a webpage.

FIG. 14 is an illustration of the toolset for managing the search engine properties of a webpage.

FIG. 15 is an illustration of the toolset for setting the values of a field that has a CSS border data type.

FIG. 16 is an illustration of the toolset for setting the values of a field that has a CSS margins data type.

FIG. 17 is an illustration of the toolset for setting the values of a field that has a CSS padding data type.

FIG. 18 is an illustration of the toolset for setting the values of a field that has a CSS font data type.

FIG. 19 is an illustration of the toolset for setting the values of a field that has a CSS background data type.

FIG. 20 is an illustration of the toolset for setting the values of a field within a block that has a class attribute with a value of ‘stylesheet’.

FIG. 21 is an illustration of the toolset for selecting an HTML color value.

FIG. 22 is an illustration of the toolset for selecting a single image from the media of the current website.

FIG. 23 is an illustration of a toolset for obtaining stock photography from a third party.

FIG. 24 is an illustration of the toolset for managing images within the current website that have a trash attribute assigned to them.

FIG. 25 is an illustration of the toolset for adding a new image to the current website.

FIG. 26 is an illustration of the toolset for assigning an image to an HTML img element.

FIG. 27 is an illustration of the toolset for adjusting the alignment of an HTML img element.

FIG. 28 is an illustration of the toolset for adjusting the border of an HTML img element.

FIG. 29 is an illustration of the toolset for adjusting the margins of an HTML img element.

FIG. 30 is an illustration of the toolset for linking a webpage address to an HTML anchor element.

FIG. 31 is an illustration of the toolset for linking a file to an HTML anchor element.

FIG. 32 is an illustration of the toolset for linking a website address to an HTML anchor element.

FIG. 33 is an illustration of the toolset for linking an email address to an HTML anchor element.

FIG. 34 is a flowchart illustrating the process of a registered agent sending a command to and receiving a response from the web service of the present invention.

FIG. 35 is a flowchart illustrating the process undertaken by the web service of the present invention when it is issued a command to output the HTML code for a webpage.

FIG. 36 is a flowchart illustrating the process of accessing the web application client of the present invention.

FIG. 37 is a flowchart illustrating the execution of a login component.

FIG. 38 is a flowchart illustrating the execution of a website chooser component.

FIG. 39 is a flowchart illustrating the execution of a webpage creator component.

FIG. 40 is a flowchart illustrating the execution of an HTTP standard response code 404.

FIG. 41 is a flowchart illustrating the execution of a generic error component.

FIG. 42 is a flowchart illustrating the execution of a webpage content editor component.

FIG. 43 is a flowchart illustrating the execution loop of a panel tool.

FIG. 44 is a flowchart illustrating the execution loop of a block tool.

FIG. 45 is a flowchart illustrating the execution loop of a block tool overlay.

FIG. 46 is a flowchart illustrating the execution loop of a field tool.

FIG. 47 is a flowchart illustrating the execution loop of a field set tool.

FIG. 48 is a diagram of the application folder of the present invention.

FIG. 49 is a diagram of the developer folder of the present invention.

FIG. 50 is a diagram of the user folder of the present invention.

FIG. 51 is a diagram of the user website folder of the present invention.

FIG. 52 is a diagram of the theme definition folder of the present invention.

FIG. 53 is a diagram of the layout definition folder of the present invention.

FIG. 54 is a diagram of the block definition folder of the present invention.

FIG. 55 is a diagram of the account management system application folder of the present invention.

FIG. 56 is a diagram of the author folder of the present invention.

FIG. 57 is a diagram of the product folder of the present invention.

FIG. 58 is a diagram of the website XML format of the present invention.

FIG. 59 is a diagram of the webpage XML format of the present invention.

FIG. 60 is a diagram of the layout XML format of the present invention.

FIG. 61 is a diagram of the panel XML format of the present invention.

FIG. 62 is a diagram of the block XML format of the present invention.

FIG. 63 is a diagram of the block instance XML format of the present invention.

FIG. 64 is a diagram of the field XML format of the present invention.

FIG. 65 is a diagram of the field set XML format of the present invention.

FIG. 66 is a diagram of the field info XML format of the present invention.

FIG. 67 is a diagram of the attribute XML format of the present invention.

FIG. 68 is a diagram of the webpage registry XML format of the present invention.

FIG. 69 is a diagram of the webpage entry XML format of the present invention.

FIG. 70 is a diagram of the media registry XML format of the present invention.

FIG. 71 is a diagram of the image XML format of the present invention.

FIG. 72 is a diagram of the file XML format of the present invention.

FIG. 73 is a diagram of the media tags XML format of the present invention.

FIG. 74 is a diagram of the tag XML format of the present invention.

### DETAILED DESCRIPTION OF INVENTION

A. Overview

The present invention is an extensible website manager (referred to herein as an “XWM”) that incorporates the advantages of a CMS with the convenience of a website builder to provide a system and method for creating a website in a true WYSIWYG environment. All editing takes place directly on the webpages using a concise, simple toolset.

At a high level, both the CMS and the XWM use layouts with “panels” in which “blocks” can be placed, and blocks are the main method for adding and managing content for webpages. The XWM is fundamentally different from a CMS, however, in the manner in which it utilizes blocks and properties. This core difference between block theories has widespread impact on the entire system and is mostly responsible for the capabilities of the XWM over competing products.

The XWM maintains tight control over the format in which blocks are created and stored, whereas a CMS allows the developer to define the format and structure of the blocks. This means that every block in a CMS is different on a core level, whereas all blocks in the XWM share the same format—this is how the XWM graphical user interface (GUI) knows how to construct a WYSIWYG interface for *any* block, and this is how the XWM allows the look and feel of a block to be customized by the user. Additionally, this allows XWM blocks to be arranged, interchanged, nested, and more. To facilitate the needs of developers, the developer can specify the names and types of fields within XWM blocks, and each block is associated with a developer-defined “render module” that communicates to the XWM how to display the block's fields on a webpage.

In the same way that the XWM has made blocks a universal data type within the system, it has also added a universal “properties” feature to webpages, blocks and the website itself. Neither existing website builders nor CMS's take this approach. In the present invention, properties use the same data format as a block; however, properties do not have a render module. The XWM includes a default set of properties for webpages, blocks and websites, but developers can add their own properties to the webpages, blocks and websites that they define. Because all properties share the same data format, the XWM knows how to create a GUI for the end user to set the values for any properties within a website—developers do not have to create custom interfaces.

Some of the features of the present invention with regard to properties include the fact that render modules for blocks can access the block's properties in order to determine how it should be displayed on the webpage. Properties for websites allow the user to adjust the look and feel of the website (with a live preview), as well as set their homepage, publish settings and establish other properties. Webpage properties allow users to set the title, metatags, layout and other properties of specific webpages.

The present invention is specifically geared toward the non-technical user. It allows the non-technical user to control, manage and publish a website without any knowledge of HTML code or previous programming background. Using the present invention, the average user is able to publish a website in less than an hour without technical support. The present invention does not require the user to enter multiple fields of data to establish a webpage look and feel; instead, the present invention allows the user to work intuitively by editing directly on the webpage itself.

Furthermore, the present invention uses editing tools (like Microsoft Word®) that are familiar and common to most users, and text and images are edited in real time, right on the webpage itself, using point-and-click editing. The present invention incorporates a simplified user interface that only displays the information required to make a specific decision (along with the available options). All of the technical actions (linking pages, scaling images, saving and writing the HTML code, etc.) are performed by the present invention without requiring the user to do the actual programming.

The user interface of the present invention is a true drag-and-drop interface in that copy (text) and images can be dragged and dropped anywhere on a webpage. This ability to drag and drop text and images provides greater flexibility than the website builders that only offer “template” webpages. The operation of the present invention is described in greater detail below in reference to the figures.

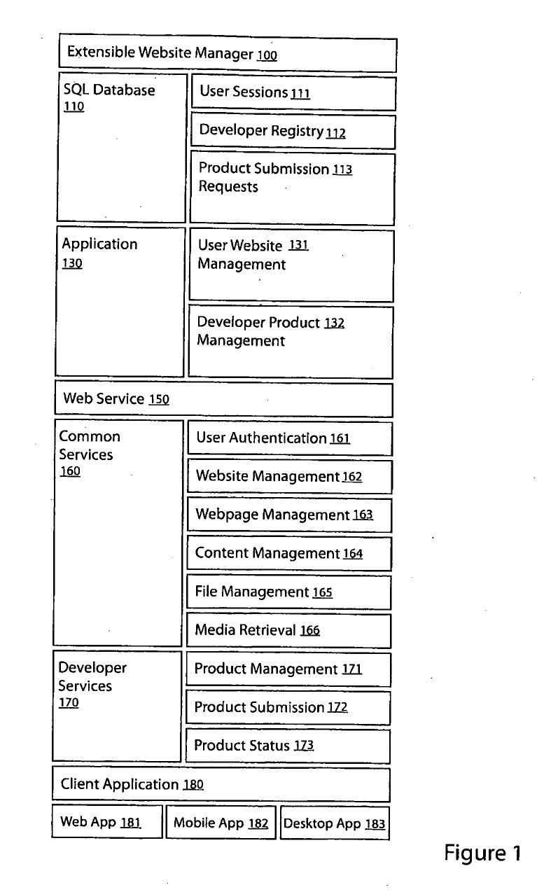

B. System Architecture (FIGS. 1-3)

The present invention (XWM) is comprised of a SQL database and an XWM application. The XWM is responsible for the creation, storage, processing and management of websites and website components such as themes, layouts and blocks.

A Structured Query Language database 110, such as MySQL, is used minimally by the XWM application 130 for simple tasks such as maintaining a record of users who are currently logged into the system, users who have access to create products on the system (developers) and products that have been submitted to be sold online. In a preferred embodiment, a Structured Query Language database, such as MySQL, is used by the XWM application 130; however, a database is not required. User sessions 111 could be handled automatically by some languages such as PHP, and the developer registry 112 product submission requests 113 could be stored by the XWM application 130 in a text file; however, using a database adds flexibility and facilitates easy management of the developer registry 112 and product submission requests 113.

When a user successfully authenticates his username and password via the client application 180, a unique session ID such as a MD5 hash or a random series of characters is generated for the user, stored as a user session 111 in the SQL database, 110 and returned to the client application 180 that initiated the user authentication communication. Before the XWM 100 will process any communication from the client application 180 other than user authentication, the client application 180 must include a session ID as part of its communication. If the session ID is not present within the SQL database 110 or it has expired, the communication will not be processed. Session IDs expire and are removed after a period of user inactivity defined by an administrator within the XWM application's settings.

The developer registry 112 is a simple record of all websites, themes, layouts and blocks created by developers and managed by the XWM application 130 (developer products). A developer may, at any time, using the tools provided by the XWM application 130, request that any of his products be made available for sale online (see product submission 172).

The XWM application 130 facilitates the creation and management of user websites and developer products. The XWM application 130 is installed within a folder on a computer storage medium, such as a hard disk drive. This folder is referred to as the XWM application folder. In addition to being able to perform the tasks outlined below, the XWM application 130 must also have the ability to access, modify or otherwise control the SQL database 110 and XWM application folder. The XWM application 130 acts as standalone software and therefore could be written in any language. In a preferred embodiment, the PHP programming language is used.

User website management 131 is the functionality provided by the XWM application 130 for creating and managing user websites. When a new user website is created, a unique ID is generated and used as the physical name of the folder that is created for the user website within the user's account folder. The user website folder is then populated with support files such as the website file, webpage registry file, webpages folder, media folder, media registry file and media tags file. The XWM application 130 is responsible for creating and managing each of these support files and folders as part of user website management 131. More than one user website may exist for each user, each website being stored in its own folder within the user's personal account folder.

Developer product management 132 is the functionality provided by the XWM application 130 that allows developers to create and manage websites, themes, layouts and blocks, all of which may be placed for sale online and utilized by user websites. When a new developer product is created, a unique ID is generated and used as the physical name of the folder that is created for the developer product within the developer's account folder. Additionally, a record for the product is stored within the developer registry 112. All files created for the developer product by the developer are stored in this folder by the XWM application 130. More than one developer product may exist for each developer, each product being stored in its own folder within the developer's personal account folder.

The web service 150 provides a complete HTTP-based interface to the XWM application 130, allowing a client application 180 to create and manage a fully-functional, multi-page website from start to finish using the web service 150. The web service will invoke commands within the XWM application 130 when processing the HTTP requests from client applications 180. As used herein, the term “HTTP” means Hypertext Transfer Protocol.

Before the web service 150 will process any communication from a client application 180 other than user authentication 161, the client application 180 must include a session ID as part of its communication. If a session ID is not present within the SQL database 110 or the referenced session has expired, the communication will not be processed. Session IDs expire and are removed after a period of user inactivity defined by an administrator within the XWM application's settings.

Typically, the web service 150 is programmed using the same language as the XWM application 130 and is integrated with the XWM application 130 by either compiling the XWM application 130 and web service 150 together as one application or by importing the XWM application 130 libraries at runtime. This allows the web service 150 to directly access and invoke any command within the XWM application 130 when processing HTTP requests. It is possible, however, for the web service 150 to be written in one language—such as PHP—and the XWM application 130 in another—such as C++—and, in this case, the web service could use PHP's system( ) method to indirectly access and invoke the XWM application's 130 commands.

Ideally, the web service 150 is installed on a web server, such as Apache, and made available to remote applications, such as the client application 180, via the HTTP protocol. After receiving a web service request, the web service 150 will execute the command referenced within the web service request and output a web service response. As used herein, the term “web service request” means an HTTP request containing the name of the web service command to be executed and any required data or arguments (referred to herein as a “web service argument”) needed to properly execute the command, and sent to the web service's uniform resource locator (URL) on the web server using the HTTP protocol. As used herein, the term “web service response” means an HTTP response to a web service request that contains an XML-formatted document with information specific to the web service command that was executed, as well as a status code that has a value of ‘1’ (referred to herein as a “success status code”) if the web service command was successfully executed.

In a preferred embodiment, the present invention uses PHP and Apache, making the web service 150 available over the HTTP protocol. The PHP library for the web service 150 dynamically imports the PHP library for the XWM application 130 at runtime, giving direct access of the XWM application's 130 commands to the web service 150.

Alternatively to using the HTTP protocol, the web service 150 could be built as a custom server application written in any language so long as it can accept, process and respond to requests sent from the client application 180 over a network connection. For instance, the web service 150 and XWM application 130 could be compiled as a single C++ application that accepts persistent network connections from the client application 180, and it could use a command/response dialogue akin to the SMTP mail server protocol or a chat room server. So rather than the client application 180 sending single HTTP requests to the web service 150, it could open a single, persistent connection to the web service 150 and then send a series of line-by-line commands to the XWM application 130 server as an ongoing dialogue. A dialogue to get a listing of available commands and then create a webpage (and a demonstration of an invalid command) may look something like:
Web Service: Hello
Client: Commands
Web Service: createWebpage,deleteWebpage,createBlock,deleteBlock, . . .
Client: createWebpage: title=“My Webpage” layout=“2column”
Web Service: ok: webpageID=“83029349541”
Client: listAll
Web Service: error: msg=“Unknown Command.”
Client: bye
Web Service: bye
* connection closed by web service 150

Common services 160 are web service 150 commands that are invoked using a web service request and are made available to standard user accounts and developer accounts and include: user authentication, website management, webpage management, content management, file management and media retrieval services.

User authentication 161 is a common service 160 that takes a username and password as part of the client application's 180 web service arguments, and, if the username and password are valid, a unique session ID such as a MD5 hash or a random series of characters is generated for the user, stored as a user session 111 in the SQL database 110, and returned within the web service's 150 HTTP response to the client application 180.

Website Management 162 is a common service that provides a set of commands that allow the client application 180 to create, modify and delete websites. Webpage management 163 is a common service that provides a set of commands that allow the client application 180 to create, modify and delete webpages.

Content management 164 is a common service that provides a set of commands that allow the client application 180 to create, modify, move and delete blocks within a webpage. File management 165 is a common service that provides a set of commands that allow the client application 180 to upload, modify and delete files within a website.

Media retrieval 166 is a common service that takes the name of a file as part of the client application's 180 web service arguments and, if the specified file exists within the website, returns the contents of the file as the web service's 150 HTTP response.

Developer services 170 are web service 150 commands that are invoked using a web service request, are made available only to developer accounts and include: product management, product submission, and product status.

Product management 171 is a developer service 170 that provides a set of commands that allow the client application 180 to create, modify and delete developer websites, themes, layouts and blocks.

Product submission 172 is a developer service 170 that takes the ID of a developer product as part of the client application's 180 web service arguments, and, if the specified product exists, a product submission request 113 is stored in the database along with the ID of the product. Additionally, the status of the developer product will be updated within the developer registry 112 to reflect that the product has a pending product submission request. An administrator will review and either reject or approve each product submission request 113, after which the product submission request 113 will be removed from the database, and the status of the developer product will be updated within the developer registry 112 to reflect whether the product has been accepted or rejected for sale online by the administrator.

Product status 173 is a developer service 170 that changes the current status of a developer product. It takes the ID of a developer product and the new status as part of the client application's 180 web service arguments and, if the specified product exists, changes the status of the product. A developer product's status can be set to published, rejected or removed.

A published status causes the current version developer product to be copied to a published folder, causing future changes made by the developer to the product to be made to a new copy of the product and not affect the published version. Future product submission requests 172 for this product, if approved, will cause the published version of the product to be replaced by the newest version of the product.

A rejected status may be set to alert the developer that his product has not been published for sale online and that he must make corrections to his product before it will be approved and updated to a published status.

A removed status causes the developer product to become permanently locked from further editing or changes by the developer who owns the product, and the product may no longer be included in product submission requests 172. The developer who owns the product may delete the product from his account or keep it for reference or record-keeping purposes.

A client application 180 is an application that provides a graphical user interface for the web service 150. This allows the user to visually create, modify and interact with his website without the need to know or understand the web service 150.

Because the web service 150 is the sole mechanism used by the client application 180 to interface with the XWM 100, the client application may be built for any platform and with any programming language capable of sending requests to the web service 150. Depending on the capabilities of the platform in question, the client application 180 can support any level of the capabilities offered by the web service 150.

A web application 181 is one example of a client application 180. It is typically programmed using a language such as PHP, ASP or Perl and hosted on a web server such as Apache. The user accesses the web application 181 via a web browser. The web application 181 preferably employs Javascript to send web service requests to the web service 150 and to process the web service responses from the web service 150, thus allowing the user to make updates to his website or product. This approach is commonly referred to as Ajax. The present invention employs this type of client application 180. As used herein, the term “web browser” means a software application that is used to access websites, such as Firefox, Safari or Internet Explorer.

A mobile app 182 is a client application 180 that is developed for specific mobile operating systems and devices, using the programming language supported by each operating system and device. The only technical requirement for a mobile app 182 is that it be able to send web service requests and that it be able to receive and process web service responses.

A desktop app 183 is a client application that is developed for specific operating systems and may be built using any one of a variety of programming languages or desktop authoring software, such as Macromedia Director or Adobe Air, that is then downloaded by the user and installed on his personal computer (PC). The only technical requirement is that it be able to send web service requests and that it be able to receive and process web service responses.

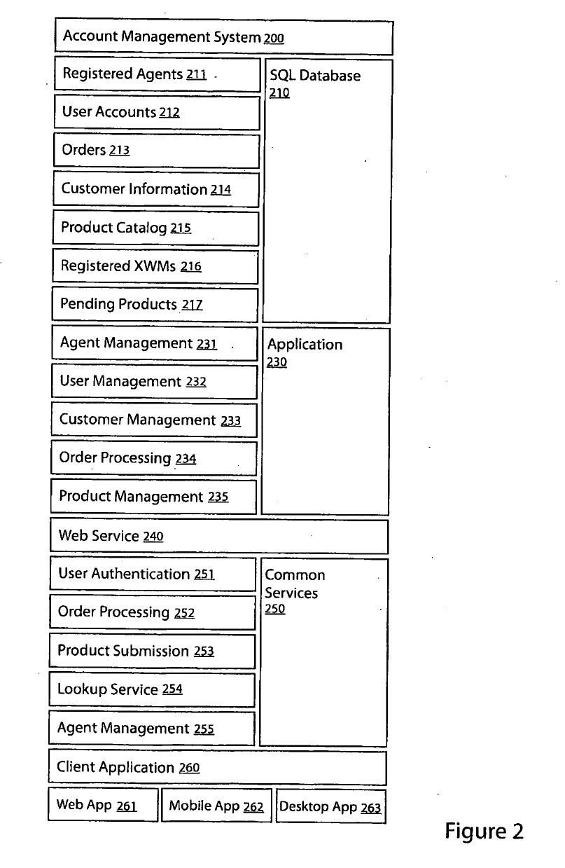

FIG. 2 is a diagram of the components of the account management system (AMS) of the present invention. The AMS is comprised of a SQL database 210, such as MySQL, and an AMS application 230. The AMS is responsible for the creation, storage, processing and management of user accounts, customers, products and orders. The SQL database 210 is used by the AMS application 230 to manage registered agents 211, user accounts) customer information and products as well as record information about purchases made by customers.

A registered agent 211 is a person or computer program, such as an XWM 100 that is allowed either full or partial access to the AMS web service 240. Each registered agent is assigned a unique key, which is used to identify the agent when he sends a request to the AMS web service 240. Information about each registered agent is stored within the SQL database 210, including the agent's unique key, as well as information about the agent and the specific AMS web service 240 commands he can access. If the registered agent 211 is a computer program running on a server, the additional information stored about the agent would be the IP address or host name of the computer and the name of the company that owns the computer. If the registered agent 211 is a person, the additional information stored about the agent would be the person's name, company name and contact information. This additional information is used to contact the registered agent 211 in the event that the unique key is compromised or the agent is abusing the AMS 200. In such an event, the compromised key will be replaced by a new key, stopping any (further) malicious actions from taking place using the compromised key. An AMS 200 administrator determines the level of access each registered agent 211 has to the AMS web service 240.

User accounts 212 are created for all registered agents 211 and customers, as well as for all users and developers who have access to an XWM 100, and are stored within the SQL database 210. Each user account 212 is stored as an entry within the SQL database 210 and, at minimum, contains a unique user ID to identify the user account 212, as well as a username and password. If the user account has access to an XWM 100, the ID of the XWM 100 is also stored within the user account's 212 database entry.

Order 213 records are stored in the SQL database 210 for all orders and financial transactions that have been processed by the AMS 200. Each record includes order information, such as items purchased, date purchased, customer who made the purchase, and payment method used.

Customer information 214 records are stored in the SQL database 210 for each user account 212 that is associated with an order invoice. Each customer information 214 record includes customer information, such as first and last name, phone number, email address and billing address.

Each developer product that is submitted by an XWM 100 and approved by the AMS 200 is stored within the SQL database 210 product catalog 215. Each record includes information such as the name and part number of the product, the ID of the developer who created and owns the product, a summary and description of the product, and the price of the product. The product catalog 215 is queried when performing product listings and processing orders.

Information about each XWM 100 that is managed by the AMS 200 is stored in the SQL database 210 as a registered XWM 216. Each record includes, at a minimum, the IP address or host name of the XWM 100 server, as well as a unique ID and name used to identify and locate the registered XWM 216.

Pending product 217 records are stored within the SQL database 216 for each product submission 253 request received by the web service 240. Each record includes the unique ID that was assigned to the request and the user ID of the registered agent 211 who sent the request.

The AMS application 230 facilitates the creation and management of registered agents, users, customers, orders and products. The AMS application 230 is installed within a folder on a computer storage medium, such as a hard disk drive. This folder is referred to as the AMS application folder. In addition to being able to perform the tasks outlined below, the AMS application 230 must also have the ability to access, modify or otherwise control the SQL database 210 and AMS application folder. The AMS application 230 is standalone software and therefore could be written in any language; in a preferred embodiment PHP programming language is used.

Agent management 231 is the functionality provided by the AMS application 230 for creating and managing registered agents 211 within the SQL database 210. User management 232 is the functionality provided by the AMS application 230 for creating and managing user accounts 212 within the SQL database 210.

Customer management 233 is the functionality provided by the AMS application 230 for creating and managing customer information 212 within the SQL database 210. Order processing 234 is the functionality provided by the AMS application 230 for processing customer purchases. Credit card processing and order placement is managed outside of the AMS 200 via a plugin module; however, upon successfully placing an order, the purchased product is copied from the AMS product catalog 215 to the customer's user folder on the XWM 100, allowing the customer to access, manage and control his purchased product(s).

Product management 235 is the functionality provided by the AMS application 230 for publishing or rejecting a pending product 217 and removing any product currently contained within the product catalog 215. Upon any action such as approval, denial or removal taken on a pending product 217 or an existing product from the product catalog 215, the registered agent 211 who maintains the associated product is notified of the action taken by sending a web service request to the web service 150 containing the product status 173 command and, as part of the web service arguments, the new status of the product.

The web service 240 provides a complete HTTP-based interface to the AMS application 230. The web service 240 will invoke commands within the AMS application 230 when processing the HTTP requests from registered agents 211.

In order for the web service 240 to process any communication from a registered agent 211, the registered agent 211 must include his agent key as part of the communication. If the specified agent key is not associated with any agent within the SQL database 210, the communication will not be processed.

Typically, the web service 240 is programmed using the same language as the AMS application 230 and is integrated with the AMS application 230 by either compiling the AMS application 230 and web service 240 together as one application or by importing the AMS application 230 libraries at runtime. This allows the web service 240 to directly access and invoke any command within the AMS application 230 when processing HTTP requests; however, it is possible for the web service 240 to be written in one language—such as PHP—and the AMS application 230 in another—such as C++—and, in this case, the web service could use PHP's system( ) method to indirectly access and invoke the AMS application's 230 commands.

Ideally, the web service 240 is installed on a web server, such as Apache, and made available to remote applications or users, such as the client application 260 or registered agent 211, via the HTTP protocol. After receiving a web service request, the web service 240 will execute the command referenced within the web service request and output a web service response.

The present invention uses PHP and Apache, making the web service 240 available over the HTTP protocol. In a preferred embodiment, the PHP library for the web service 240 dynamically imports the PHP library for the AMS application 230 at runtime, giving direct access of the AMS application's 230 commands to the web service 240.

Alternatively to using the HTTP protocol, the web service 240 could be built as a custom server application written in any language so long as it can accept, process and respond to requests sent from registered agents 211 and client applications 260 over a network connection. For instance, the web service 240 and AMS application 230 could be compiled as a single C++ application that accepts persistent network connections from the client application 260, and it could use a command/response dialogue akin to the SMTP mail server protocol or a chat room server. So rather than the client application 260 sending single HTTP requests to the web service 240, it could open a single, persistent connection to the web service 240 then send a series of line-by-line commands to the AMS application 230 server as an ongoing dialogue. A dialogue to get a listing of available commands and create a webpage (and a demonstration of an invalid command) may look something like:
Web Service: Hello
Client: Commands
Web Service: createUser,placeOrder,cancelOrder,submitProduct
Client: createUser: username=“new_user” password=“secretpassword”
Web Service: ok: userID=“23472312”
Client: listAll
Web Service: error: msg=“Unknown Command.”
Client: bye
Web Service: bye
* connection closed by web service 240

Common services 250 are web service 240 commands that are invoked using a web service request and are made available to registered agents 211. User authentication 251 is a common service 250 that takes a username and password as part of the web service request, and, if the username and password exist within the user accounts 212, the ID and location of the XWM 100 server associated with the user are returned within the web service's 240 HTTP response.

Order processing 252 is a common service 250 that provides a set of commands for allowing the registered agent 211 to create and process orders. Product submission 253 is a common service 250 that takes the ID of a developer product from an XWM 100 and creates a record for the product within the pending products 217 database table. The record includes a unique ID that is assigned to the request. The ID is returned as part of the web service's 140 HTTP response (see also product submission 172).

Lookup service 254 is a common service 250 that provides a listing of any data that is managed by the AMS application 230 in XML format. The lookup service 254 can be used to retrieve product listings, order histories, financial transaction logs and customer information. In a preferred embodiment, only information that was created by the registered agent 211 requesting the information will be provided by this service. In other words, a registered agent 211 may not request customer information or transaction logs that were created by another registered agent 211.

Agent management 255 is a common service 250 that provides a set of commands for allowing the creation and management of registered agents 211.

The client application 260 is an application that provides a graphical user interface for the web service 240. This allows the user to visually create, modify and interact with his website without the need to know or understand the web service 240.

Because the web service 240 is the sole mechanism used by the client application 260 to interface with the AMS 200, the client application 260 may be built for any platform and with any programming language capable of sending requests to the web service 240. Depending on the capabilities of the platform in question, the client application 260 can support any level of the capabilities offered by the web service 240.

A web application 261 is one example of a client application 260. It is typically programmed using a language such as PHP, ASP or Perl and hosted on a web server such as Apache. The user accesses the web application 261 via a web browser. The web application 261 preferably employs Javascript to send web service requests to the web service 240 and to process the web service responses from the web service 240. This approach is commonly referred to as Ajax. The present invention employs this type of client application 180.

A mobile app 262 is a client application 260 that is developed for specific mobile operating systems and devices, using the programming language supported by each operating system and device. The only technical requirement for a mobile app 262 is that it be able to send web service requests to the web service 240 and that it be able to receive and process web service responses.

A desktop app 263 is a client application that is developed for specific operating systems and may be built using any one of a variety of programming languages or desktop authoring software, such as Macromedia Director or Adobe Air, that is then downloaded by me user and installed on his PC. The only technical requirement is that it be able to send web service requests to the web service 240 and that it be able to receive and process web service responses.

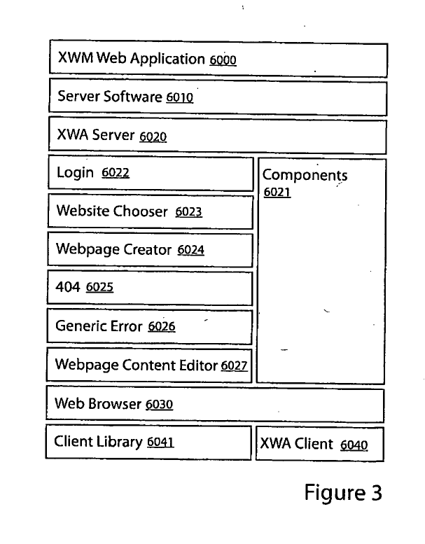

FIG. 3 is a diagram of the components of the client graphical user interface of the present invention. The XWM web application (XWA) 6000 is a web application 181 that provides a single, unified toolset, graphical user interface and WYSIWYG environment for managing a website. The XWA 6000 is divided into two parts: the XWA server 6020 and the XWA client 6040.

The server software 6010 (preferably Apache) processes HTTP communications over a network. The XWA server 6020 provides managed access to the components 6021, as well as unmanaged access to support media (such as images, Javascript and CSS) that are referenced within a component's 6021 HTML. The XWA server is preferably built using PHP and deployed on a server using the Apache server software 6010, making it accessible via a network address and the HTTP protocol.

The components 6021 are written in HTML and Javascript, which provide interfaces to perform specific tasks related to managing a website. The components 6021 that are included with the XWA server 6020 are the login component 6022, website chooser component 6023, webpage creator component 6024, 404 component 6025, generic error component 6026 and webpage content editor component 6027.

The login component 6022 provides an interface for validating a username and password. This component uses HTML to display a form containing username and password fields that, when submitted, uses Javascript to send a request to the user authentication 251 web service.

The website chooser component 6023 provides an interface that allows the user to select which of his sites to edit during his current session. This component uses HTML to display a form containing a listing of each website owned and managed by the user. The website listing is retrieved via a Javascript request to the lookup service 254.

The webpage creator component 6024 provides an interface for creating a new webpage. This component uses HTML to display a form containing a listing of layouts available to the website that the user is currently managing. The layout listing is retrieved via a Javascript request to the lookup service 254.

The 404 component 6025 provides an interface that notifies the user that the requested webpage could not be found. (The term “404 component” is a reference to the HTTP standard response code indicating that the client was unable to communicate with the server, but either the server could not find what was requested, or it was configured not to fulfill the request and did not reveal the reason why.) This component uses HTML to display the notice.

The generic error component 6026 provides an interface that notifies the user that an error has occurred while managing his website. This component uses HTML to display the error.

The webpage content editor component 6027 provides the HTML for a single webpage within the website that the user is currently managing, as well as the Javascript required to launch the XWA client 6040 application, allowing the user to edit the contents of the webpage within a WYSIWYG environment. This component causes the web browser 6030 to display the webpage exactly as it will be displayed to end users after it is published, while allowing the user to edit the contents of the webpage.

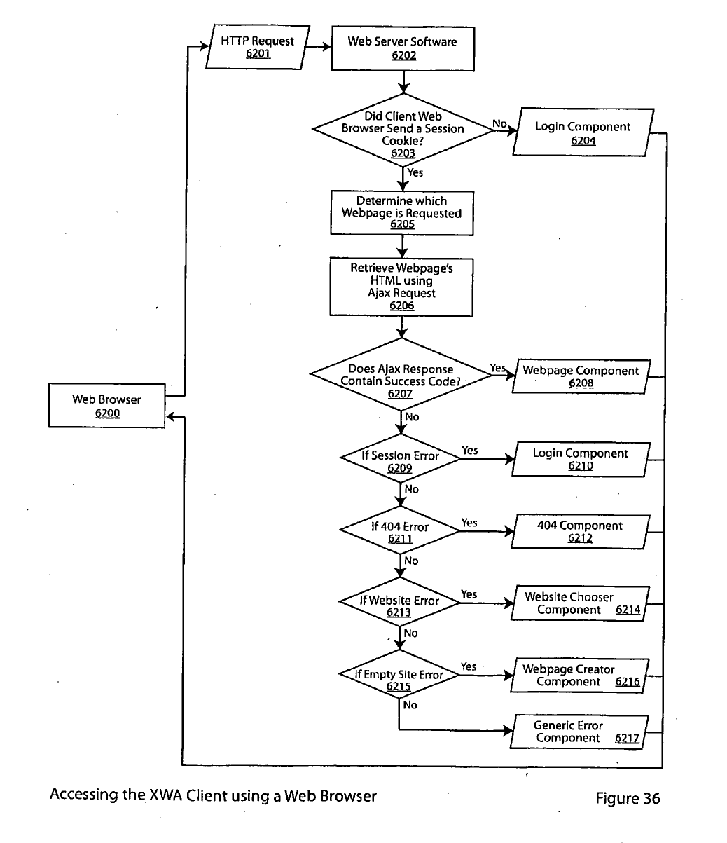

The web browser 6030 is a web browser that supports Javascript, Document Object Model (DOM), cookies and inline HTML editing. The XWA client 6040 is a web browser that requests, receives, executes and displays components 6021 from the XWA server 6020 (see FIG. 36).

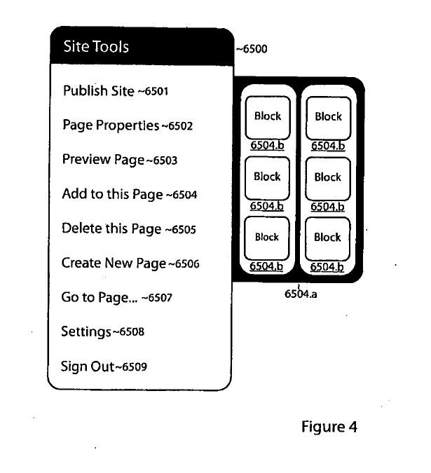

C. Graphical User Interface (FIGS. 4-33)

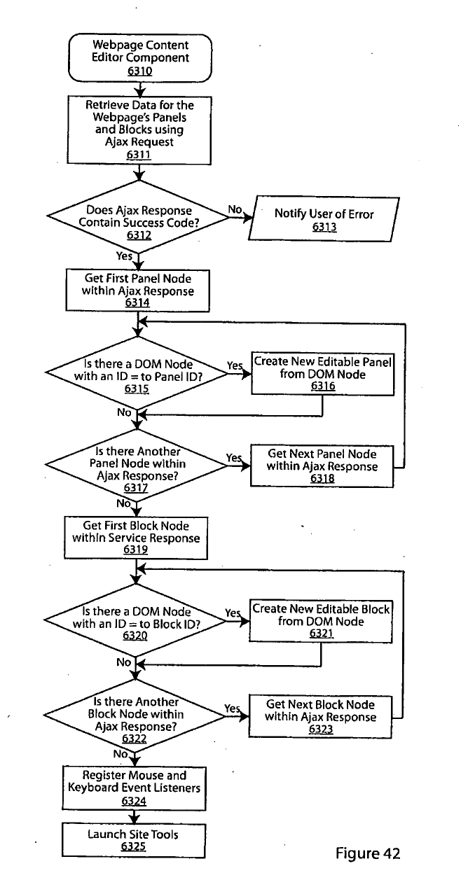

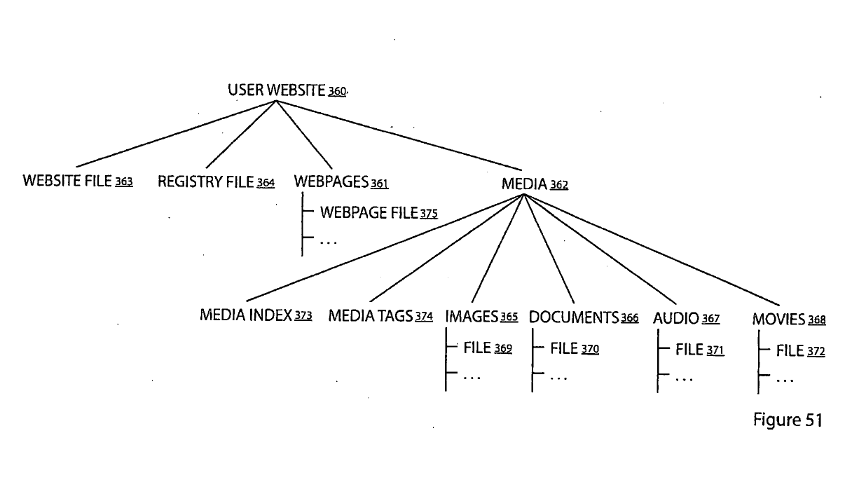

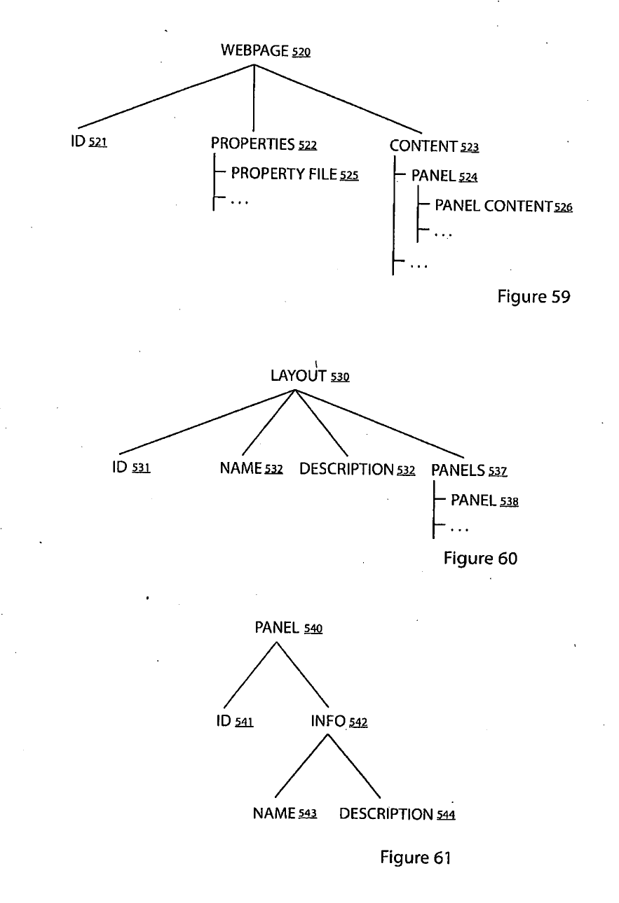

FIG. 4 is an illustration of the site tools tool palette. The site tools tool palette 6500 is a dynamic HMTL (DHTML) element that is represented as a movable tool palette that is always on top of other HTML elements within the webpage and is always accessible to the user. The site tools tool palette gives the user access to many of the low-level capabilities of the XWM application 130 for managing a user website (FIG. 51). As used herein, the term “DHTML element” means an HTML document object model (DOM) node that is dynamically constructed, managed, controlled and displayed using Javascript and that is extended with Javascript methods and properties to support receiving and processing mouse and keyboard events from the user, as well as to support drag-and-drop capabilities. The current webpage is the webpage (see FIG. 59) associated with the webpage content editor component (see FIG. 42) currently being displayed within the web browser.

The publish site tool 6501 preferably uses an Ajax request to publish the current website. If the Ajax response contains a success status code, a message dialog is displayed stating that the website was published; otherwise, a message dialog is displayed stating that the website could not be published. As used herein, the term “message dialog” means a modal dialog that is created and displayed via the Javascript alert( ) function. As used herein, the term “Ajax request” means an HTTP POST request sent to the web service 150 using Javascript. Each Ajax request is accompanied by a_cmd attribute that specified the action to be taken by the web service 150.

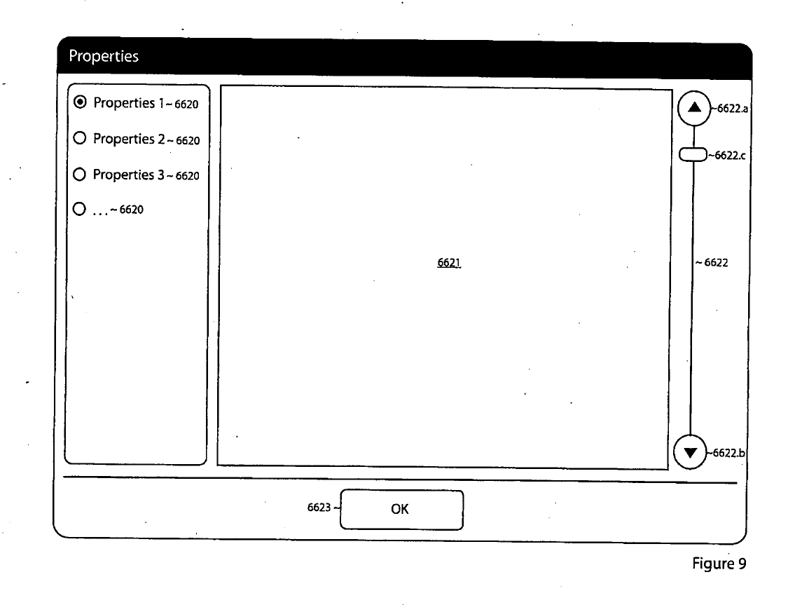

The page properties tool 6502 uses an Ajax request to retrieve the webpage properties for the current webpage. The webpage properties are loaded into a properties dialog (see FIG. 9) where the user can make changes to and save the webpage properties.

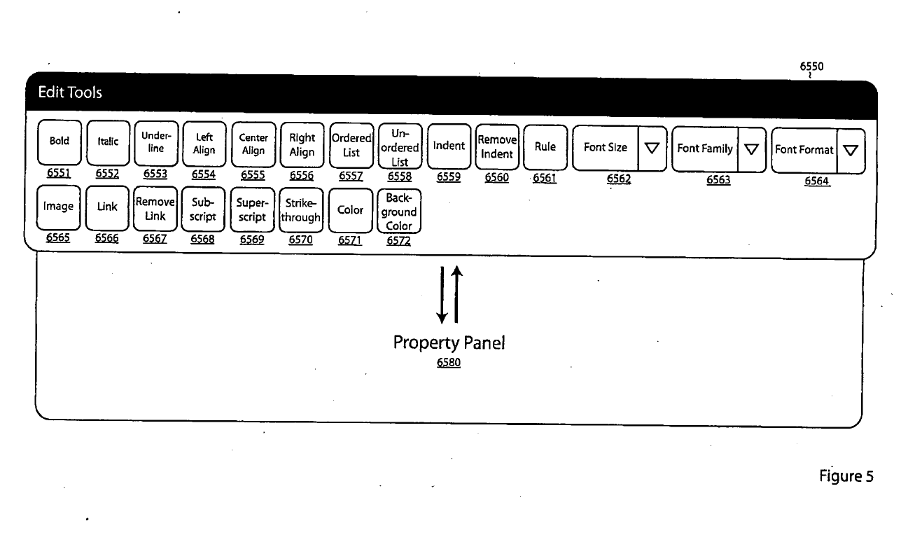

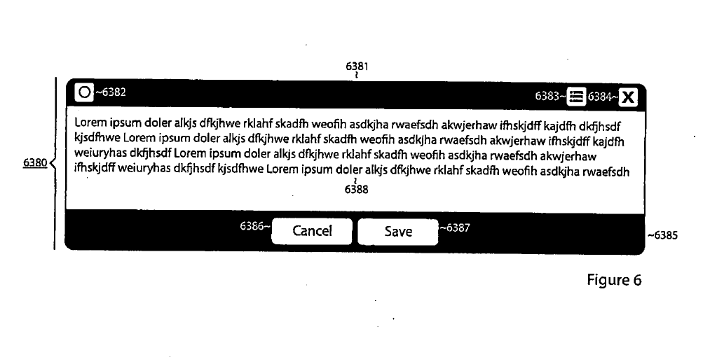

The preview page tool opens the current webpage in a new web browser window and displays the current webpage without the site tools (see FIG. 4), edit tools (see FIG. 5) or block tool overlays (see FIG. 6) enabled. This gives the user an opportunity to see the current webpage as it will appear after it is published.

The add to this page tool 6504 toggles the visibility of the block sidebar 6504.a, which is a set of DHTML elements that gives the user the ability to add new blocks (i.e., content) to the webpage. The block sidebar contains one graphical icon for each block definition that is defined within the theme definition folder that has been loaded by the current user website.

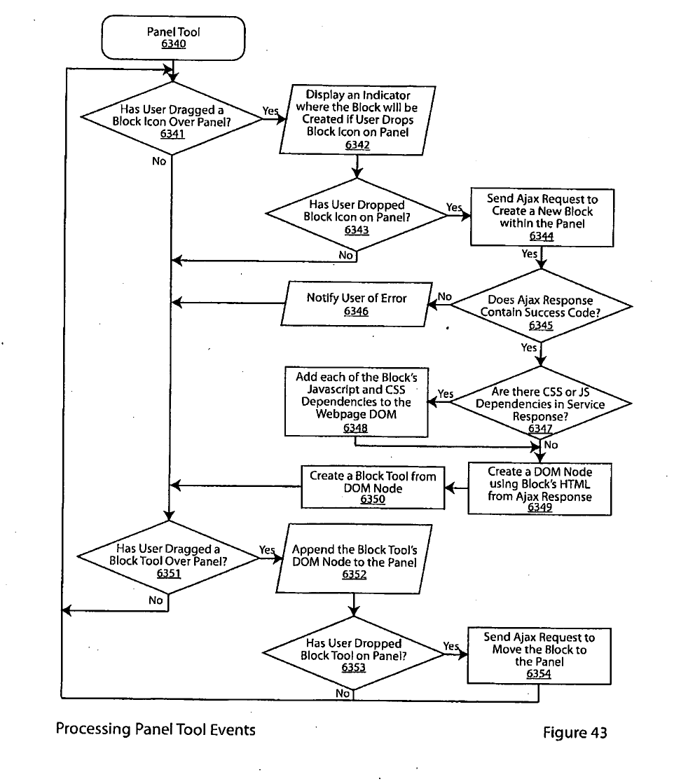

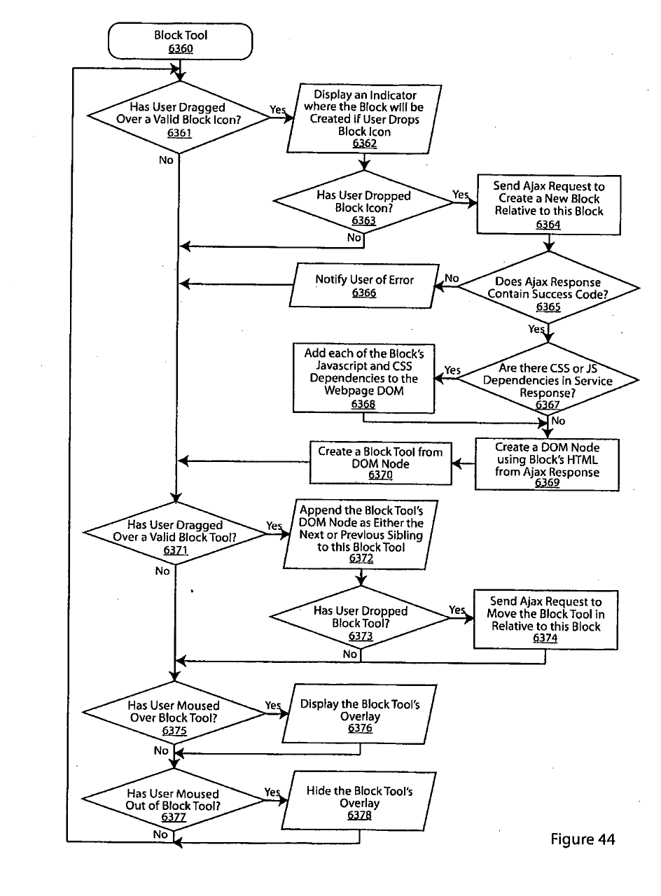

The block icon 6504.b is a graphic icon that represents a single block definition. Block icons 6504.b are DHTML elements that the user can click and drag over any panel tool (see FIG. 43) or block tool (see FIG. 44) within the current webpage. Doing so will create, within the specific portion of the current webpage in which the block icon was released, an instance of the block that is represented by the block icon.

The delete this page tool 6505 uses an Ajax request to delete the current webpage. If the Ajax response contains a success status code, a message dialog is displayed stating that the webpage was deleted; otherwise, a message dialog is displayed stating that the webpage could not be deleted.

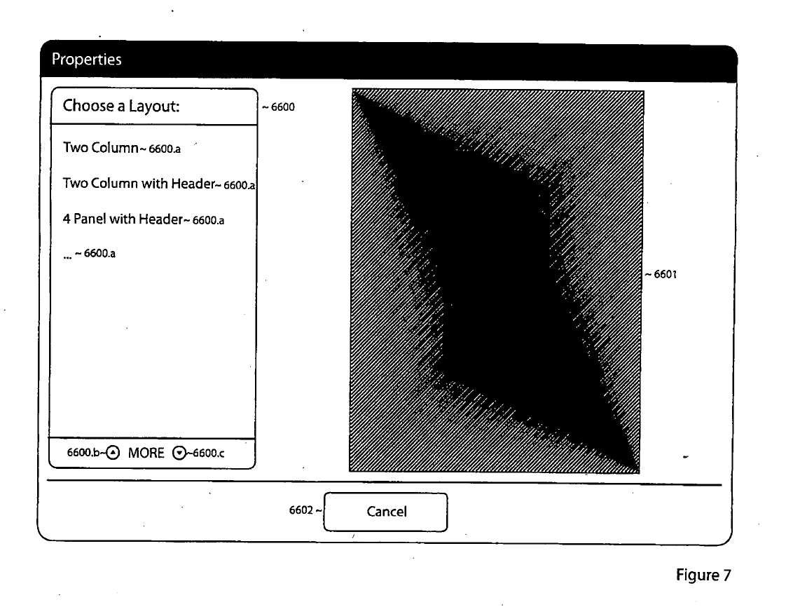

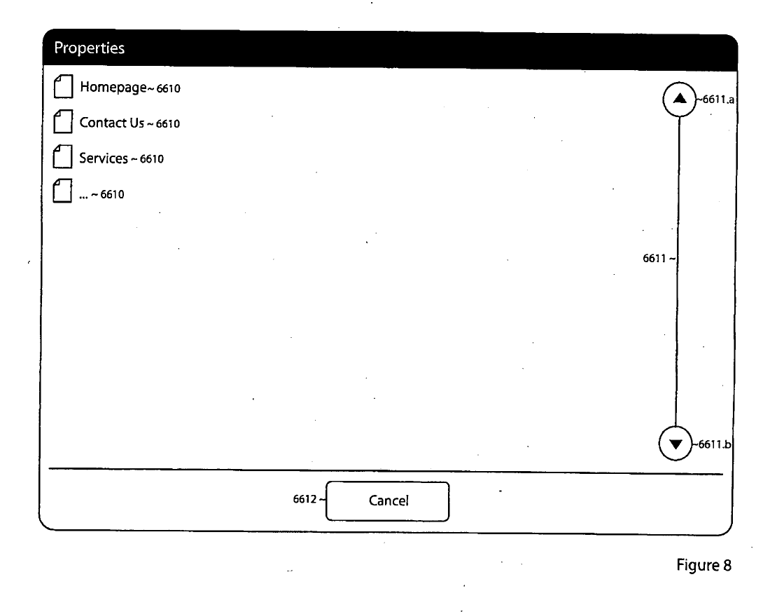

The create new page tool 6506 is shown in FIG. 7 and further described in connection with that figure. The go to page tool 6507 is shown in FIG. 8 and further described in connection with that figure.

The settings tool 6508 uses an Ajax request to retrieve the website properties for the current website. The website properties are loaded into a properties dialog (see FIG. 9) where the user can make changes to and save the website properties.

The sign out tool 6509 uses Javascript to delete the cookie from the web browser that contains the user's login session information. It also uses Javascript to redirect the web browser to the landing page of the XWM web application 6000.

FIG. 5 is an illustration of the edit tools tool palette. The edit tools tool palette 6550 is a set of DHTML elements that form a movable tool palette. When the edit tools tool palette 6550 is visible, it always appears on top of all other HTML elements within the webpage. The edit tools tool palette 6550 gives the user access to many of the capabilities of the XWM application 130 for managing the properties and field values of blocks within a webpage.

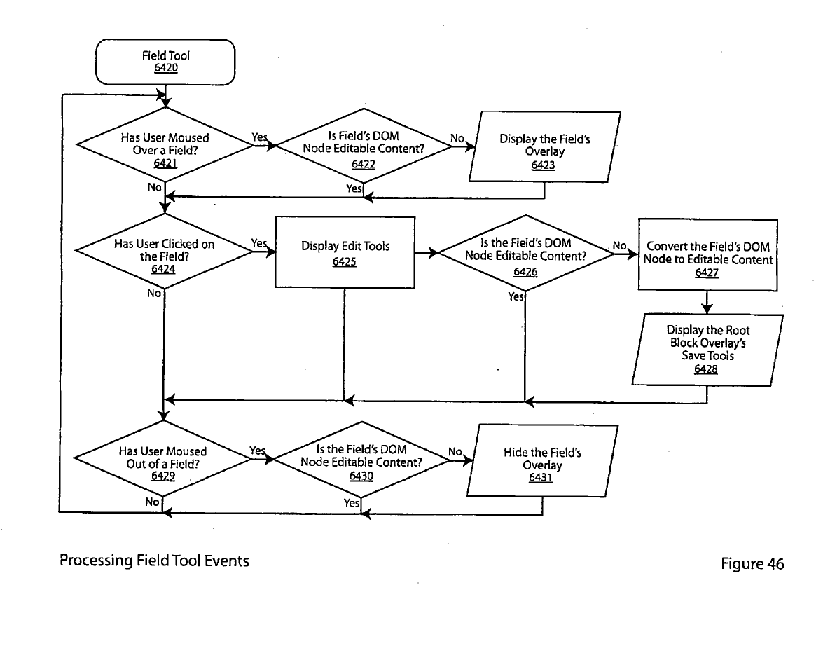

Each of the tools within the edit tools tool palette 6550 has the ability to edit any editable field tool (see FIG. 46) within a webpage. When the user clicks his mouse on any editable field tool, the edit tools tool palette 6550 will become active and visible. When the user clicks his mouse on any HTML element that is not an editable field tool, the edit tools tool palette 6550 will become inactive and invisible.

The edit tool palette 6550 makes use of the execCommand Javascript function that is included within all major web browsers and that, when called, performs an action on the currently selected (highlighted) HTML and text within an editable field tool (see FIG. 46). The specific action performed depends on the arguments that are specified when calling execCommand. If no content is selected, the effect of the command will be applied to any new text that is typed from the current cursor position.

The bold 6551 tool uses execCommand with the argument ‘Bold’ to toggle bold text. The italic tool 6552 uses execCommand with the argument ‘Italic’ to toggle italic text. The underline tool 6553 uses execCommand with the argument ‘Underline’ to toggle underlined text.

The left align tool 6554 uses execCommand with the argument ‘justifyleft’ to left justify text. The center align tool 6555 uses execCommand with the argument ‘justifycenter’ to center text. The right align tool 6556 uses execCommand with the argument ‘justifyright’ to right justify text. The ordered list tool 6557 uses execCommand with the argument ‘insertorderedlist’ to create an ordered list.

The unordered list tool 6558 uses execCommand with the argument ‘insertunorderedlist’ to create an unordered list. The indent tool 6559 uses execCommand with the argument ‘indent’ to indent text or increase the indention of an ordered or unordered list. The remove indent tool uses execCommand with the argument ‘outdent’ to outdent text or decrease the indention of an ordered or unordered list.

The rule tool 6561 uses execCommand with the argument ‘insertHorizontalRule’ to create a horizontal rule. The font size tool 6562 uses execCommand with the argument ‘fontsize’ to adjust the size of text. The font family tool uses execCommand with the argument ‘fontname’ to adjust the typeface of text.

The font format tool 6564 uses execCommand with the argument ‘formatblock’ to adjust the format of text. Formats include, by way of example, Heading 1 (<h1>), Heading 2 (<h2>), paragraph (<p>), and preformatted (<pre>). The image tool 6565 displays options within the tool property panel 6580 for inserting or editing an image within an editable field tool (see FIG. 46). If an HTML img element is selected within an editable field tool when the image tool 6565 is launched, it will launch in edit mode. Otherwise, it will launch in insert mode.

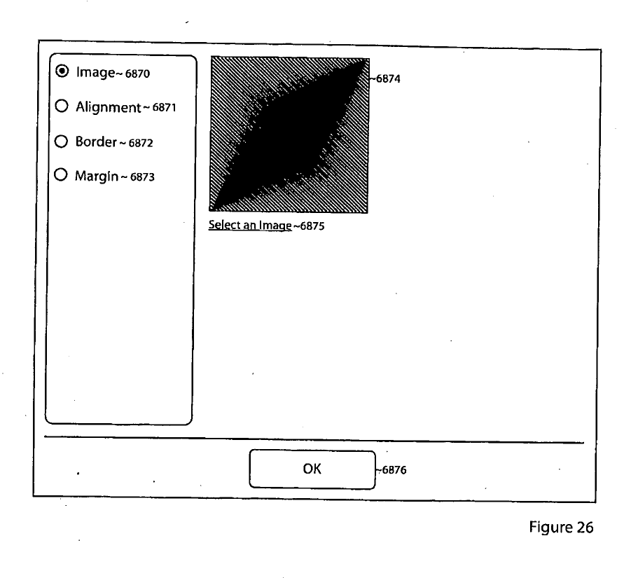

The edit mode launches and displays the toolset for assigning an image file URL to an HTML img element (see FIG. 26) within the tool property panel 6580 and provides to the toolset the HTML img element for the selected image.

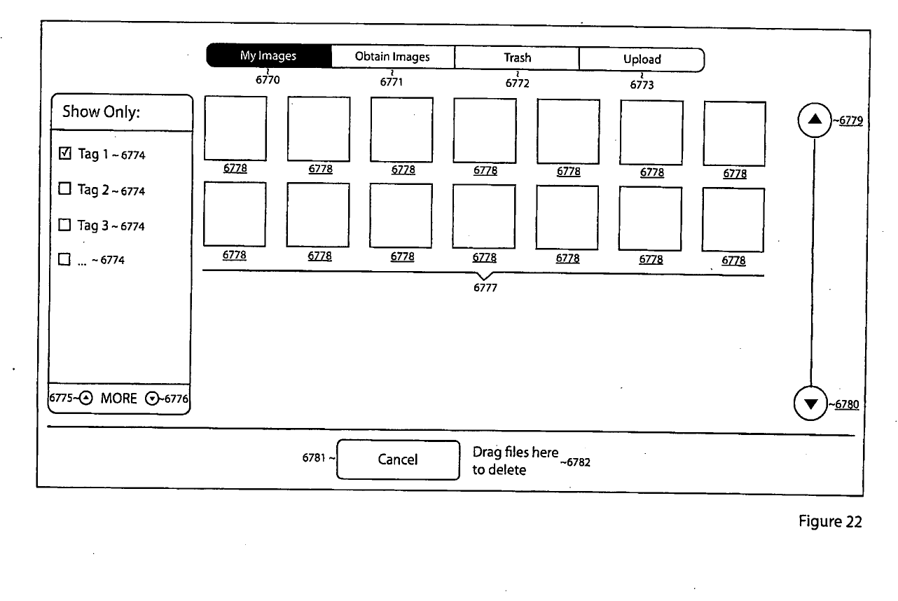

The insert mode launches and displays the toolset for selecting a single image from the media of the current website image (see FIG. 22) within the tool property panel 6580. Upon selecting an image or uploading an image within the toolset for selecting a single image from the media of the current website, execCommand is used with the argument ‘insertimage’ to add the image to the editable field tool (see FIG. 46) at the current cursor position. This tool will then close the toolset for selecting a single image from the media of the current website image (FIG. 22) and then switch to edit mode to allow the user to make adjustments to the image.

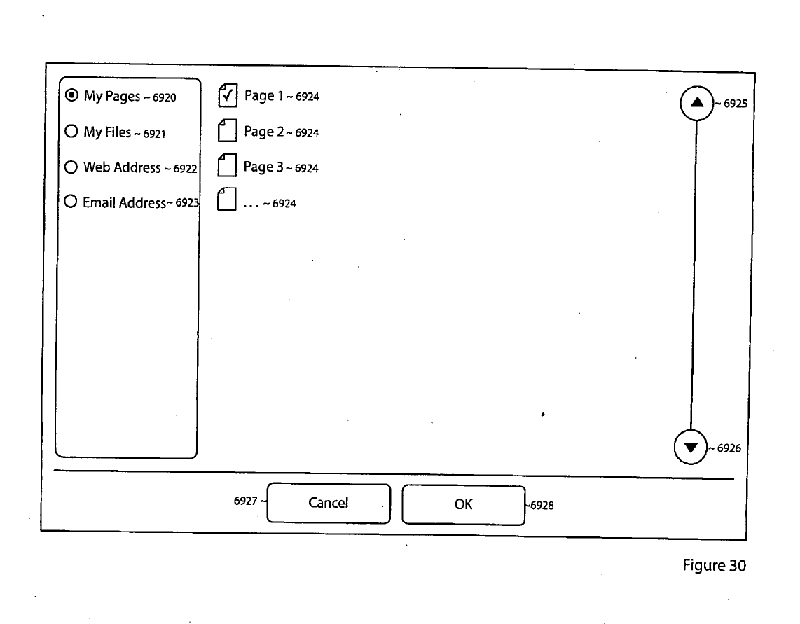

The link tool 6566 displays options within the tool property panel 6580 for assigning a hyperlink to text within an editable field tool (see FIG. 46). If an HTML hyperlink is not selected within an editable field tool when the link tool is launched, it will display the toolset for assigning a webpage address to an HTML hyperlink (see FIG. 30) within the tool property panel 6580. Otherwise, it will launch in one of the following modes:

(1) webpage mode—if the selected link references a webpage, the toolset for assigning a webpage address to an HTML hyperlink (FIG. 30) will be displayed within the tool property panel 6580;

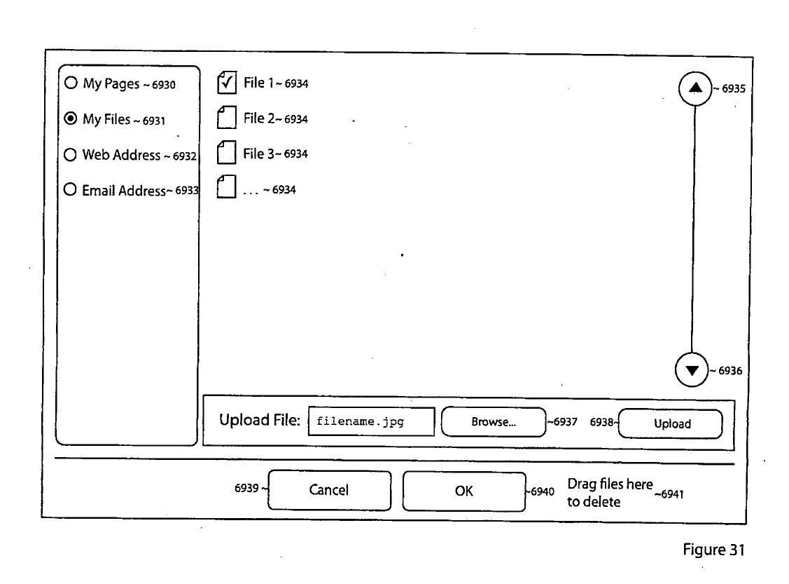

(2) document mode—if the selected link references a file, the toolset for assigning a file to an HTML hyperlink (FIG. 31) will be displayed within the tool property panel 6580;

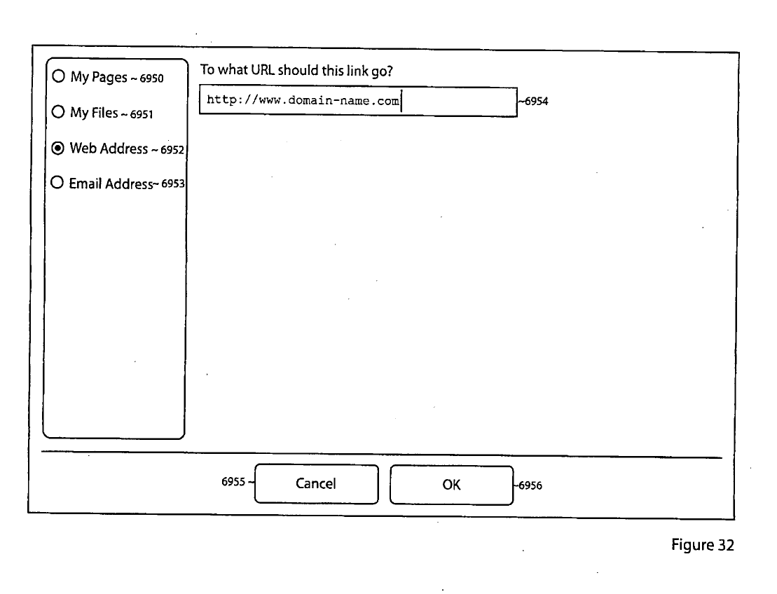

(3) URL mode—if the selected link references a website address, the toolset for assigning a website address to an HTML hyperlink (FIG. 32) will be displayed within the tool property panel 6580;

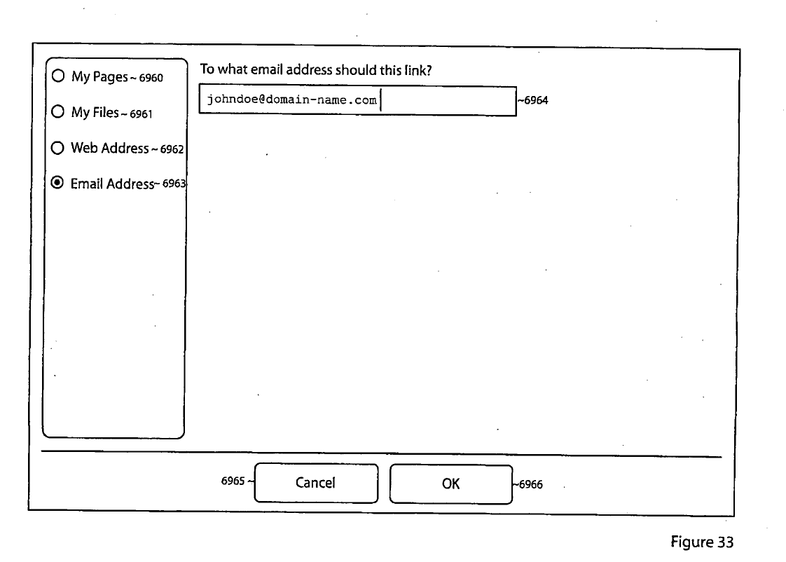

(4) email mode—if the selected link references an email address, the toolset for assigning an email address to an HTML hyperlink (FIG. 33) will be displayed within the tool property panel 6580.

If the user chooses a link using the toolset that was launched in the tool property panel 6580, the link tool 6566 uses execCommand with the argument ‘createlink’ to apply the chosen link to the selected text and then closes the tool property panel 6580.

The remove link tool 6567 uses execCommand with the argument ‘unlink’ to remove a hyperlink from text. The subscript tool 6568 uses execCommand with the argument ‘subscript’ to toggle subscript text. The superscript tool 6569 uses execCommand with the argument ‘superscript’ to toggle superscript text. The strikethrough tool 6570 uses execCommand with the argument ‘strikethrough’ to toggle strikethrough text.

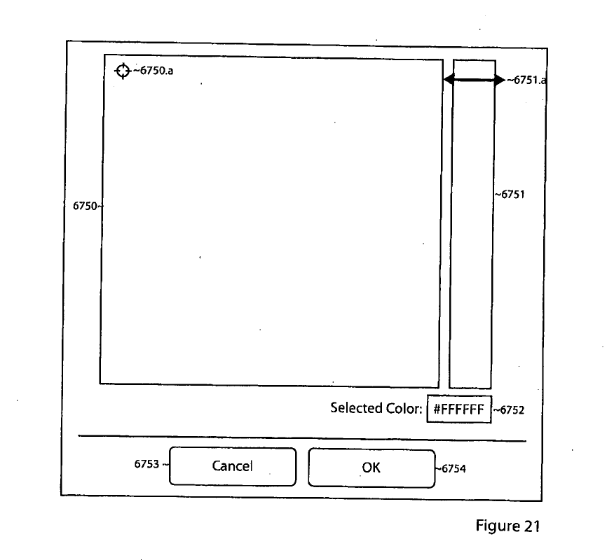

The color tool 6571 displays the toolset for selecting an HTML color value (FIG. 21) within the tool property panel 6580. Upon selecting a color, this tool uses execCommand with the argument ‘foreColor’ to apply the chosen color to the selected text. The background color tool 6572 behaves identically to the color tool 6571, except that rather than assigning a color to text, it assigns a background color to text. It does this by using ‘hiliteColor’ as the argument provided to execCommand rather than ‘foreColor’.

The tool property panel 6580 is a collapsible area attached to the Edit Tools tool palette 6550 that is used to display additional options and controls when certain tools in the tool palette are activated. The tool property panel is hidden when such a tool is not active.

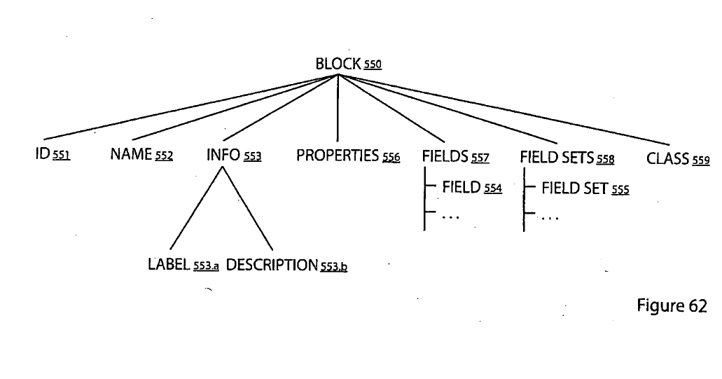

FIG. 6 is an illustration of a block tool (see FIG. 44) overlay. A block tool overlay provides a graphical toolset for managing a block (see FIG. 62) and is composed of HTML DOM elements that are created dynamically using Javascript, appended to the webpage's body HTML DOM element, and configured to be positioned over the block tool (FIG. 44) that corresponds with the block (FIG. 62) that is managed by the block tool overlay.

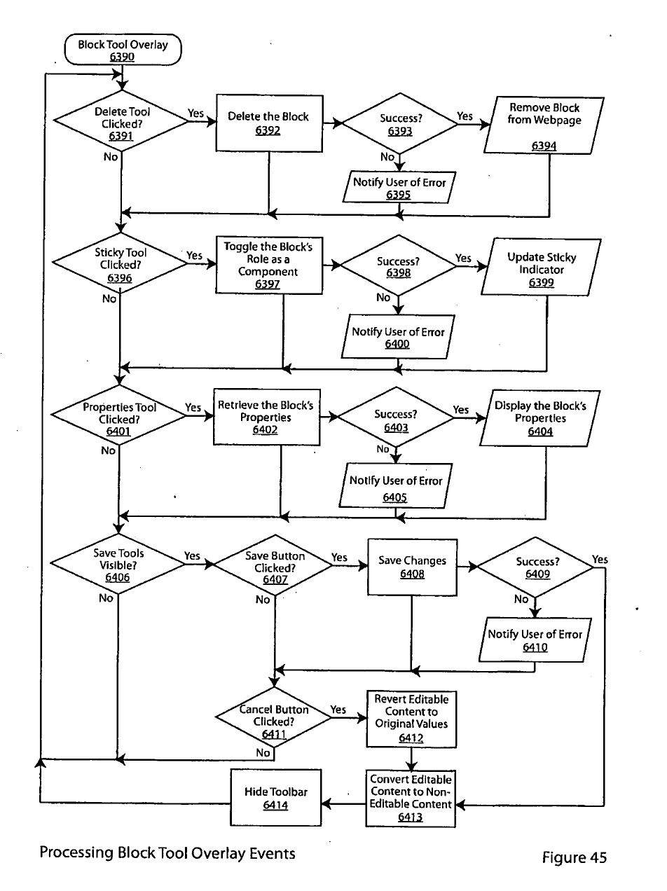

The overlay frame 6380 surrounds the border of the block tool with which this block tool overlay is associated. The overlay title bar 6381 contains several tools for managing the block that corresponds with the block tool overlay. These tools include the sticky tool 6382, the properties tool 6383, and the delete tool 6384. These tools are also referred to in connection with FIG. 45 (reference numbers 6396, 6402 and 6391).

The save tools 6385 allow the user to save or cancel changes made to field tools (see FIG. 46) within the block tool (FIG. 44) that corresponds with the block tool overlay. The save tools are only visible when one or more field tools are in editable mode. The cancel button 6386 revert any changes made to field tools associated with this overlay (see FIG. 45, reference number 6411). The save button 6387 saves all changes made to field tools associated with this overlay (see FIG. 45, reference number 6408).

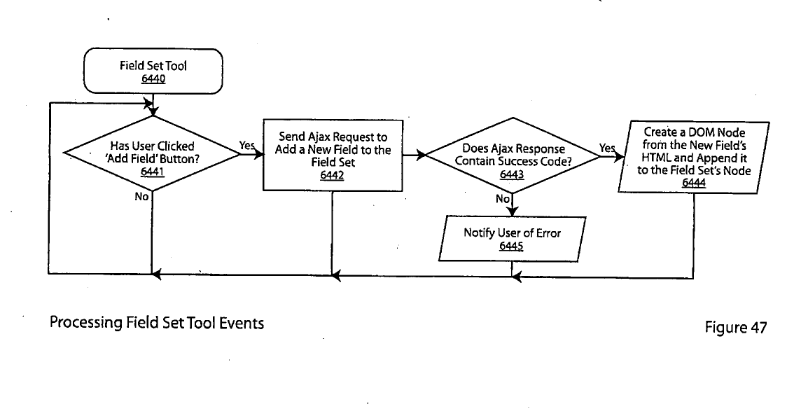

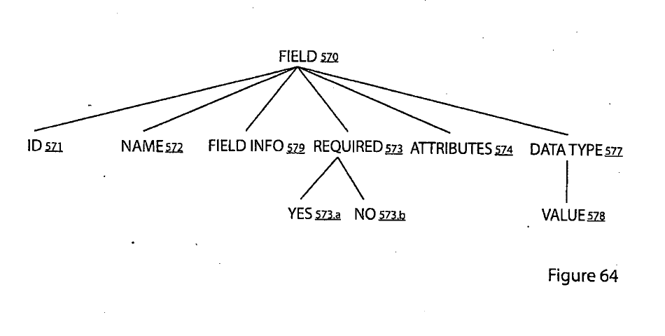

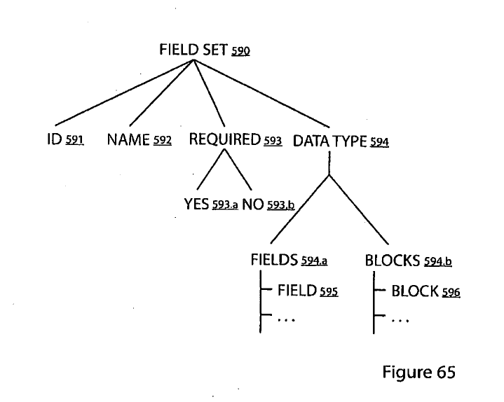

The block tool contents 6388 represents the fields (FIG. 64) and field sets (FIG. 65) that make up the block (FIG. 62) that is associated with the block tool overlay. In the case of this FIG. 6, the block tool contents 6388 represents a single field (see FIG. 64). The appearance of the contents for each block tool (FIG. 44) varies; however, the block tool contents are always composed of one or more fields (FIG. 64) or field sets (FIG. 65). Furthermore, each of said fields (FIG. 64) has a corresponding field tool (FIG. 46), and each of said field sets (FIG. 65) has a corresponding field set tool (FIG. 47). In this manner, a single block tool overlay may contain one or more nested field tools (FIG. 46), field set tools (FIG. 47), block tools (FIG. 44) and block tool overlays.

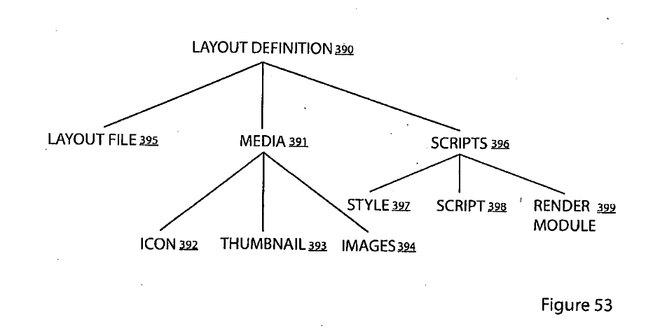

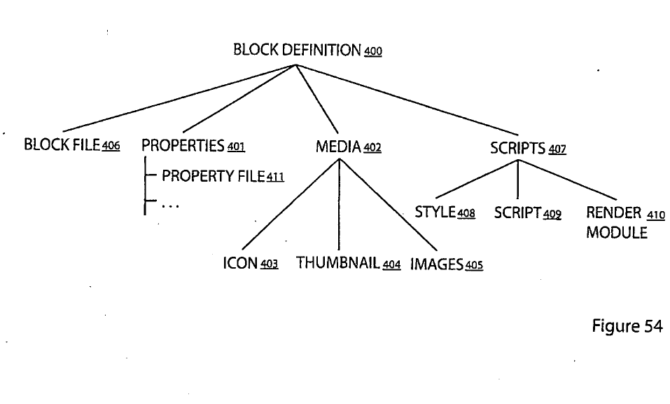

FIG. 7 is an illustration of a dialog window containing tools that allow the user to create a new webpage. The dialog window contains tools that allow the user to create a new webpage. One of these tools is the layout chooser 6600. The layout chooser 6600 lists the title of each layout definition (FIG. 53) that is available to the current website via its assigned theme (see FIG. 54, reference 504).

Each layout definition entry is a DHTML element, and upon mousing over an entry, the layout preview 6601 image will be dynamically updated using Javascript to display the entry's thumbnail. Upon clicking a layout definition entry, an Ajax request is sent to the Web service 150 containing the newpage command and, as part of the web service arguments, the name of the entry that was clicked. This causes the web service 150 to create a new blank webpage (FIG. 59) that references the layout definition (FIG. 53) that is associated with the entry that was clicked. If the Ajax response contains a success status code, the ID of the newly created webpage is read from the Ajax response and used to redirect the user's web browser to the newly created webpage via Javascript. Otherwise, a message dialog containing an error message is displayed.

The layout preview 6601 is a DHTML element containing an HTML img element that references a jpeg or gif image to display the thumbnail of the layout definition entry over which the user's mouse is positioned. The cancel button 6602 is a DHTML element that, when clicked, hides this dialog window.

FIG. 8 is an illustration of a dialog window containing tools that allow the user to navigate to any webpage within the current website. Webpage entries 6610 are listed for as many webpages as are contained within the current website and are labeled with the title of the webpage from the webpage's properties. Each entry is a DHTML element that, when clicked by the user, will cause the web browser to be redirected via Javascript to the selected webpage.

The scrollbar 6611 is a set of DHTML elements that allow the user to view the entire list of webpage entries 6610 in the event that there are more entries than can be displayed at one time within the dialog window. The scroll up button 6611.a is a DHTML element. If more entries 6610 are listed than can be displayed at one time, this button will scroll the list of entries up one, removing the top entry and pushing the following entries up one position. The entries are repositioned dynamically using Javascript to move the entry's DOM element within the HTML DOM.

The scroll down button 6611.b is a DHTML element. If more entries 6610 are listed than can be displayed at one time, this button will scroll the list of entries down one, removing the bottom entry and pushing the previous entries down one position. The entries are repositioned dynamically using Javascript to move the entry's DOM element within the HTML DOM. The cancel button 6612 is a DHTML element that, when clicked, hides this dialog window by setting its CSS display property to ‘none’ and its CSS visibility property to ‘hidden’.

FIG. 9 is an illustration of a dialog window containing tools that allow the user to edit one or more property sets. Property sets share the same data format as blocks (FIG. 62). A property entry 6620 is created for each of the property sets that is specified at the time this dialog window is launched and is labeled with the title associated with the property set. Each property entry 6620 is a DHTML element that, when clicked by the user, will cause the property panel 6621 to be updated via Javascript to display the tools needed to edit the specific property set associated with the property entry 6620 that was clicked.

The property panel 6621 is a DHTML element used to display the tools needed for editing a property set. These tools are dynamically created and displayed using Javascript based on the specific types of fields contained within the properties being edited. These tools may include standard text fields, sliders, radio buttons, checkboxes, dropdown menus, multiple selection lists, and custom user interface elements.

The scrollbar 6622, scroll up button 6622.a and scroll down button 6622.b function in the same manner as described in connection with the previous figure. The OK button 6623 is a DHTML element that, when clicked, will hide this dialog window using Javascript by setting its CSS display property to ‘none’ and will save any changes made to the property sets by sending an Ajax request to the web service 150 containing the saveblock command and, as part of the web service arguments, the field IDs and values within each of the property sets to be saved.

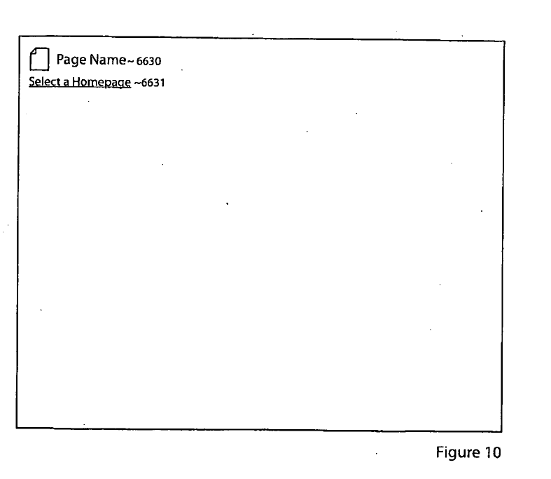

FIG. 10 is an illustration of the toolset for managing the general properties of a website. The page name 6630 lists the name of the webpage that is currently assigned as the current website's homepage. If the current website does not yet have a homepage assigned, nothing is listed here.

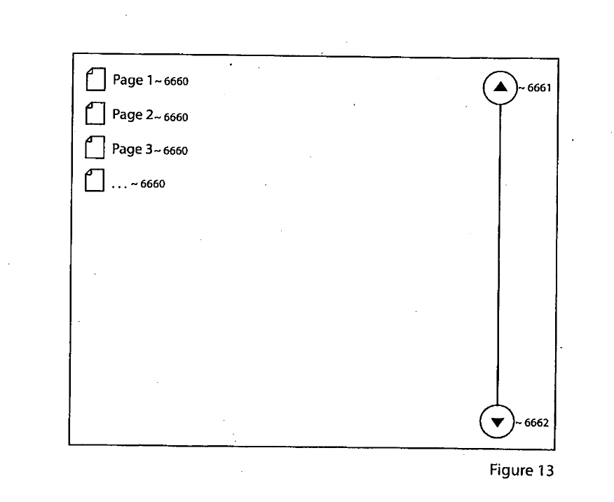

The select a homepage tool 6631 is a DHTML element that, when clicked, will cause the toolset shown in FIG. 10 to be replaced with the toolset for selecting a webpage shown in FIG. 13. The latter toolset allows the user to choose any webpage within the website registry. Upon selection of a webpage by the user, the page name 6630 is updated with the name of the selected webpage, the toolset shown in FIG. 13 is hidden, and the toolset of FIG. 10 is redisplayed to the user.

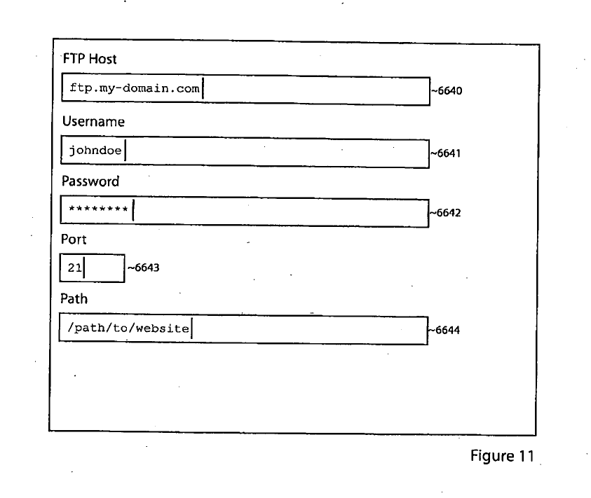

FIG. 11 is an illustration of the toolset for managing the publishing properties of a website. The FTP host field 6640 is an HTML input text field in which the user can specify the host name or IP address of the FTP server to which the current website will be published. The username field 6641 is an HTML input text field in which the user can specify the username needed to connect to the FTP host. The password field 6642 is an HTML input text field in which the user can specify the password needed to connect to the FTP Host. The port field 6643 is an HTML input text field in which the user can specify the TCP/IP port that will be used to connect to the FTP Host. The path field 6644 is an HTML input text field in which the user can specify the file system path to which files for the current website should be uploaded on the FTP host.

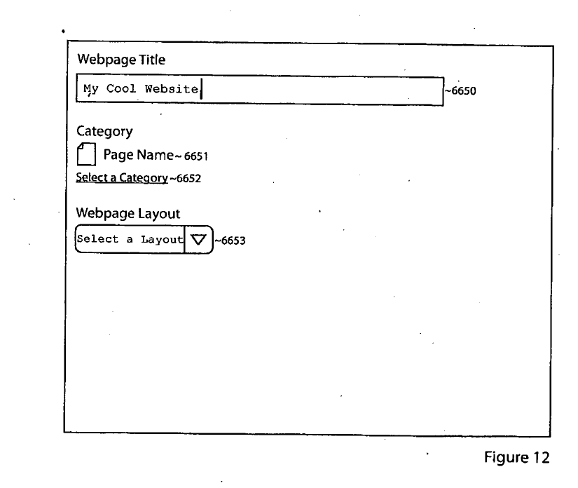

FIG. 12 is an illustration of the toolset for managing the general properties of a webpage. The webpage title field 6650 is an HTML text field in which the user can specify the name of the current webpage. The webpage title is used to help the user identify specific webpages within the current website.

The current category 6651 lists the name of the webpage to which the current webpage is assigned as a child. This scheme allows a hierarchy of webpages to be created by the user. Parent webpages are referred to herein as “categories.” If the current webpage is not assigned to a category, nothing is listed for the current category. The select a category tool 6652 is a DHTML element that, when clicked, will cause the toolset shown in FIG. 12 to be replaced with the toolset for selecting a webpage (see FIG. 13), which allows the user to choose any webpage within the website registry. Upon selecting a webpage, the current category 6651 is updated with the name of the selected webpage, the toolset shown in FIG. 13 is hidden, and the toolset shown in FIG. 12 is redisplayed to the user.

The webpage layout field 6653 is an HTML select field that allows the user to select the layout used by the current webpage. If the user selects a different layout than the one currently in use and saves his changes, Javascript will be used to reload the current webpage so that the user may see the affects of the newly selected layout.

FIG. 13 is an illustration of the toolset for selecting a webpage. This toolset is a DHTML element. A webpage entry is created for each webpage within the webpage registry. An Ajax request is sent to the web service 150 along with the listwebpages command, which causes the web service 150 to output each of the webpages within the current website as part of its Ajax response. If the Ajax response contains a success status code, a webpage entry is created and displayed for each webpage node contained within the Ajax response. If the Ajax response does not contain a success status code, Javascript is used to display a message dialog to the user containing an error message. When a webpage entry is clicked, this toolset will return the ID of the corresponding webpage.

The scroll up 6661 and scroll down 6662 buttons function as described above in connection with other figures.

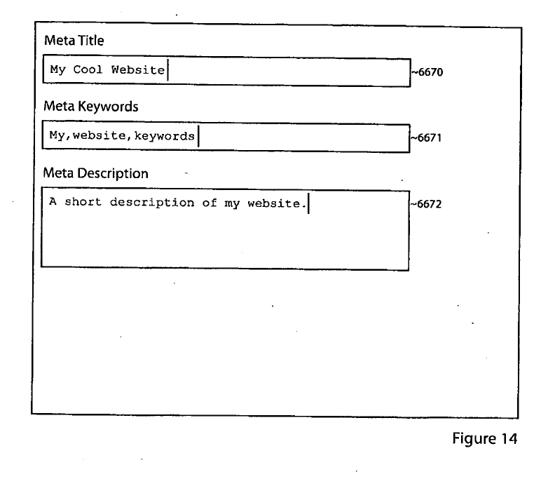

FIG. 14 is an illustration of the toolset for managing the search engine properties of a webpage. The meta title field is an HTML text field in which the user can specify the meta title of the current webpage. The meta title may be referenced by layout definition render modules (see FIG. 53) when rendering a webpage in order to place this (FIG. 14) meta title, keyword and description information within the head tag of the webpage's HTML output.

The meta keywords field 6671 is an HTML text field in which the user can specify the meta keywords of the current webpage. The meta keywords may be referenced by layout definition render modules (see FIG. 53) when rendering a webpage in order to place HTML meta information within the head tag of the webpage's HTML output. The meta description field 6672 is an HTML text field in which the user can specify the meta description of the current webpage. The meta description may be referenced by layout definition render modules (see FIG. 53) when rendering a webpage in order to place HTML meta information within the head tag of the webpage's HTML output.

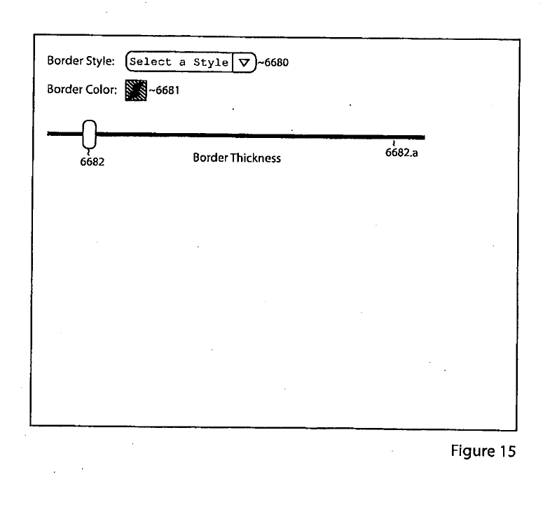

FIG. 15 is an illustration of the toolset for setting the values of a field (FIG. 64) that has a data type of CSS border. This toolset is instantiated and managed by a properties dialog (see FIG. 9) and is displayed within the property panel 6621. If the field has a css attribute, this toolset will use Javascript to update the specific CSS property referenced by the css attribute (the CSS style) with the values from this toolset in real time as the user changes them, causing the physical appearance of the webpage to update in real time to reflect the values that the user has caused to be assigned to the field (FIG. 64) and its attributes via the GUI toolset. This process of dynamically updating the values of CSS properties using Javascript based on the values of fields (FIG. 64) that contain a css attribute is referred to herein as “dynamic CSS.”

The border style field 6680 is an HTML select element that allows the user to assign a value to the style attribute of the field (FIG. 64) associated with this toolset. Upon the user selecting a new value in the border style field, the CSS border-style property of the CSS style will be assigned the newly selected value using dynamic CSS.

The border color field 6681 is a DHTML element. The CSS background-color property of this DHTML element is assigned the value of the color attribute of the field associated with this toolset. When this DHTML element is clicked, the color chooser popup (see FIG. 21) is displayed to the user with the current border color selected by default. As the user selects new colors within the color chooser popup, the value of the color is used to update the CSS border-color property within the dynamic CSS associated with this toolset.

The border thickness slider 6682 is a DHTML element. The CSS border-size property of this DHTML element is assigned the value of the size attribute of the field associated with this toolset. This element can be dragged horizontally between the left and right edges of the border thickness range 6682.a. As this DHTML element is dragged, the size attribute value is calculated by linear interpolation using the minimum and maximum values of the border thickness range 6682.a and the current position of this DHTML element in relation to the left and right edges of the border thickness range 6682.a. The value of the size attribute is used to update the CSS border-size property within the dynamic CSS associated with this toolset.

The border thickness range 6682.a is a DHTML element with a fixed width that is used to represent the range of the border thickness slider 6682. In a preferred embodiment, the minimum value for the border thickness range is 1, and the maximum value is 20.

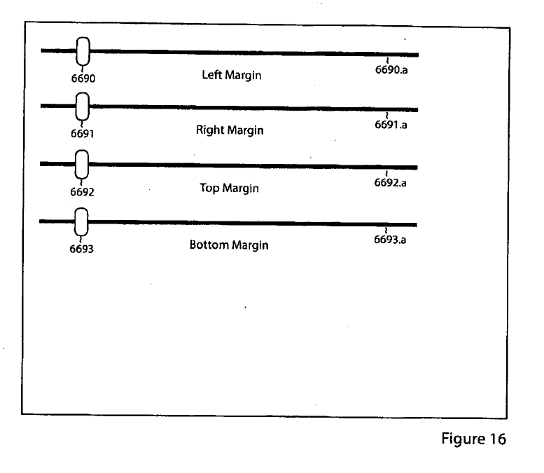

FIG. 16 is an illustration of the toolset for setting the values of a field that has a CSS margins data type. This toolset is instantiated and managed by a properties dialog (see FIG. 9) and is displayed within the property panel 6621. If the field has a css attribute, this toolset will update the CSS style referenced by the css attribute with the values from the toolset as the user changes them in real time via dynamic CSS.

The left margin size slider 6690 is a DHTML element. The CSS margin-left property of this DHTML element is assigned the value of the left attribute of the field associated with this toolset. This element can be dragged horizontally between the left and right edges of the left margin range 6690.a. As this DHTML element is dragged, the left attribute value is calculated by linear interpolation using the minimum and maximum values of the left margin range 6690.a and the current position of this DHTML element in relation to the left and right edges of the left margin range 6690.a. The value of the left attribute is used to update the CSS margin-left property within the dynamic CSS associated with this toolset.

The left margin range 6690.a is a DHTML element with a fixed width that is used to represent the range of the left margin size slider 6690. In a preferred embodiment, the minimum value for the left margin range is 0, and the maximum value is 150.

The right margin size slider 6691 and right margin range 6691.a operate in the same manner as described above for the left margin size slider 6690 and left margin range 6690.a. The top and bottom margin size sliders 6692, 6693 and top and bottom margin ranges 6692.a, 6693.a operate in the same manner as described above for the left margin size slider 6690 and left margin range 6690.a.

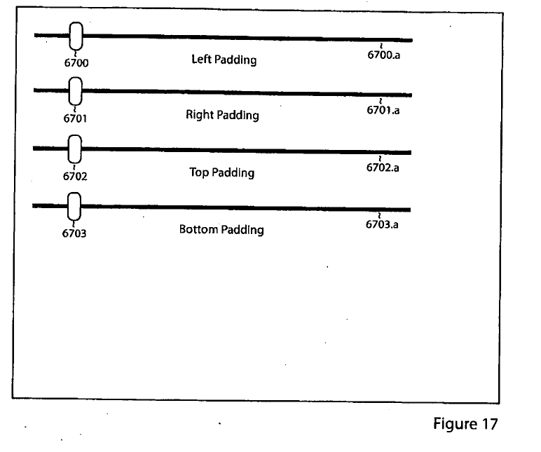

FIG. 17 is an illustration of the toolset for setting the values of a field that has a CSS padding data type. This toolset is instantiated and managed by a properties dialog (see FIG. 9) and is displayed within the property panel 6621. If the field has a css attribute 574, this toolset will update the CSS style referenced by the css attribute with the values from the toolset as the user changes them in real time via dynamic CSS.

The left padding size slider 6700 is a DHTML element. The CSS padding-left property of this DHTML element is assigned the value of the left attribute of the field associated with this toolset. (Padding refers to the spacing between the content and the border, whereas margins are outside the border.) This element can be dragged horizontally between the left and right edges of the left padding range 6700.a. As this DHTML element is dragged, the left attribute value is calculated by linear interpolation using the minimum and maximum values of the left padding range 6700.a and the current position of this DHTML element in relation to the left and right edges of the left padding range 6700.a. The value of the left attribute is used to update the CSS padding-left property within the dynamic CSS associated with this toolset.

The left padding range 6700.a is a DHTML element with a fixed width that is used to represent the range of the left padding size slider 6700. In a preferred embodiment, the minimum value for the left padding range is 0, and the maximum value is 150.

The right padding size slider 6701 and right padding range 6701.a operate in the same manner as described above for the left padding size slider 6700 and left padding range 6700.a. The top and bottom padding size sliders 6702, 6703 and top and bottom padding ranges 6702.a, 6703.a operate in the same manner as described above for the left padding size slider 6700 and left padding range 6700.a.

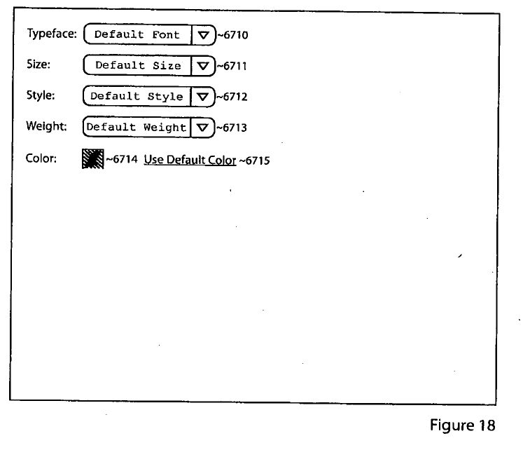

FIG. 18 is an illustration of the toolset for setting the values of a field that has a CSS font data type. This toolset is instantiated and managed by a properties dialog (see FIG. 9) and is displayed within the property panel 6621. If the field has a css attribute, this toolset will update the CSS style referenced by the css attribute with the values from the toolset as the user changes them in real time via dynamic CSS.

The typeface field 6710 is an HTML select field that allows the user to assign a value to the font attribute of the field associated with this toolset. When the user selects a new value, Javascript is used to update the CSS font-family property within the dynamic CSS associated with this toolset with the new value.

The size field 6711 is an HTML select field that allows the user to assign a value to the size attribute of the field associated with this toolset. When the user selects a new value, Javascript is used to update the CSS font-size property within the dynamic CSS associated with this toolset with the new value.

The style field 6712 is an HTML select field that allows the user to assign a value to the style attribute of the field associated with this toolset. When the user selects a new value, Javascript is used to update the CSS text-decoration property within the dynamic CSS associated with this toolset with the new value.

The weight field 6713 is an HTML select field that allows the user to assign a value to the weight attribute of the field associated with this toolset. When the user selects a new value, Javascript is used to update the CSS font-weight property within the dynamic CSS associated with this toolset with the new value.

The color tool 6714 is a DHTML element. The CSS background-color property of this DHTML element is assigned the value of the color attribute of the field associated with this toolset. When this DHTML element is clicked, the color chooser popup (see FIG. 21) is displayed to the user with the current color selected by default. As the user selects new colors within the color chooser popup, the value of the color is used to update the CSS color property within the dynamic CSS associated with this toolset.

The use default color tool 6715 is a DHTML element that, when clicked, causes the value of the color attribute to be cleared and the default color attribute value to be used. This default value is defined by the property file from which the field associated with this toolset was loaded.

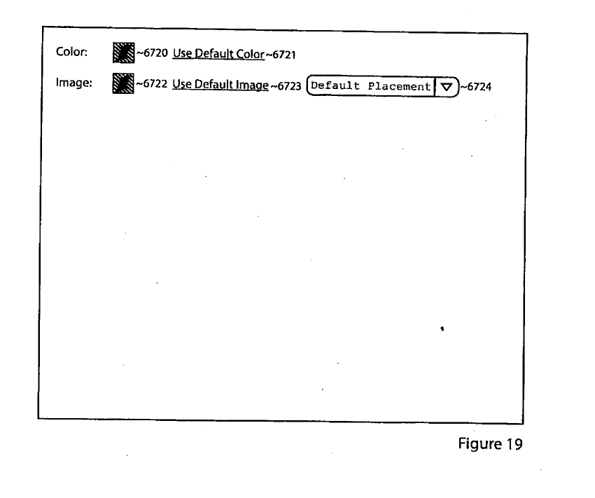

FIG. 19 is an illustration of the toolset for setting the values of a field that has a CSS background data type. This toolset is instantiated and managed by a properties dialog (see FIG. 9) and is displayed within the property panel 6621. If the field has a css attribute, this toolset will update the CSS style referenced by the css attribute with the values from the toolset as the user changes them in real time via dynamic CSS.

The background color tool 6720 is a DHTML element. The CSS background-color property of this DHTML element is assigned the value of the bgcolor attribute of the field associated with this toolset. When this DHTML element is clicked, the color chooser popup (see FIG. 21) is displayed to the user with the current background color selected by default. As the user selects new colors within the color chooser popup, the value of the color is used to update the CSS background-color property within the dynamic CSS associated with this toolset.

The use default color tool 6721 is a DHTML element. When this DHTML element is clicked, the value of the bgcolor attribute is cleared, causing the default bgcolor attribute value to be used. This default value is defined by the property file from which the field associated with this toolset was loaded.

The background image tool 6722 is a DHTML element. The CSS background-image property of this DHTML element is assigned the value of the bgimage attribute of the field associated with this toolset. When this DHTML element is clicked, the image chooser (see FIG. 22) is displayed to the user. If the user selects or uploads a new image within the image chooser, the image chooser is closed, the toolset shown in FIG. 19 is redisplayed to the user, and the URL of the selected image is used to update the CSS background-image property within the dynamic CSS associated with this toolset.

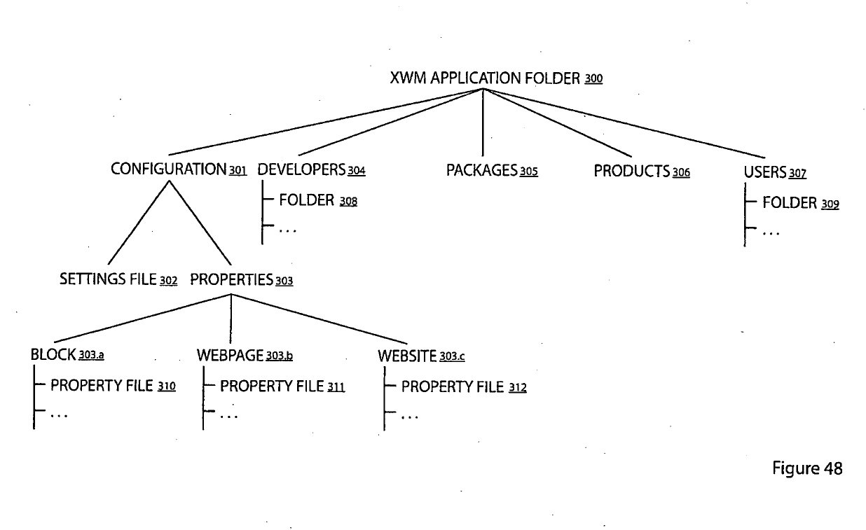

The use default image tool 6723 is a DHTML element that, when clicked, causes the value of the bgimage attribute to be cleared and the default bgimage attribute value to be used. This default value is defined by the property file from which the field associated with this toolset was loaded (see FIG. 48, reference number 303).

The image alignment tool 6724 is an HTML select field that allows the user to assign a value to the bgposition attribute of the field associated with this toolset. This allows the user to specify the alignment of the background image including: tile, top-left, top, top-right, right bottom-right, bottom, bottom-left, and left. When the user selects a new value, Javascript is used to update the CSS background-position property within the dynamic CSS associated with this toolset with the new value.

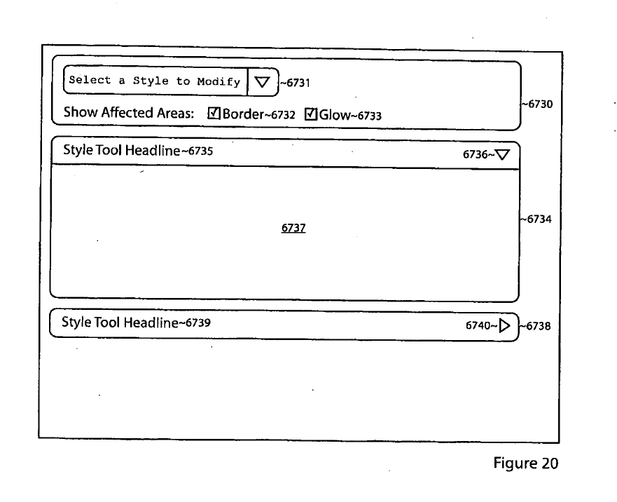

FIG. 20 is an illustration of the toolset for setting the values of a field (FIG. 64) within a block (FIG. 62) that has a class attribute with a value of ‘stylesheet’. This toolset is instantiated and managed by a properties dialog (see FIG. 9) and is displayed within the property panel 6621. For each field (see FIG. 64) within the block (see FIG. 62) that has a css attribute, this toolset will update the CSS style referenced by the css attribute with the values from this toolset as the user changes them in real time via dynamic CSS.

The style chooser 6730 is a group of tools that allows the user to select a specific field to edit within the block associated with this toolset. The active style field 6731 is an HTML select field that contains one entry for each field and field set contained within the block associated with this toolset. Upon selection of an entry and depending on the type of entry selected, one or more opened style tools 6734 are created using Javascript and displayed to the user directly beneath the style chooser 6730. If the selected entry is a field set (see FIG. 65), one opened style tool 6734 is created from each field within the field set. If the selected entry is a field (see FIG. 64) (as opposed to a field set), a single opened style tool 6734 is created from the field.

The border checkbox 6732 is an HTML checkbox that, when checked, uses dynamic CSS to add a border-color and border-size property to each of the CSS styles referenced by the css attribute within each of the fields associated with the active style 6731. This effectively places an outline around every HTML element on the webpage that will be affected when making changes with the opened style tool(s) 6734.

The glow checkbox 6733 is an HTML checkbox that, when checked, uses a Javascript function and dynamic CSS to dynamically fade in and out the opacity of each of the CSS styles referenced by the css attribute within each of the fields associated with the active style 6731. The Javascript function is repeatedly called every 100 milliseconds, and each time it is called, it increases the opacity value until it reaches 100%, at which point it will start decreasing the opacity until it reaches 25% and then start increasing the opacity again. This effectively creates a pulsing effect on each HTML element on the webpage that will be affected when making changes with the opened style tool(s) 6734.

An opened style tool 6734 is a DHTML element containing a toolset for modifying the field values and attribute values of a field. A different toolset is displayed depending on the data type of the field represented by the opened style tool 6734 (see FIGS. 15-19).

The style tool headline 6735 is a text headline describing the type of field that the opened style tool 6734 is used to edit. This headline reflects the data type of the field associated with the opened style tool 6734. In a preferred embodiment, the data types, their respective headlines and their corresponding toolsets are:
CSS Font—Text appearance—FIG. 18
CSS Background—Background color and image—FIG. 19
CSS Padding—Padding—FIG. 17
CSS Margins—Margins—FIG. 16
CSS Border—Border appearance—FIG. 15

The open/close toggle button 6736 is a DHTML element that, when clicked, causes the opened style tool 6734 to collapse into a closed style tool 6738, effectively hiding the style tool panel 6737 associated with the opened style tool 6734. This allows the user to better utilize the available screen space for the individual toolsets. The style tool panel 6737 is a DHTML element in which the toolset for the opened style tool 6734 is displayed.

The closed style tool 6738 is identical to the opened style tool 6734, except that its style tool panel 6737 has been hidden using Javascript by removing the style tool panel 6737 from tie webpage's DOM. The style tool headline 6739 for the closed style tool 6738 is identical to the style tool headline 6735 for the opened style tool 6734.

The open/close toggle button is a DHTML element that, when clicked, causes the closed style tool 6738 to unfold into an opened style tool 6734 by using Javascript to add the style tool panel 6737 back to the webpage's DOM.

FIG. 21 is an illustration of the toolset for selecting an HTML color value. The saturation and luminance chooser 6750 is an HTML div element whose CSS background-color property is assigned to the value of the color that is selected by the hue slider 6751.a. Additionally, a gradient ranging from pure white in the top-left corner to pure-black in the bottom-right corner with varying transparency is overlaid on top of the background color to simulate the effect of luminance.

The SL slider 6750.a (“SL” stands for saturation and luminance) is a DHTML element. The user may click and drag the SL slider within the bounding rectangle of the saturation and luminance chooser 6750. As the SL slider is moved by the user, Javascript is used to calculate the hexadecimal RGB (“RGB” stands for red-green-blue) value of the color on top of which the SL slider is currently placed, and the value of that color is displayed within the selected color 6752.

The hue chooser 6751 is an HTML div element whose CSS background-image property is assigned to a gradient image that ranges from red, orange, yellow, green, cyan, blue and violet back to red. The hue slider 6751.a is a DHTML element. The user may click and drag the hue slider vertically between the top and bottom boundaries of the hue chooser 6751. As the hue slider is moved by the user, the CSS background-color property of the saturation and luminance chooser 6750 is updated to reflect the color over which the hue slider is placed. Javascript is used to calculate the hexadecimal RGB value of the color on top of which the hue slider is currently placed, and the calculated value of that color is displayed within the selected color field 6752.

The selected color field 6752 is an HTML text field containing the hexadecimal RGB value of the currently selected color.

The cancel button 6753 is a DHTML element that, when clicked, causes a request to close this toolset to be sent to the parent object that instantiated this toolset. The OK button 6754 is a DHTML element that, when clicked, sends the hexadecimal RGB value of the selected color and a request to close this toolset to the parent object that instantiated this toolset.

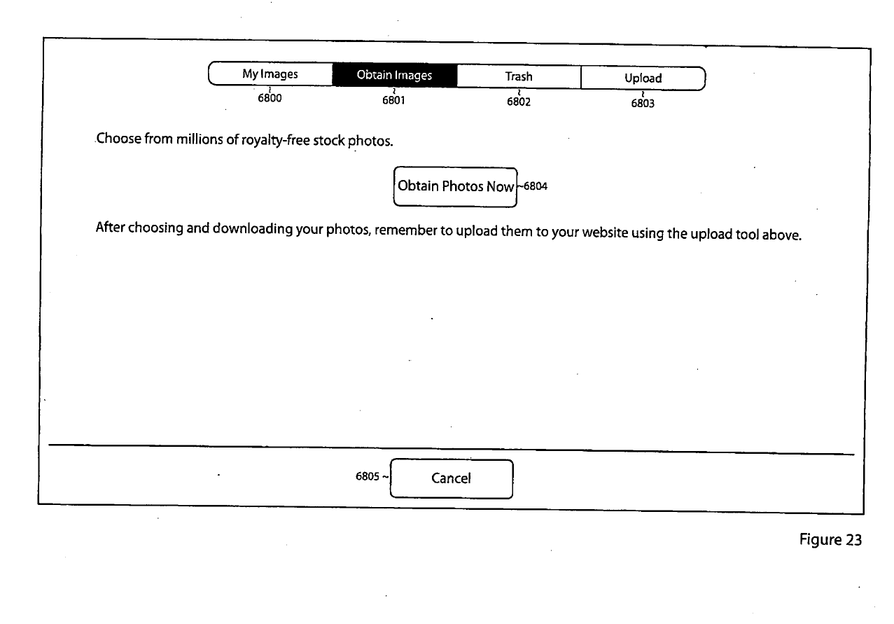

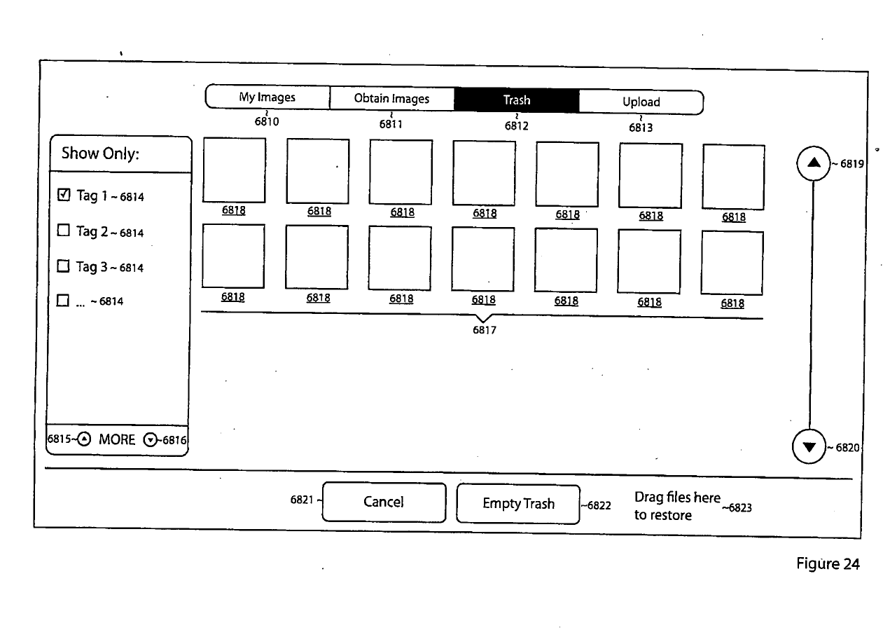

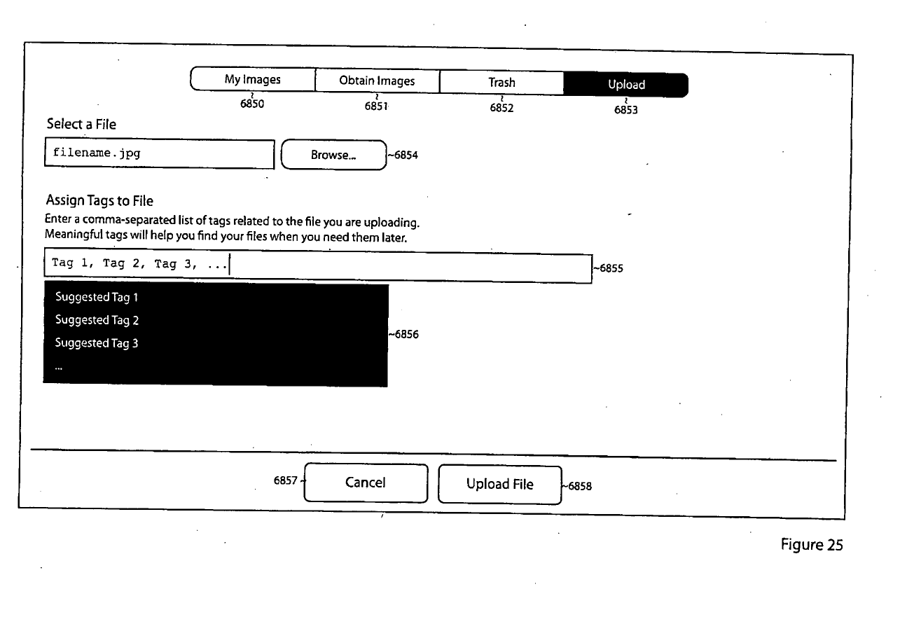

FIG. 22 is an illustration of the toolset for selecting a single image (FIG. 71) from the media of the current website. The my images tab 6770 is a DHTML element that illustrates that the toolset shown in FIG. 22 is currently active and visible. The obtain images tab 6771 is a DHTML element that, when clicked, replaces the toolset shown in this figure with the toolset shown in FIG. 23. The trash tab 6772 is a DHTML element that, when clicked, replaces the toolset shown in this figure with the toolset shown in FIG. 24. The upload tab 6773 is a DHTML element that, when clicked, replaces the toolset shown in this figure with the toolset shown in FIG. 25.

The tag filter 6774 is a DHTML element that represents a single media tag (FIG. 73). As used herein, the term “media tag” refers to an individual tag within FIG. 73; a media tag is a keyword that is assigned to a file. When the toolset shown in FIG. 22 is first displayed, an Ajax request is sent to the web service 150 with the listmediatags command, which causes the web service 150 to output all of the media tags within the current website as part of the Ajax response. Each mediatag node found within the Ajax response is listed as a tag filter using the name attribute of the mediatag node as its title. When a tag filter is clicked, it is toggled between a checked and unchecked state. If one or more tag filters is/are checked, the file listing 6777 is filtered to show only the files that are assigned to media tags associated with the checked tag filters (see FIG. 73). If no tag filters are checked, the file listing 6777 will show all files.

The scroll up 6775 and scroll down 6776 elements are DHTML elements that operate in the same manner described above in connection with other scroll up and scroll down functions.

The file listing 6777 is a DHTML element that contains one file thumbnail for each image (FIG. 71) that is in the current website and does not have its trash attribute set to ‘yes’. When the toolset shown in FIG. 22 is first displayed, an Ajax request is sent to the web service 150 with the listimages command, which causes the web service 150 to output as part of its Ajax response each of the images (FIG. 71) within the current website that do not have the trash attribute set to ‘yes’. A file thumbnail 6778 is created for each image (FIG. 71) node within the Ajax response and is displayed within a grid. If any tag filters 6774 are checked, the same Ajax request as above is sent again, but the name(s) of the tag filters 6774 that are checked are added as part of the web service arguments, which causes the Ajax response to contain only those images that are assigned to media tags corresponding to the specified tag filter 6774 names.

The file thumbnail 6778 is a DHTML element. This element displays a graphical thumbnail of the image (FIG. 71) with which it is associated by assigning the CSS background-image property to the URL of the image as retrieved from the file listing 6777 service response. When this DHTML element is clicked, the URL to the image is sent to the parent object that instantiated this toolset along with a request to close the toolset.

The scroll up button 6779 and scroll down button 6780 operate in the same manner as described above in connection with other figures, as does the cancel button 6781.

The trash bin 6782 is a DHTML element. When a file thumbnail 6778 is dragged over this element and released, an Ajax request is sent to the web service 150 containing the deletefile command and, as part of the web service arguments, the name of the image (FIG. 71) associated with the file thumbnail 6778. This in turn causes the web service 150 to assign the value ‘yes’ to the image's trash (FIG. 71, reference 656) attribute. If the Ajax response contains a success status code, the file listing 6777 is refreshed, effectively removing the image from the file listing 6777. If the Ajax response does not contain a success status code, a message dialog containing an error message is displayed.

FIG. 23 is an illustration of a toolset for obtaining stock photography from a third party. The my images, obtain images, trash and upload tabs 6800, 6801, 6802 and 6803 operate in the same manner as described above in connection with FIG. 22. The obtain images button 6804 is a DHTML element that, when clicked, opens a new web browser window using Javascript and directs the user to a third party website where he can obtain stock photography.

The cancel button 6805 operates in the same manner as described above in connection with other figures.

FIG. 24 is an illustration of the toolset for managing images (FIG. 71) within the current website that have a trash attribute assigned to them. The my images, obtain images, trash and upload tabs 6810, 6811, 6812 and 6813 operate in the same manner as described above in connection with FIG. 22. The tag filter 6814 is the same as the tag filter 6774 described in connection with FIG. 22. The scroll filters up 6815 and scroll filters down 6816 buttons operate in the same manner as described above in connection with other figures.

The file listing 6817 is the same as the file listing 6777 described in connection with FIG. 22, with the exception that only images (FIG. 71) that have the trash attribute set to ‘yes’ are listed.

The file thumbnail 6818 is the same as the file thumbnail 6778 described in connection with FIG. 22. The scroll up and scroll down buttons 6819, 6820 operate in the same manner as described above in connection with other figures, as does the cancel button 6821.

The empty trash button 6822 is a DHTML element that, when clicked, sends an Ajax request to the web service 150 containing the emptytrash command, which causes the web service 150 to permanently delete all images (FIG. 71) within the current website that have the trash attribute set to ‘yes’. If the Ajax response contains a success status code, the file listing 6817 is refreshed, effectively removing all file thumbnails 6818 from the file listing 6817. If the Ajax response does not contain a success status code, a message dialog containing an error message is displayed.

The restore file tool 6823 is a DHTML clement. When a file thumbnail 6818 is dragged over this element and released, an Ajax request is sent to the web service 150 containing the restorefile command and, as part of the web service arguments, the ID of the image (FIG. 71) that is associated with the file thumbnail 6818 that was clicked. This in turn causes the web service 150 to set the image's (FIG. 71) trash attribute to ‘no’. If the Ajax response contains a success status code, the file listing 6817 is refreshed, effectively removing the image (FIG. 71) from the file listing 6817. If the Ajax response does not contain a success status code, a message dialog containing an error message is displayed.

FIG. 25 is an illustration of the toolset for adding a new image to the current website. The my images, obtain images, trash and upload tabs 6850, 6851, 6852 and 6853 operate in the same manner as described above in connection with FIG. 22. This toolset contains an HTML form element (the upload form), which further contains the file chooser 6854 and tag field 6855 elements. The upload form, when submitted, executes a PHP script that processes the information from the file chooser 6854 and tag field 6855 to save the uploaded file to the media folder, create an entry for the file within the media registry, and create entries for any media tags that have been entered in the tag field 6855 and, in order to assign the media tag(s) to the uploaded file, set the filename attribute of each media tag entry to the filename of the uploaded file. This toolset, when instantiated, uses Javascript to dynamically create an HTML frameset element and append it to the webpage DOM (referred to as the upload frameset). Javascript is used to dynamically assign the target attribute of the upload form to the name of the upload frameset. This approach allows the upload form to be submitted “behind the scenes” without causing the web browser to navigate to a new webpage.

The file chooser 6854 is an HTML file input that allows the user to select a file from his computer's file system. Because the file chooser uses the web browser's built-in file input widget, the file chooser will look and behave differently depending on the web browser and operating system.

The tag field 6855 is an HTML text input field that is extended with Javascript properties that allow it to monitor keyboard input. For each character the user enters into the tag field, an Ajax request is sent to the web service 150 containing the listmediatags command and, as part of the web service arguments, the current tag. This in turn causes the web service 150 to output as part of its Ajax response each of the media tags within the user website that has a name that contains the same sequence of characters as in the current tag. For example, if the user website contains the media tags ‘foo’ and ‘bar’, and the current tag is ‘fo’, then the Ajax response will output the ‘foo’ media tag but not the ‘bar’ media tag. As used herein, the term “current tag” means, within the tag field 6855, all text appearing after the last comma entered or all text if no comma has been entered. If the Ajax response contains a success status code, an entry for each of the mediatags nodes contained within the Ajax response is displayed within the suggested tags tool 6856. If the Ajax response does not contain a success status code, the suggested tags tool 6856 is hidden from the user using Javascript.

The suggested tags tool 6856 is a DHTML element that lists one or more media tag entries by name. Each media tag is a DHTML element that, when clicked, replaces the current tag within the tag field 6855 with the name of the media tag associated with the entry that was clicked, and the suggested tags tool 6856 is hidden. (As discussed in connection with FIGS. 22 and 24, media tags are used to ‘filter’ the file listing.)

The cancel button 6857 operates in the same manner as described above in connection with other figures. The upload button 6858 is a DHTML element that, when clicked, uses Javascript to submit the upload form to the upload frameset and then listen for a response from the upload frameset. If the upload frameset returns a success code, then a request to close this toolset is sent to the parent object that instantiated this toolset. If the upload frameset returns an error code, an error message is displayed to the user.

FIG. 26 is an illustration of the toolset for assigning an image to an HTML img element. This toolset is instantiated and managed by the edit tools tool palette 6550 (see FIG. 5) and is displayed within the tool property panel 6580. At the time this toolset is instantiated, the edit tools tool palette 6550 includes a reference to the HTML img HTML DOM element that this toolset affects (the “image element”).

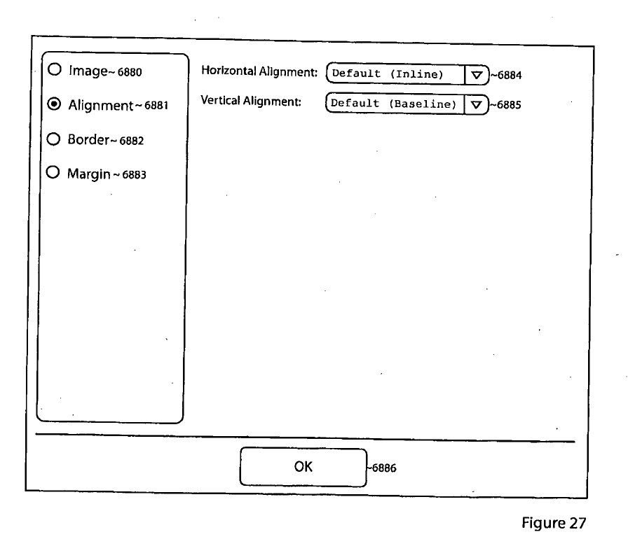

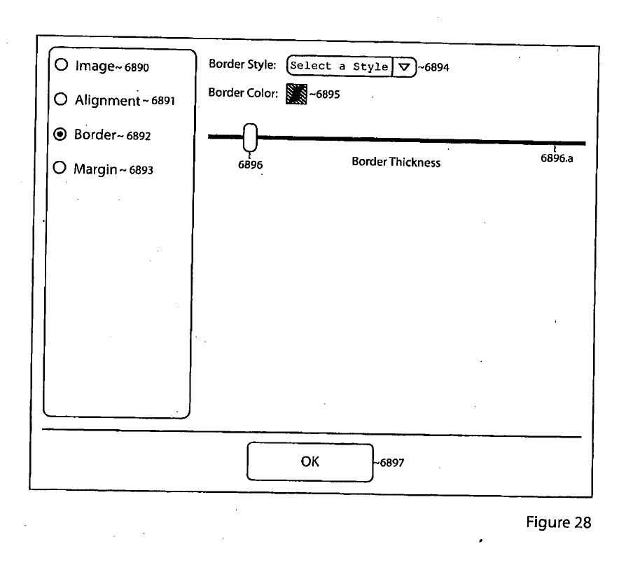

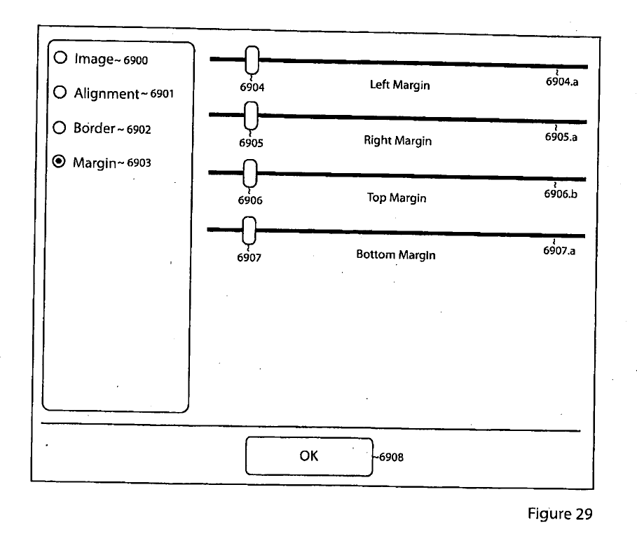

The image tab 6870 is a DHTML element that represents the toolset shown in FIG. 26. (Note that in FIGS. 27-29, when the image tab is clicked, the display switches to the toolset shown in FIG. 26.) The alignment tab 6871 is a DHTML element that, when clicked, replaces this entire toolset with the toolset shown in FIG. 27. The border tab 6872 is a DHTML element that, when clicked, replaces this entire toolset with the toolset shown in FIG. 28. The margin tab 6873 is a DHTML element that, when clicked, replaces this entire toolset with the toolset shown in FIG. 29.

The image thumbnail 6874 is a DHTML element. The image thumbnail's background-image CSS property is assigned to the URL from the image element src attribute. This provides to the user a preview of the selected image. Clicking this element behaves identically to the select image button 6875. The select image button 6875 is a DHTML element that, when clicked, uses Javascript to display the image chooser (see FIG. 22) to the user. If the user selects or uploads a new image within the image chooser, the image chooser is closed, the toolset shown in FIG. 26 is redisplayed to the user, and the URL of the selected image is assigned to the image thumbnail 6874 to display to the user the selected image. Additionally, the src attribute of the image element is assigned to the URL of the selected image, replacing the original image on the webpage with the newly selected image.

The cancel button 6876 operates in the same manner as described above in connection with other figures.

FIG. 27 is an illustration of the toolset for adjusting the alignment of an HTML img element. This toolset is instantiated and managed by the edit tools tool palette 6550 (see FIG. 5) and is displayed within the tool property panel 6580. At the time this toolset is instantiated, the edit tools tool palette (see FIG. 5) provides a reference to the HTML img element to be adjusted by this toolset.

The image, alignment, border and margin tabs 6880, 6881, 6882 and 6883 operate in the same manner as described above in connection with FIG. 26.

The horizontal alignment field 6884 is an HTML select field that uses Javascript to detect when the user changes the selection. This select field allows the user to change the horizontal alignment of the img element within its parent HTML DOM element to flush left, inline or flush right. When the user changes the alignment selection, Javascript is used to assign the float CSS property of the img element to ‘left’, ‘none’ or ‘right’, depending on the alignment selected.

The vertical alignment field 6885 is an HTML select field that uses Javascript to detect when the user changes the selection. This select field allows the user to change the vertical alignment of the img element to one of the following: ‘baseline’, ‘sub’, ‘super’, ‘top’, ‘text-top’, ‘middle’, ‘bottom’, or ‘text-bottom’. When the user changes the alignment selection, Javascript is used to assign the vertical-align CSS property of the img element to the value of the selected alignment.

The cancel button 6886 operates in the same manner as described above in connection with other figures.

FIG. 28 is an illustration of the toolset for adjusting the border of an HTML img element. This toolset is instantiated and managed by the edit tools tool palette 6550 (see FIG. 5) and is displayed within the tool property panel 6580. At the time this toolset is instantiated, the edit tools tool palette (see FIG. 5) includes a reference to the HTML img element to be adjusted by this toolset.

The image, alignment, border and margin tabs 6890, 6891, 6892 and 6893 operate in the same manner as described above in connection with FIG. 26.

The border style field 6894 is an HTML select field that uses Javascript to detect when the user changes the selection. This select field allows the user to change the type of border surrounding the HTML img element. When the user changes the alignment selection, Javascript is used to assign the border-style CSS property of the image element to ‘none’, ‘dotted’, ‘dashed’, ‘solid’, ‘double’, ‘groove’, ‘ridge’, ‘inset’ or ‘outset’, depending on the border style selected.

The border color tool 6895 is a DHTML element. The CSS background-color property of this DHTML element is assigned the value of the border-color CSS property of the HTML img element. When this DHTML element is clicked, the color chooser popup (FIG. 21) is displayed to the user with the current border color selected by default. As the user selects new colors within the color chooser popup, the value of the color is used to update the CSS border-color property of the image element.

The border thickness slider 6896 is a DHTML element. This element can be dragged horizontally between the left and right edges of the border thickness range 6896.a. As this DHTML element is dragged, a size value is calculated by linear interpolation using the minimum and maximum values of the border thickness range 6896.a and the current position of this DHTML element in relation to the left and right edges of the border thickness range 6896.a. The size value is assigned to the CSS border-size property of the image element in real time.

The border thickness range is a DHTML element with a fixed width that is used to represent the range of the border thickness slider 6896. In a preferred embodiment, the minimum value for the border thickness range is 1, and the maximum value is 20.

The OK button 6897 operates in the same manner as described above in connection with other figures.

FIG. 29 is an illustration of the toolset for adjusting the margins of an HTML img element. This toolset is instantiated and managed by the edit tools tool palette 6550 and is displayed within the tool property panel 6580. At the time this toolset is instantiated, the edit tools tool palette (FIG. 5) includes a reference to the HTML img element to be adjusted by this toolset.

The image, alignment, border and margin tabs 6900, 6901, 6902 and 6903 operate in the same manner as described above in connection with FIG. 26.

The left margin size slider 6904 is a DHTML element that can be dragged horizontally between the left and right edges of the left margin range 6904.a. As this DHTML element is dragged, a left value is calculated by linear interpolation using the minimum and maximum values of the left margin range 6904.a and the current position of this DHTML element in relation the left and right edges of the left margin range 6904.a. The left value is assigned to the CSS margin-left property of the image element in real time. The left margin range 6904.a is a DHTML element with a fixed width that is used to represent the range of the left margin size slider 6904. In a preferred embodiment, the minimum value for the left margin range is 0, and the maximum value is 150.

The right margin size slider 6905 and right margin range 6904.a operate in the same manner as described above for the left margin size slider 6904 and left margin range 6904.a. Similarly, the top and bottom margin size sliders 6906, 6907 and top and bottom margin ranges 6906.a, 6907.a operate in the same manner as described above for the left margin size slider 6904 and left margin range 6904.a.

The OK button 6908 operates in the same manner as described above in connection with other figures.

FIG. 30 is an illustration of the toolset for assigning a webpage address to an HTML hyperlink. This toolset is instantiated and managed by the edit tools-tool palette 6550 and is displayed within the tool property panel 6580.

The my pages tab 6920 is a DHTML element that represents the toolset shown in FIG. 30. (Note that in FIGS. 31-33, when the my pages tab is clicked, the display switches to the toolset shown in FIG. 30.) The my files tab 6921 is a DHTML element that, when clicked, replaces the toolset shown in this figure with the toolset shown in FIG. 31. The web address tab 6922 is a DHTML element that, when clicked, replaces the toolset shown in this figure with the toolset shown in FIG. 32. The email address tab 6923 is a DHTML element that, when clicked, replaces the toolset shown in this figure with the toolset shown in FIG. 33.

The webpage entry tool 6924 is a DHTML element that is created for each webpage (FIG. 59) within the webpage registry (FIG. 68). At the time this toolset is first displayed, an Ajax request is sent to the web server 150 containing the listwebpages command, which causes the web service 150 to output as part of its Ajax response basic information, such as the ID and name, for each of the webpages (FIG. 59) in the webpage registry (FIG. 68). If the Ajax response contains a success status code, a webpage entry is created and displayed for each webpage node (FIG. 59) contained within the Ajax response. If the Ajax response does not contain a success status code, a message dialog containing an error message is displayed to the user. When clicked, the webpage entry will become highlighted, and all other webpage entries will not be highlighted.

The scroll up and scroll down buttons 6925, 6926 operate in the same manner as described above in connection with other figures. The cancel button 6927 operates in the same manner as described above in connection with other figures. The OK button 6928 is a DHTML element that, when clicked, sends the ID 521 (see FIG. 59, reference number 521) of the webpage (FIG. 59) that is associated with the active webpage entry 6924 and a request to close this toolset to the parent object that instantiated this toolset.

FIG. 31 is an illustration of the toolset for assigning a file to an HTML hyperlink. This toolset is instantiated and managed by the edit tools tool palette 6550 and is displayed within the tool property panel 6580. This toolset contains an upload form that contains the file chooser 6937. The upload form, when submitted, executes a PHP script that processes the information from the file chooser 6937 in order to save the uploaded file to the media folder and create an entry for the file within the media registry. This toolset, when instantiated, uses Javascript to dynamically create an upload frameset. Javascript is used to dynamically assign the target attribute of the upload form to the name of the upload frameset. This approach allows the upload form to be submitted “behind the scenes” without causing the web browser to navigate to a new webpage.

The my pages, my files, web address and email address tabs 6930, 6931, 6932 and 6933 operate in the same manner as described above in connection with FIG. 30.

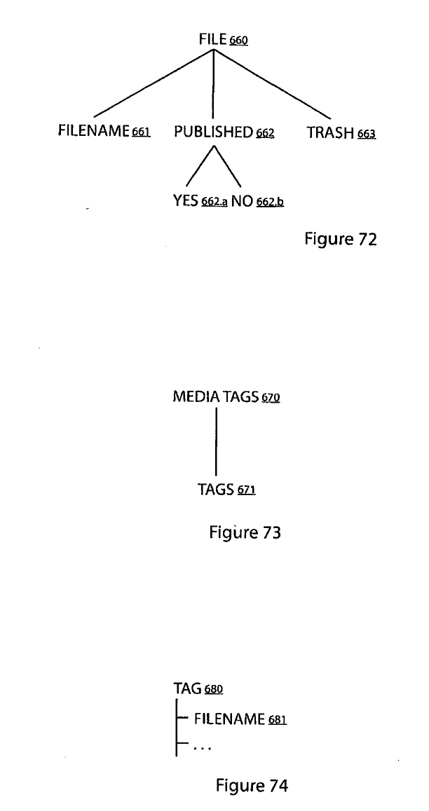

The file entry tool 6934 is a DHTML element. A file entry is created for each file within the media registry (FIG. 70). An Ajax request is sent to the web service 150 containing the listfiles command, which causes the web service 150 to output as part of its Ajax response, each file (FIG. 72) that is in the media registry (FIG. 70), excluding images 641. If the Ajax response contains a success status code, a file entry is created and displayed for each file (FIG. 72) node listed within the Ajax response. If the Ajax response does not contain a success status code, a message dialog containing an error message is displayed to the user. When clicked, the file entry 6934 will become active, and all other file entries 6934 will become inactive.

The scroll up and scroll down buttons 6935, 6936 operate in the same manner as described above in connection with other figures.

The file chooser 6937 is an HTML file input that allows the user to select a file from his computer's file system. Because the file chooser uses the web browser's built-in file input widget, the file chooser will look and behave differently depending on the web browser and operating system.

The upload button 6938 is a DHTML element that, when clicked, uses Javascript to submit the upload form to the upload frameset and then listen for a response from the upload frameset. If the upload frameset returns a success code, the file entry 6934 listing is refreshed, the file entry 6934 for the newly uploaded file is made active, and all other file entries 6934 are deactivated. If the upload frameset returns an error code, an error message is displayed to the user.

The cancel button 6939 operates in the same manner as described above in connection with other figures. The OK button 6940 is a DHTML element that, when clicked, sends the filename of the file that is associated with the active file entry 6934 and a request to close this toolset to the parent object that instantiated this toolset.

The delete file tool 6941 operates in the same manner as described in 6782 above in connection with FIG. 22, with the exception that the file is permanently and immediately deleted instead of having its trash attribute modified.

FIG. 32 is an illustration of the toolset for assigning a website address to an HTML hyperlink. This toolset is instantiated and managed by the edit tools tool palette 6550 and is displayed within the tool property panel 6580.

The my pages, my files, web address and email address tabs 6950, 6951, 6952 and 6953 operate in the same manner as described above in connection with FIG. 30.

The Internet address field 6954 is an HTML text field in which the user can specify the URL to which to assign to an HTML hyperlink. The cancel button 6955 operates in the same manner as described above in connection with other figures. The OK button 6956 is a DHTML element that, when clicked, sends the URL entered in the Internet address field 6954 field and a request to close this toolset to the parent object that instantiated this toolset.

FIG. 33 is an illustration of the toolset for linking an email address to an HTML anchor element. This toolset is instantiated and managed by the edit tools tool palette 6550 and is displayed within the tool property panel 6580.

The my pages, my files, web address and email address tabs 6960, 6961, 6962 and 6963 operate in the same manner as described above in connection with FIG. 30.

The email address field 6964 is an HTML text field in which the user can specify the email address to which to assign to an HTML hyperlink. The cancel button 6965 operates in the same manner as described above in connection with other figures. The OK button 6966 is a DHTML element that, when clicked, sends the email address entered in the email address field 6964 (prefixed with “mailto:” to signify that the link is for an email address) and a request to close this toolset to the parent object that instantiated this toolset.

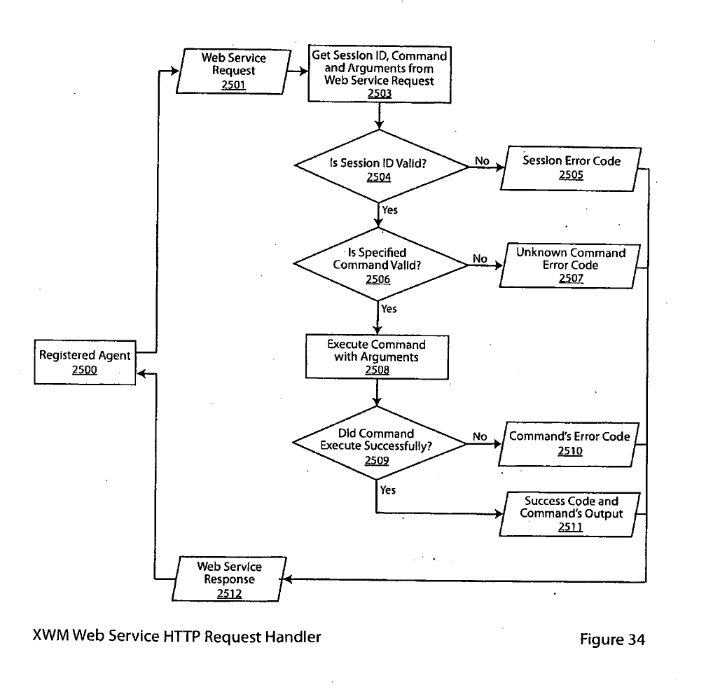

D. Flowcharts (FIGS. 34-47)

FIG. 34 is a flowchart illustrating the process of a registered agent 211 sending a web service request to, and receiving a web service response from, the web service 150.

The registered agent 2500 is a registered agent 211 that sends 2501 to the web service 150 a web service request containing the specific command name to be executed and including as part of the web service arguments the ID of the session 111 that corresponds to the user account under which this request is being sent.

The session ID, command and web service arguments are read 2503 from the web service response. If a session 111 ID was not provided within the web service request, or if the session 111 referenced by the ID does not exist or is invalid 2504, processing continues to 2505; otherwise, it continues to 2506.

In step 2505, an XML-formatted error message containing the statement that there was a problem with the session ID is constructed for output within the web service response 2512, and processing continues to 2512.

In step 2506, if the command that is specified within the web service request is not recognized 2501, processing continues to 2507; otherwise, it continues to 2508.

In step 2507, an XML-formatted error message containing the statement that a generic error has occurred is constructed for output within the web service response 2512, and processing continues to 2512.

In 2508, the web service 150 processes the web service request using its included command name and web service arguments and outputs a web service response. Processing continues to 2509.

In step 2509, if the web service command did not successfully execute, processing continues to 2510; otherwise, it continues to 2511.

In step 2510, an XML-formatted error message containing the error message and code from the executed web service command is constructed for output within the web service response 2512, and processing continues to 2512.

In step 2511, an XML-formatted message containing a success code and the XML data from the executed web service command is constructed for output within the web service response 2512, and processing continues to 2512.

In step 2512, HTTP headers are constructed for the XML-formatted web service response, and the web service response is then sent as an HTTP response to the registered agent 2500 via a network connection. The network connection between the registered agent 2500 and the web service is closed.

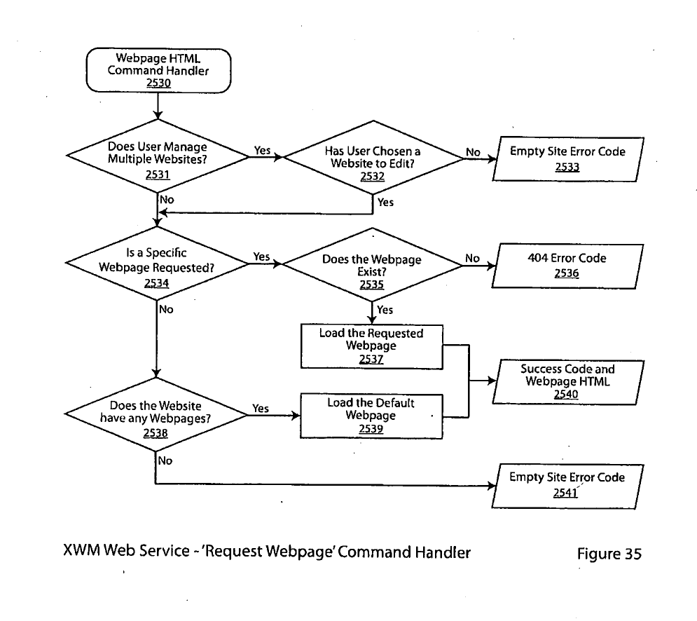

FIG. 35 is a flowchart illustrating the process taken by the web service 150 when it is issued the command to output the HTML for a webpage (FIG. 59). Upon execution of this command 2530, the web service will reference the user account under which this command is being executed in order to determine if the user has more than one user website (FIG. 51) registered under his account. If the user has multiple user websites (FIG. 51) registered under his account, processing continues to 2532; otherwise, it continues to 2534.

In step 2532, if the user has a user website (FIG. 51) currently assigned to his session 111, processing continues to 2534; otherwise, it continues to 2533.

In step 2533, an XML-formatted message is output; this message contains the statement that the website does not contain any webpages.

In step 2534, if an argument containing a webpage (FIG. 59) ID was provided to this process as part of the web service arguments for this web service command, processing continues to 2535; otherwise, it continues to 2538.

In step 2535, if a webpage (FIG. 59) with the provided webpage ID exists within the user's account, processing continues to 2537; otherwise, it continues to 2536.

In step 2536, an XML-formatted message is output stating that the webpage corresponding to the provided webpage ID could not be found.

In step 2537, the webpage (FIG. 59) corresponding to the provided webpage ID is loaded.

In step 2538, if the webpage registry (FIG. 68) contains one or more webpage entries 621, processing continues to 2539; otherwise, it continues to 2541.

In step 2539, if a default webpage (FIG. 59) ID is contained within the website (FIG. 58) properties 503, the default webpage is loaded; otherwise, the first webpage entry 621 within the webpage registry (FIG. 68) is read, and its corresponding webpage (FIG. 59) is loaded.

In step 2540, an XML-formatted message is output containing a success code and the HTML for the loaded webpage (FIG. 59).

In step 2541, an XML-formatted message is output stating that the web site does not contain any webpages.

FIG. 36 is a flowchart illustrating the process of accessing the XWA client 6040 by navigating to the Internet address of the XWM web application 6000 using a web browser.

An HTTP request 6201 is sent to the web server software 6202 by the web browser 6200 after the user enters the Internet address for the XWM web application 6000 into the web browser's address bar. The HTTP request 6201 is received by the web server software 6202, which executes the XWA server 6020 application for processing the HTTP request.

In step 6203, if the web browser includes a cookie containing a session 111 ID within its HTTP request 6201, processing continues to 6205; otherwise, it continues to 6204.

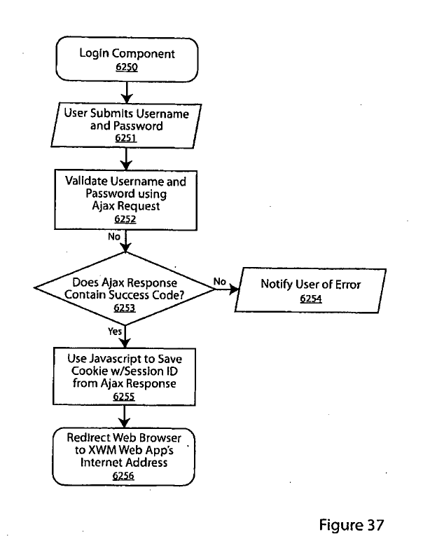

The login component 6204 outputs the HTTP headers and login component 6022 HTML to the web browser before stopping execution (see FIG. 37).

In step 6205, the webpage (FIG. 59) being requested by the web browser is determined by extracting the webpage's ID from the HTTP request 6201. A webpage ID is not required to be specified within the HTTP request 6201.

In step 6206, an Ajax request is sent to the web service 150 containing the webpagehtml command and, as part of the web service arguments, the ID of the requested webpage (FIG. 59).

In step 6207, if the Ajax response contains a success status code, processing continues to 6208; otherwise, it continues to 6209.

In step 6208, the Javascript code for the webpage content editor component 6027 is added to the webpage (FIG. 59) HTML. An HTTP response containing the modified webpage HTML is output to the web browser for execution 6200 (see FIG. 42).

In step 6209, if the Ajax response contains a session error code 2505 processing continues to 6210; otherwise, it continues to 6211.

In step 6210, an HTTP response containing the login component 6022 HTML is output to the web browser for execution (see FIG. 37).

In step 6211, if the Ajax response contains a 404 error code 2536 processing continues to 6212; otherwise, it continues to 6213.

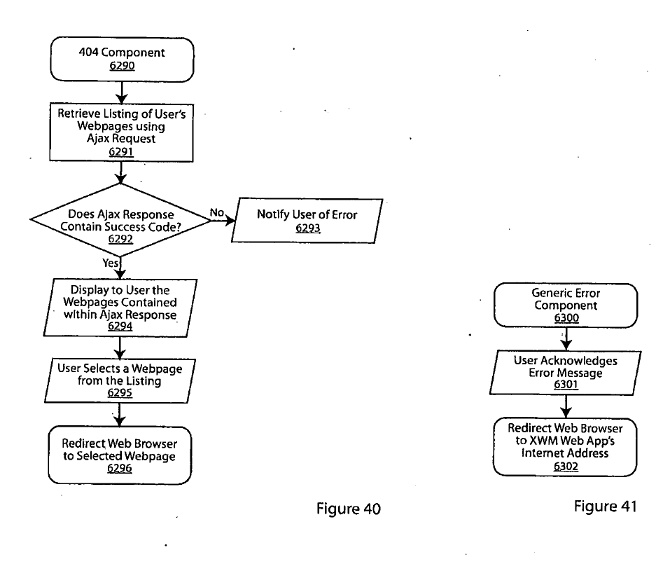

In step 6212, an HTTP response containing the 404 component 6025 HTML is output to the web browser for execution (see FIG. 40).

In step 6213, if the Ajax response contains a website error code 2533, processing continues to 6214; otherwise, it continues to 6215.

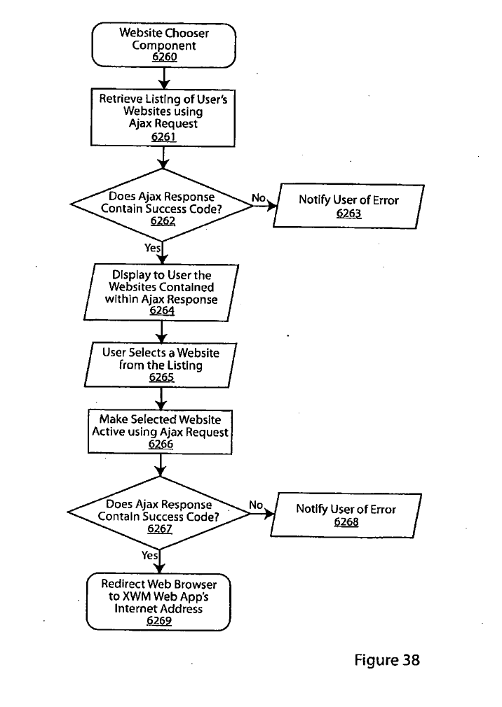

In step 6214, an HTTP response containing the website chooser component 6023 HTML is output to the web browser for execution (see FIG. 38).

In step 6215, if the Ajax response contains an empty site error code 2541, processing continues to 6216; otherwise, it continues to 6217.

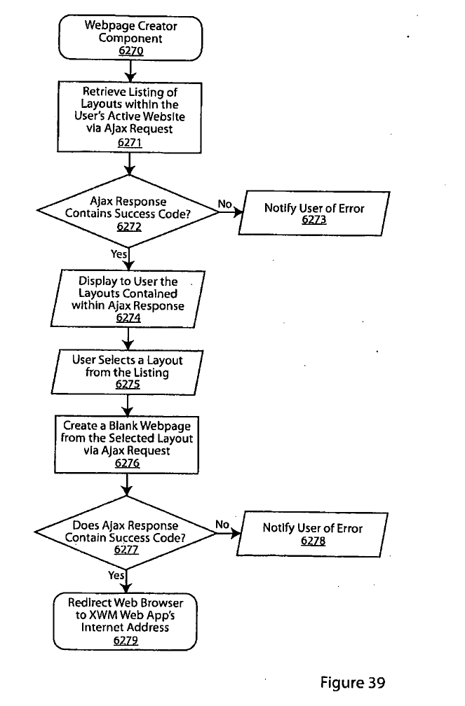

In step 6216, an HTTP response containing the webpage creator component 6024 HTML is output to the web browser for execution (see FIG. 39).

In step 6217, an HTTP response containing the generic error component 6026 HTML is output to the web browser for execution (see FIG. 41).

FIG. 37 is a flowchart illustrating the process of a web browser executing the login component 6022.

In step 6250, the login component's 6022 HTML is displayed by a web browser. Within the web browser, the user enters his username and password into form fields on the login component's 6022 webpage and submits the form 6251. After the user submits the form, an Ajax request is sent 6252 to the web service 150 containing the validateuser command and, as part of the web service arguments, the username and password.

In step 6253, if the Ajax response contains a success status code, processing continues to 6255; otherwise, it continues to 6254.

In step 6254, an HTML-formatted error message stating that the username or password was not valid is output to the web browser.

In step 6255, Javascript is used to save the session 111 ID from the Ajax response within a cookie in the user's web browser.

In step 6256, the user's web browser is redirected via Javascript to the Internet address of the XWM web application 6000 where the XWA client 6040 will then be executed (see FIG. 36).

FIG. 38 is a flowchart illustrating the process of a web browser executing the website chooser component 6023.

In step 6260, the website chooser component's 6023 HTML is displayed by a web browser. An Ajax request is sent 6261 to the web service 150 containing the listwebsites command and, as part of the web service arguments, the user's session 111 ID.

In step 6262, if the Ajax response contains a success status code, processing continues to 6264; otherwise, it continues to 6263.

In step 6263, an HTML-formatted error message stating that the user website(s) (FIG. 51) could not be listed is output to the web browser.

In step 6264, an HTML hyperlink for each of the user website (FIG. 51) XML entries within the Ajax response is output to the web browser. After the user clicks on one of the website entry hyperlinks 6265, processing continues to 6266.

In step 6266, an Ajax request is sent 6266 to the web service 150 containing the websiteselect command and, as part of the web service arguments, the ID of the website whose entry the user clicked.

In step 6267, if the Ajax response contains a success status code processing continues to 6269; otherwise, it continues to 6268.

In step 6268, an HTML-formatted error message stating that the website could not be selected or edited is output to the web browser.

In step 6269, the user's web browser is redirected via Javascript to the Internet address of the XWM web application 6000 where the XWA client 6040 will then be executed (see FIG. 36).

FIG. 39 is a flowchart illustrating the process of a web browser executing the webpage creator component 6024.

In step 6270, the webpage creator component's 6024 HTML is displayed by a web browser. An Ajax request is sent 6271 to the web service 150 containing the listlayouts command and, as part of its web service arguments, the user's session 111 ID. This in turn causes the website to output as part of its Ajax response each layout definition (FIG. 53) that is available to the user website (FIG. 51).

In step 6272, if the Ajax response contains a success status code, processing continues to 6274; otherwise, it continues to 6273.

In step 6273, an HTML-formatted error message stating that the layout definitions (FIG. 53) within the user website (FIG. 51) could not be listed is output to the web browser.

In step 6274, an HTML hyperlink for each of the layout definition (FIG. 53) XML entries within the Ajax response is output to the web browser. After the user clicks on one of the layout entry hyperlinks 6275, processing continues to 6276.

In step 6276, an Ajax request is sent 6276 to the web service 150 containing the webpagecreate command and, as part of its web service arguments, the ID of the layout whose entry the user clicked. This in turn causes the web service 150 to create a new webpage (FIG. 59) that uses the specified layout (FIG. 53). If the Ajax response 6277 contains a success status code, processing continues to 6279; otherwise, it continues to 6278.

In step 6278, an HTML-formatted error message stating that the webpage (FIG. 59) could not be created is output to the web browser.

In step 6279, the user's web browser is redirected via Javascript to the Internet address of the XWM web application 6000 where the XWA client 6040 will then be executed (see FIG. 36).

FIG. 40 is a flowchart illustrating the process of a web browser executing the 404 component 6025.

In step 6290, the 404 component's 6025 HTML is displayed by a web browser. An Ajax request is sent 6291 to the web service 150 containing the listwebpages command and, as part of the web service arguments, the user's session 111 ID.

In step 6292, if the Ajax response contains a success status code, processing continues to 6294; otherwise, it continues to 6293.

In step 6293, an HTML-formatted error message stating that the webpages (FIG. 59) within the user website (FIG. 51) could not be listed is output to the web browser.

In step 6294, an HTML hyperlink for each of the webpage (FIG. 59) XML entries within the Ajax response is output to the web browser. After the user clicks on one of the webpage entry hyperlinks 6295, processing continues to 6296.

In step 6296, the user's web browser is redirected via Javascript to the Internet address for the XWM web application 6000 for the selected webpage (FIG. 59) entry where the XWA client 6040 will then be executed (see FIG. 36).

FIG. 41 is a flowchart illustrating the process of a web browser executing the generic error component 6026.

In step 6300, the generic error component's 6026 HTML is displayed by a web browser. An HTML-formatted error message stating that a generic error has occurred is output to the web browser along with an HTML input button labeled ‘ok’. After the user clicks the ‘ok’ button 6301, processing continues to 6302.

In step 6302, the user's web browser is redirected via Javascript to the Internet address for the XWM web application 6000 where the XWA client 6040 will then be executed (see FIG. 36).

FIG. 42 is a flowchart illustrating the process of a web browser executing the webpage content editor component 6027.

In step 6310, the webpage content editor component's 6027 HTML is displayed by a web browser. An Ajax request is sent 6311 to the web service 150 containing the loadwebpage command and, as part of the web service arguments, the user's session 111 ID and the user's selected webpage's (FIG. 59) ID. The complete XML data for each block (FIG. 62) and panel (FIG. 61) within the webpage (FIG. 59) that has the ID that was specified in the Ajax request is included as part of the Ajax response.

In step 6312, if the Ajax response contains a success status code, processing continues to 6314; otherwise, it continues to 6313.

In step 6313, Javascript is used to display a message dialog stating that the webpage content editor component 6027 could not be loaded and that the webpage (FIG. 59) will not be editable.

In step 6314, the first panel XML node is read from the Ajax response using Javascript. If a panel node does not exist within the Ajax response, processing continues to 6319; otherwise, processing continues to 6315.

In step 6315, if an HTML DOM element exists within the webpage with the same ID as the panel node's ID attribute, processing continues to 6316; otherwise, it continues to 6317.

In step 6316, Javascript is used to extend the functionality of the matching HTML DOM element into a panel tool (FIG. 43) by applying to it methods and properties for receiving and processing drag-and-drop events from the site tools' (FIG. 4) sidebar 6504.a and from block tools (FIG. 44). If additional panel nodes exist within the Ajax response 6317, the next panel node 6318 is read from the Ajax response and processed using the procedure described in step 6315; otherwise, processing continues to 6319.

In step 6319, the first block XML node is read from the Ajax response using Javascript. If a block node does not exist within the Ajax response, processing continues to 6324; otherwise, processing continues to 6320.

In step 6320, if an HTML DOM element exists within the webpage with the same ID as the block node's ID attribute, processing continues to 6321; otherwise, it continues to 6322.

In step 6322, Javascript is used to extend the functionality of the matching HTML DOM element into a block tool (FIG. 44) by applying to it methods and properties for receiving and processing mouse events as well as drag-and-drop events from the site tools' (FIG. 4) sidebar 6504.a and other block tools (FIG. 44). Methods and properties for receiving and processing mouse events, as well as drag-and-drop events, are also added to each HTML DOM element with an ID matching the ID of one of the field nodes within the block node to create field tools (FIG. 46) and to each HTML DOM element with an ID matching the ID of one of the fieldset nodes within the block node to create field set tools (FIG. 47). Additionally, using Javascript, DHTML elements containing a link are created for each field set tool (FIG. 47), are positioned at the bottom-left corner of the field set toot (FIG. 47) on the webpage and, when clicked, will add a new field (FIG. 64) or block (FIG. 62) to the field set (FIG. 65) represented by the field set tool (FIG. 47). Javascript is also used to dynamically construct HTML DOM elements that represent an overlay (FIG. 6) for this block tool. If additional block nodes exist within the Ajax response 6322, the next block node 6323 is read and processed using the procedure described in step 6320; otherwise, processing continues to 6324.

In step 6324, Javascript is used to capture mouse and keyboard user input events from the web browser to be received and processed by a central Javascript library that allows drag-and-drop events, mouse events and keyboard events to be received and handled by individual HTML DOM elements, such as those that make up block tools (FIG. 44), field tools (FIG. 46) and field set tools (FIG. 47).

In step 6325, each of the block tools (FIG. 44), field tools (FIG. 46) and field set tools (FIG. 47) created by the execution of this webpage content editor component 6310 is initialized using Javascript and begins processing and handling events as shown in their respective figures.

FIG. 43 is a flowchart illustrating the execution loop of a panel tool 6316. Panel tools execute asynchronously for as long as the webpage content editor component 6027 is active within the web browser. When initialized, the panel tool begins listening for mouse and keyboard events 6340.

In step 6341, if the user has dragged a block icon 6504.b from the site tools (FIG. 4) sidebar 6504.a over this panel tool, processing continues to 6342; otherwise, processing continues to 6351.

In step 6342, Javascript is used to create an HTML DOM element that represents a thin, horizontal bar indicating the location where a new block (FIG. 62) will be created and placed if the user releases the block icon 6504.b over this panel tool 6316. In a preferred embodiment, the indicator bar is positioned at the top left corner of the panel tool and is sized to the width of the panel tool and a height of approximately four pixels. If the panel (FIG. 61) associated with this panel tool contains blocks (FIG. 62), the indicator bar is preferably positioned at the bottom left corner of the panel tool.

In step 6343, if the user has released the block icon 6504.b over this panel tool, 6316 processing continues to 6344; otherwise, processing continues to 6351.

In step 6344, an Ajax request is sent to the web service 150 containing the createblock command and, as part of the web service arguments, the name of the block icon 6504.b and the ID of the panel (FIG. 61) associated with this panel tool. The complete XML data for the block (FIG. 62) that has been created as a result of the Ajax request is included as part of the Ajax response.

In step 6345, if the Ajax response contains a success status code, processing continues to 6347; otherwise, processing continues to 6346.

In step 6346, a message dialog is displayed stating that an error occurred and that the block (FIG. 62) could not be created.

In step 6347, if a css or js XML node exists within the Ajax response, processing continues to 6348; otherwise, processing continues to 6349.

In step 6348, Javascript is used to dynamically create an HTML DOM script element for each js XML node within the Ajax response, using the js node's filename attribute as the src attribute for the script element. Javascript is also used to dynamically create an HTML DOM link element for each css XML node within the Ajax response, using the css node's filename attribute for the rel attribute of the link element. The HTML DOM script and link elements are appended to the webpage's head element using Javascript. Adding these HTML DOM script and link elements allows the web browser to properly display and process the block (FIG. 62) after it is added to the webpage.

In step 6349, Javascript is used to read the html XML node from the Ajax response and create an HTML DOM element using the HTML read from the html node. The HTML DOM element is then appended to the panel tool's HTML DOM element, allowing the user to see the newly created block (FIG. 62) on the webpage within the web browser. The HTML DOM element is then made into a block tool 6350 following the same procedure as described in step 6321, which allows the user to interact with and modify the block (FIG. 62) directly on the webpage within the web browser.

In step 6351, if the user has dragged a block tool 6321 over this panel tool, processing continues to 6352; otherwise, it continues to 6341.

In step 6352, Javascript is used to append the block tool's 6321 HTML DOM element to this panel tool's HTML DOM element, which causes the block tool 6321 to be moved from its current location to this panel tool's HTML DOM element. The user will instantly see the block tool's 6321 change of placement on the webpage within the web browser.

In step 6353, if the user has released the block tool 6321 over this panel tool, processing continues to 6354; otherwise, it continues to 6341.

In step 6354, an Ajax request is sent to the web service 150 containing the placeblock command and, as part of the web service arguments, the ID of the block (FIG. 62) associated with the block tool 6321, the ID of the panel (FIG. 61) associated with this panel tool, and the ID of the currently active webpage (FIG. 59). The Ajax request causes the block's (FIG. 62) new placement to be saved within the user's webpage (FIG. 59).

FIG. 44 is a flowchart illustrating the execution loop of a block tool 6321. Block tools execute asynchronously for as long as the webpage content editor component 6027 is active within the web browser. When initialized, this block tool begins listening for mouse and keyboard events 6360.

In step 6361, if the user has dragged a block icon 6504.b from the site tools (FIG. 4) sidebar 6504.a over this block tool, processing continues to 6362; otherwise, it continues to 6371.

In step 6362, Javascript is used to create an HTML DOM element that represents a thin, horizontal or vertical bar indicating the location where a new block (FIG. 62) will be created and placed if the user releases the block icon 6504.b over this block tool. The indicator bar is positioned along the edge of this block tool that borders the sibling of this block tool that is nearest to the block icon 6504.b. A block tool's sibling is any other block tool that is within the same panel (FIG. 61) as this block tool and that appears immediately before or after this block tool.

In step 6363, if the user has released the block icon 6504.b over this block tool processing continues to 6364; otherwise, processing continues to 6371.

In step 6364, an Ajax request is sent to the web service 150 containing the createblock command and, as part of the web service arguments, the name of the block icon 6504.b, the ID of the block (FIG. 62) associated with this block tool (the reference block), and whether or not the new block (FIG. 62) should be placed before or after the reference block. The complete XML data for the block (FIG. 62) that has been created as a result of the Ajax request is included as part of the Ajax response.

In step 6365, if the Ajax response contains a success status code, processing continues to 6367; otherwise, processing continues to 6366.

In step 6366, a message dialog is displayed stating that an error occurred and that the block (FIG. 62) could not be created.

In step 6367, if a css or js XML node exists within the Ajax response, processing continues to 6368; otherwise, processing continues to 6369.

In step 6368, Javascript is used to dynamically create an HTML DOM script element for each js XML node within the Ajax response, using the js node's filename attribute as the src attribute for the script element. Javascript is also used to dynamically create an HTML DOM link element for each css XML node within the Ajax response, using the css node's filename attribute for the rel attribute of the link element. The HTML DOM script and link elements are appended to the webpage's head element using Javascript. Adding these HTML DOM script and link elements allows the web browser to property display and process the block (FIG. 62) after it is added to the webpage.

In step 6369, Javascript is used to read the html XML node from the Ajax response and create an HTML DOM element using the HTML read from the html node. The HTML DOM element is then appended to the panel tool's HTML DOM element, allowing the user to see the newly created block (FIG. 62) on the webpage within the web browser. The HTML DOM element is then made into a block tool 6370 following the same procedure as described in step 6321, which allows the user to interact with and modify the block (FIG. 62) directly on the webpage within the web browser.

In step 6371, if the user has dragged a block tool 6321 over this block tool, processing continues to 6372; otherwise, it continues to 6375.

In step 6372, Javascript is used to move the dragged block tool from its current location to a location that is adjacent to this block tool. Depending on the dragged block tool's location in relation to this block tool's siblings, the dragged block tool's HTML DOM element is either appended before or after this block tool's HTML DOM element. The dragged block tool is appended before this block tool if the dragged block tool 6321 is positioned closest to this block tool's previous sibling and after if it is positioned closest to this block tool's next sibling. The user will instantly see the dragged block tool's change of placement on the webpage within the web browser.

In step 6373, if the user has released the block tool 6321 over this block tool, processing continues to 6374; otherwise, it continues to 6375.

In step 6374, an Ajax request is sent to the web service 150 containing the placeblock command and, as part of the web service arguments, the ID of the block (FIG. 62) associated with the dragged block tool that has been released over this block tool, the ID of the block (FIG. 62) associated with this block tool (the “reference block”), whether or not the new block (FIG. 62) should be created before or after the reference block, and the ID of the currently active webpage (FIG. 59). The Ajax request causes the block's (FIG. 62) new placement to be saved within the user's webpage (FIG. 59).

In step 6375, if the user has moved his mouse over this block tool 6321, processing continues to 6376; otherwise, it continues to 6377.

In step 6376, Javascript is used to display this block tool's 6321 overlay (FIG. 6) by setting its visibility CSS property to ‘visible’ and its display CSS property to ‘block’.

In step 6377, if the user has moved his mouse out of this block tool 6321, processing continues to 6378; otherwise, it continues to 6361.

In step 6378, if there are no field tools (FIG. 46) within this block tool 6321 that are currently in editable mode 6427, Javascript is used to hide this block tool's 6321 overlay (FIG. 6) by setting its visibility CSS property to ‘hidden’ and its display CSS property to ‘none’.

FIG. 45 is a flowchart illustrating the execution loop of a block tool's 6321 overlay (FIG. 6). Block tool overlays execute asynchronously for as long as the webpage content editor component 6027 is active within the web browser and the block tool overlay is visible. When initialized, block tool overlays begin listening for mouse and keyboard events 6390.

In step 6391, if the user has clicked the delete tool 6384, processing continues to 6392; otherwise, it continues to 6396.

In step 6392, an Ajax request is sent to web service 150 containing the deleteblock command and the ID of the block (FIG. 62) associated with this block tool overlay.

In step 6393, if the Ajax response contains a success status code, processing continues to 6394; otherwise, it continues to 6395.

In step 6394, Javascript is used to remove from the HTML DOM both this block tool overlay's DOM element and the DOM element of the block tool 6321 that is associated with this block tool overlay. This action instantly removes the block tool 6321 and this block tool overlay from the webpage within the web browser, giving the user visual feedback that the block (FIG. 62) has been deleted.

In step 6395, a message dialog is displayed stating that an error occurred and that the block (FIG. 62) could not be deleted.

In step 6396, if the user has clicked the sticky tool 6382, processing continues to 6397; otherwise, it continues to 6401.

In step 6397, the component property of the block (FIG. 62) associated with this overlay (FIG. 6) is toggled between an active and inactive state. If the component property of the block tool 6321 associated with this overlay (FIG. 6) is boolean false (inactive), an Ajax request is sent to the web service 150 containing the setcomponent command and, as part of its web service arguments, the ID of the block (FIG. 62) that is to be made into a component. This in turn causes the web service 150 to convert the block (FIG. 62) from a regular block (FIG. 62) to a component (FIG. 58, reference number 506) (a “component” being a regular block whose component property is active or Boolean true, making the component automatically appear on every page of the website). Otherwise, if the component property of the block tool associated with this overlay is Boolean true (active), an Ajax request is sent to the web service 150 containing the unsetcomponent command and, as part of its web service arguments, the ID of the block (FIG. 62) that is to be made into a regular block. This in turn causes the web service 150 to convert the block (FIG. 62) from a component 506 to a regular block (FIG. 62).

In step 6398, if the Ajax response contains a success status code, processing continues to 6399; otherwise, it continues to 6400.

In step 6399, using Javascript, the graphic used to represent the sticky tool 6382 is exchanged with one of two images; one image represents an active state and is used if the block's component property is set to ‘true’, and the other represents an inactive state and is used if the block's component property is set to ‘false’. This is the only visual cue provided to the user as to the current role of a block (FIG. 62).

In step 6400, a message dialog is displayed stating to the user that an error occurred while attempting to toggle the component status of the block (FIG. 62).

In step 6401, if the user has clicked the properties tool (see FIG. 6, reference 6383), processing continues to 6402; otherwise, it continues to 6406.

In step 6402, an Ajax request is sent to the web service 150 containing the loadproperties command and, as part of its web service attributes, the ID of the block (FIG. 62) that is associated with this block tool. This in turn causes the web service 150 to output as part of its Ajax response the complete XML data for the block's (FIG. 62) properties 556.

In step 6403, if the Ajax response contains a success status code, processing continues to 6404; otherwise, it continues to 6405.

In step 6404, the block's (FIG. 62) properties 556 are read from the Ajax response and displayed within the properties dialog as indicated in FIG. 9, providing to the user a graphical toolset which allows changes to the block's (FIG. 62) properties 556 to be made and saved by the user.

In step 6405, a message dialog is displayed stating to the user that an error occurred while attempting to retrieve the block's (FIG. 62) properties 556.

In step 6406, if the save tools 6385 are visible, processing continue to 6407; otherwise, it continues to 6391.

In step 6407, if the user has clicked the save button 6387, processing continues to 6408; otherwise, it continues to 6411.

In step 6408, an Ajax request is sent to the web service 150 containing the saveblock command and, as part of the web service arguments, the IDs and values 578 of the block's properties fields 570 that have been changed by the user. This in turn causes the web service 150 to save said changes.

In step 6409, if the Ajax response contains a success status code, processing continues to 6413; otherwise, it continues to 6410.

In step 6410, a message dialog is displayed stating to the user that an error occurred while attempting to save the changes made to the block's (FIG. 62) properties 556.

In step 6411, if the user has clicked the cancel button 6386, processing continues to 6412; otherwise, it continues to 6391.

In step 6412, the block tool 6321 associated with this overlay (FIG. 6) is reverted to its original state before the user began editing it. For each field tool (FIG. 46) within the block tool 6321 associated with this overlay (FIG. 6) that is currently in editable mode 6427, the values 578 of the fields 570 are reverted back to their original values 578 as they were before the field tool (FIG. 46) entered editable mode 6427. At the same time, the field tool's (FIG. 46) HTML is reverted to its original HTML as it was before the field tool (FIG. 46) entered editable mode 6427.

In step 6413, the editable mode 6427 is disabled for each field tool (FIG. 46) within the block tool 6321 that is associated with this overlay (FIG. 6). This is done by setting the content/Editable property to ‘false’ and the designMode property to ‘off’ for each field tool's (FIG. 46) HTML DOM element.

In step 6414, this overlay's (FIG. 6) save tools 6385 are hidden using Javascript by settings the CSS visibility property to ‘hidden’ and the CSS display property to ‘none’.

FIG. 46 is a flowchart illustrating the execution loop of a field tool. Field tools are created as a part of block tools (FIG. 44) and execute asynchronously for as long as the webpage content editor component 6027 is running. When initialized, the field tool begins listening for mouse and keyboard events 6420.

In step 6421, if the user has moved the mouse over this field tool, processing continues to 6422; otherwise, it continues to 6424.

In step 6422, if this field tool is in editable mode 6427, processing continues to 6424; otherwise, it continues to 6423.

In step 6423, using Javascript, the DHTML element overlay for this field tool is placed at the same position and size of this field tool and displayed on top of this field tool at 50% opacity. This illustrates to the user the content that is contained within this field tool that can be edited upon clicking on this field tool.

In step 6424, if the user has clicked on this field tool, processing continues to 6425; otherwise, it continues to 6429.

In step 6425, the edit tools (FIG. 5) toolbar is displayed using Javascript by setting the CSS visibility property to ‘visible’ and the CSS display property to ‘block’.

In step 6426, if this field tool is in editable mode 6427, processing continues to 6429; otherwise, it continues to 6427.

In step 6427, the editable mode is enabled for this field tool by setting its Javascript designMode property to ‘on’ and its Javascript contentEditable property to ‘enabled’. This allows the user to click within the field tool and begin typing to alter its contents directly on the webpage. This also allows the edit tools (FIG. 5) toolbar to affect the content within this field tool using the Javascript execCommand function. The web browser handles the creation of the HTML for this editable content behind the scenes, allowing the user to edit the content in a WYSIWYG environment with no need to understand or use HTML.

In step 6428, the overlay (FIG. 6) and its save tools 6385 for the top-most parent block tool 6321 associated with this field tool are displayed using Javascript by adjusting the CSS visibility property to ‘visible’ and the display property to ‘block’. The overlay (FIG. 6) and save tools 6385 will be visible until either the save button 6387 or cancel button 6386 is clicked.

In step 6429, if the user has moved the mouse out of this field tool, processing continues to 6429; otherwise, it continues to 6421.

In step 6430, if this field tool is currently in editable mode 6427, processing continues to 6421; otherwise, it continues to 6430.

In step 6431, the overlay for this field tool is hidden using Javascript by adjusting the CSS visibility property to ‘hidden’ and the CSS display property to ‘none’.

FIG. 47 is a flowchart illustrating the execution loop of a field set tool. Field set tools are created as a part of block tools 6321 and execute asynchronously for as long as the webpage content editor component 6027 is running. When initialized, the field set tool begins listening for mouse and keyboard events 6440.

In step 6441, if the user has clicked the field set tool's link (see FIG. 42, reference number 6322) for adding a new field (FIG. 64) to the field set (FIG. 65), processing continues to 6442; otherwise, it continues to 6441.

In step 6442, an Ajax request is sent to the web service 150 containing the createfield command and, as part of its web service arguments, the ID of the field set 590 to affect. This in turn causes the web service 150 to create a new field (FIG. 64) within the specified field set (FIG. 65) and contain within its Ajax response the full HTML required to displayed said new field. The specific data type of the field (FIG. 64) that is added to the field set (FIG. 65), or the type of block that is added to the field set (FIG. 65), is determined by the field data type 594 defined by the field set (FIG. 65) itself.

In step 6443, if the Ajax response contains a success status code, processing continues to 6444; otherwise, it continues to 6445.

In step 6444, the HTML for the new field is read from the Ajax response and, using Javascript, a DHTML element is created from the field's HTML then appended to the field set tool's HTML DOM element, allowing the user to see the new field (FIG. 64) instantly within the web browser. If the field set's (FIG. 65) data type 594 is a field 594.a, a field tool is created from the new field (FIG. 64) using the same procedure as shown in FIG. 46. If the field set's (FIG. 65) data type 594 is set to ‘block’ (FIG. 62), a block tool 6321 is created from the new field (FIG. 64) using the same procedure as shown is FIG. 44.

In step 6445, a message dialog is displayed to the user stating that an error occurred while attempting to add a new entry to the field set 590.

D. Files and folders (FIGS. 48-57)

FIG. 48 is a diagram of the structure and contents of the XWM application folder. The XWM application folder 300 is the physical folder located on a computer storage medium, such as a hard disk drive, within which the XWM application 130 operates. The XWM application 130 is responsible for managing the physical files and folders within the XWM application folder.

The configuration folder 301 contains an XML-formatted settings file 302 that defines the behavior and settings of the XWM application 130, the most notable being the software mode, which can be set to one of three modes: standard mode, developer mode, and demo mode. Standard mode allows the XWM application 130 to create and manage user websites (FIG. 51) within their respective user folders (FIG. 50). Developer mode allows the XWM application 130 to create and manage developer products 321 within their respective developer folders 320. Demo mode allows the XWM application 130 to create temporary user websites (FIG. 51) for guest users or users who do not have a user account 212 within the AMS 200. A guest user's website is deleted after the guest user's session expires. In addition to these software modes, the following settings are also able to be set within the XWM application's 130 settings file: (1) the length of time, in seconds, of user inactivity before a user session 111 expires; (2) the host name or IP address, port and path needed to create a TCP/IP network connection to the AMS 200 web service 240; and (3) the host name or IP address, database name, username and password needed to create a network connection to the SQL database 110.

The properties folder 303 contains properties files that are assigned to all blocks (FIG. 62), webpages (FIG. 59) and websites (FIG. 58) managed by the XWM application 130. These properties are used to define the behavior, settings and attributes of blocks (FIG. 62), webpages (FIG. 59) and websites (FIG. 58). Property files 310, 311, 312 are XML-formatted files that share the same data structure as blocks (FIG. 62). Within the property files, default field values 578 and attributes 574 may be defined. Properties are dynamically imported at runtime by blocks (FIG. 62), webpages (FIG. 59) and websites (FIG. 58) when they are first created, allowing each to maintain its own unique field values 578 and attributes 574 for the imported properties, or, by leaving a value empty, to use the value defined within the imported property file. Property files can be added to and removed from the properties folder at any time by the system administrator. Each time a block (FIG. 62), webpage (FIG. 59) or website (FIG. 58) is loaded, it adds or removes any properties necessary to reflect any added or removed property files within the properties folder.

The block folder 303.a contains property files 310 that are assigned to all blocks (FIG. 62). Three block property files are included with the XWM application 130: border, margin and padding These property files assign HTML CSS styles to blocks (FIG. 62) in order to allow the user to control the appearance of each block (FIG. 62) within his webpages (FIG. 59). The border properties apply a border style, thickness and color to blocks (FIG. 62). The Margin properties apply spacing outside of the top, right, bottom and left edges of a block (FIG. 62). The padding properties apply spacing inside of the top, right, bottom and left edges of a block (FIG. 62).

The webpage folder 303.b contains property files 311 that are assigned to all webpages (FIG. 59). Two webpage property files are included with the XWM application 130: general and search engine. The general property file contains the title, layout and categories properties and is required to exist in order for a webpage to load properly. The title property is a text string representing the name of a webpage (FIG. 59). The categories property is a comma-separated list of webpage IDs 521 to which the webpage (FIG. 59) is assigned; these webpage IDs allows a hierarchy of webpages (FIG. 59) to be created. The individual webpage IDs 521 within the categories property are saved to the webpage registry 620 file. The layout property is the ID of the layout (FIG. 60) used by the webpage. The search engine property file contains the meta title, meta description and meta keywords properties, each of which are text strings that are assigned to HTML meta tags within the webpage's (FIG. 59) HTML head tag when displayed within a web browser, ensuring that the webpage (FIG. 59) will be indexed on search engines such as Google or Yahoo!.

The website folder 303.c contains property files 312 that are assigned to all websites (FIG. 58). Three website property files are included with the XWM application 130: general, publish and email. The general property file contains the homepage property, which is assigned to the ID of a specific webpage (FIG. 59) that is to represent the default webpage (FIG. 59) for the website (FIG. 58) (the home page). The publish property file contains the host name, port, username, password and path properties, which are used by the XWM application 130 to connect to a remote web server that is accessible to the Internet through an IP address or a fully qualified domain name, allowing the website (FIG. 58) to be transferred to the remote server and published to the Internet. In a preferred embodiment, the XWM application uses the FTP protocol when connecting to the remote server. The email property file contains the host name, port, username and password properties that are used by the XWM application 130 to send email using the simple mail transfer protocol (SMTP). The email properties are global to the user website (FIG. 51), allowing any block definition's (FIG. 54) render module 410 access to the XWM application's 130 email capabilities and, thus, allowing individual blocks (FIG. 62) to send email from webpages (FIG. 59).

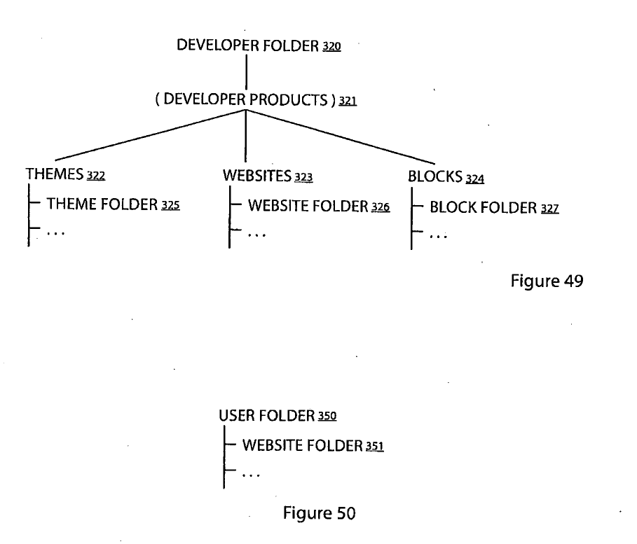

The developers 304 folder contains one folder 308 for each developer who is registered with the XWM 100. Each folder 308 is a developer folder (FIG. 49) and is named with the unique ID of the developer.

The packages 305 folder contains source code libraries that extend the functionality of the XWM application and are dynamically loaded by the XWM application 130 at the time it is instantiated.

The products 306 folder maintains a synced copy of the approved developer products 1001 folder. The folder is synced over a network connection using a network utility such as rsync.

The users 307 folder contains one folder 309 for each user who owns a website (FIG. 58) that is registered with the XWM 100. Each folder 309 is a user folder (FIG. 50) and is named with the unique ID of the user.

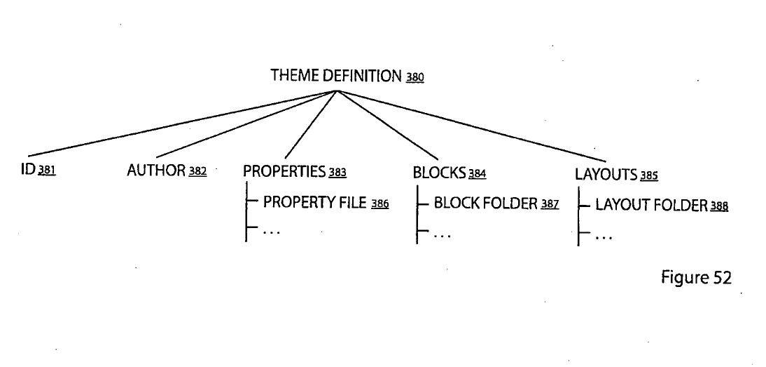

FIG. 49 is a diagram of the structure and contents of the developer folder. The developer folder 320 contains a developer products 321 folder for each developer who is registered with the XWM 100 and is only used when the XWM application 130 is configured for developer mode 302. Each developer products 321 folder may only be accessed by the developer who is assigned to the folder. Each developer products 321 folder contains one or more folders for themes 322, websites 323 and blocks 324. Each themes 322 folder is a theme definition (FIG. 52), each websites 323 folder is a user website (FIG. 51), and each blocks 324 folder is a block definition (FIG. 54).

FIG. 50 is a diagram of the structure and contents of a user folder. A user folder 350 exists for each user who has a user website (FIG. 51) registered with the XWM (FIG. 1). Each user folder 350 contains one or more website folders 351, and each website folder 351 is a user website (FIG. 51).

FIG. 51 is a diagram of the structure and contents of a user website folder. A user website 360 contains all of the webpages (FIG. 59), images, properties and documents needed to form a complete website that can be managed by the XWM (FIG. 1). The website file 363 is a website (FIG. 58), and it contains the global settings and properties for this user website 360. The registry file 364 is a webpage registry (FIG. 68), and it maintains an index of all the webpages 361 within this user website. The webpages 361 folder contains a webpage file 375 for each webpage within this user website, and each webpage file 375 is a webpage (FIG. 59). The media 362 folder contains each of the image 365 files 369, document 366 files 370, audio 367 files 371, and movie 368 files 372 uploaded to this user website by the user or developer who maintains this user website. It also contains a media index 373 file, which maintains an index of each file that has been uploaded to this website, and a media tags 374 file, which maintains associations of keywords with uploaded files. The media index 373 file is a media registry (FIG. 70), and the media tags file 374 is a media tags (FIG. 73) registry. Image files 369 include any type of graphical or bitmap file format, such as jpeg, gif and png. Audio files 371 include any type of audio file format, such as wav, aiff, aac, and mp3. Movie files 372 include any type of video file format, such as avi, mpeg, wmv and flv. Document files 370 include any type of file format that does not belong within the images 365, audio 367 or movies 368 folders, such as doe, pdf, txt and rtf.

FIG. 52 is a diagram of the structure and contents of a theme definition folder. A theme definition folder contains files that define the appearance and physical layout of a user website (FIG. 51). Theme definitions are referenced by user websites (FIG. 51), and more than one user website (FIG. 51) may reference the same theme definition, causing theme definitions to serve as a design and feature template for user websites (FIG. 51). Each theme definition is assigned a unique ID 381 at the time it is created, and the theme definition is stored within a folder using the unique ID 381 as its name. User websites (FIG. 51) reference theme definitions by their unique ID 381. The ID of the user who created the theme definition, the author 382, is stored within the theme definition folder.

Additionally, each theme definition folder contains a properties 383 folder, blocks 384 folder and layouts 385 folder. The properties 383 folder contains one or more property files 386, which are imported to any user website (FIG. 51) that references this theme definition in its website file 363. Each property file 386 shares the same format as a block (FIG. 62) (see FIG. 48, reference number 303). The blocks 384 folder contains one or more block folders 387, which are imported to any user website (FIG. 51) that references this theme definition in its website file 363. Each block folder 387 is a block definition (FIG. 54), and it represents the only types of blocks (FIG. 62) that can be added to webpages (FIG. 59) within any user website (FIG. 51) that references this theme definition. The layouts 385 folder contains one or more layout folders 388, which are imported to any user website (FIG. 51) that references this theme definition in its website file 363. Each layout folder 388 is a layout definition (FIG. 53), and it represents the only types of layouts (FIG. 60) that can be added to webpages (FIG. 59) within any user web site (FIG. 51) that references this theme definition.

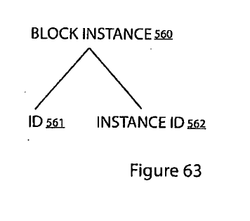

FIG. 53 is a diagram of the structure and contents of a layout definition folder. A layout definition 390 is a folder containing files that describe a physical layout for a webpage (FIG. 59) within a user website (FIG. 51). A physical layout is the arrangement of content within a webpage, and it is composed of one or more panels. Panels are areas within a layout in which blocks (FIG. 62) and block instances (FIG. 63) can be placed. Blocks and block instances form the content, or text and images, of a webpage (FIG. 59). The layout file 395 is a layout (FIG. 60).

The media 391 folder contains icon 392 and thumbnail 393 image files, which provide a graphical representation of the layout definition, with the icon 392 image being considerably smaller and less detailed than the thumbnail 393 image. The thumbnail 393 image graphically illustrates the appearance of this layout definition, usually showing the arrangement of panels that make up this layout definition. The media 391 folder also contains an images 394 folder, which contains one or more image files that are used as part of the visual appearance of this layout definition when displaying this layout definition as a webpage within a web browser. This layout definition's render module 399 or style 397 file may reference these images 394.

The scripts 396 folder contains files used to properly output this layout definition to a webpage within a web browser. It contains a style 397 file, a script 398 file and a render module 399. The style 397 file is a CSS that will be placed within the HTML of any webpage (FIG. 59) that is output to a web browser using this layout. The style 397 file is optional and is used to provide easier management of the look and feel of this layout definition. Generally, any CSS styles defined in this file will be referenced within this layout definition's render module 399. The script 398 file is a Javascript file that will be placed within the HTML of any webpage (FIG. 59) that is output to a web browser using this layout. The script 398 file is optional and is used to provide extended capabilities to this layout, as determined by the author of the layout definition. Generally, any Javascript methods or properties defined in this file will be referenced within this layout's render module 399.

The render module 399 is a script or compiled library that is imported to the XWM application 130 when it needs to output a webpage (FIG. 59) that uses this layout definition (FIG. 53) to a web browser. The render module 399, when executed, returns the HTML output for a webpage (FIG. 59) that uses this layout. The XWM application 130 will provide a list of each block contained within each panel defined by this layout definition. The render module will request from the XWM application 130 the blocks for individual panels within this layout definition and then render them using the block's (FIG. 54) render module 410. As each block is output, any required support media, such as the block's (FIG. 54) style 408 file and script 409 files, will be returned by the block's (FIG. 54) render module so that they can be linked within the HTML output of the webpage (FIG. 59) by the render module 399. Additionally, the render module 399 may access any properties of the webpage (FIG. 59), such as meta tags, title and other properties, when generating the HTML output for the webpage (FIG. 59).

FIG. 54 is a diagram of the structure and contents of a block definition folder. A block definition 400 contains files that describe the structure and appearance of a block, which is the basic component used to store content within one of a layout's (FIG. 60) panels. The block file 406 is a block (FIG. 62), and it represents user-editable content, such as text and images, that appears on a webpage.

The properties 401 folder contains one or more property files 411, which are imported to any webpage (FIG. 59) that references this block definition in one or more of its panels 524. Each property file 411 shares the same format as a block (see FIG. 62; see also FIG. 48, reference number 303.) This scheme allows the XWM application 130 to provide a global set of properties to each block (FIG. 62) within a website, while allowing the developer of this block definition (FIG. 54) to specify additional custom properties for any block (FIG. 62) created from this block definition. Block properties, once imported to a block (FIG. 62), are assigned to that block (FIG. 62), specifically overriding any global properties that may have previously applied to the block (FIG. 62). A block (FIG. 62) can, however, revert to using a global property by leaving the value of an overridden property blank.

The media 402 folder contains icon 403 and thumbnail 404 image files, which provide a graphical representation of the block definition, with the icon 403 image being considerably smaller and less detailed than the thumbnail 404 image. The thumbnail 393 image graphically illustrates the appearance of this block definition when output by the render module 410. The media 402 folder also contains an images 405 folder, which contains one or more image files that are used as part of the visual appearance of this block definition when displaying a block (FIG. 62) that references this block definition within a webpage. This block definition's render module 410 or style 408 file may reference these images 405.

The scripts 407 folder contains files used to properly output a block (FIG. 62) that references this block definition to a webpage within a web browser. It contains a style 408 file, a script 409 file and a render module 410. The style 408 file is a CSS that will be placed within the HTML of any webpage (FIG. 59) that is output to a web browser using this block definition. The style 408 file is optional and is used to provide easier management of the look and feel of this block definition when output to a web browser. Generally, any CSS styles defined in this file will be referenced within this block definition's render module 410. The script 409 file is a Javascript file that will be placed within the HTML of any webpage (FIG. 59) that references this block definition and is output to a web browser. This file is optional and is used to provide extended capabilities to this block definition, as determined by the author of the block definition. Generally, any Javascript methods or properties defined in this file will be referenced within this block's render module 410.

The render module 410 is a script or compiled library that is imported to the XWM application 130 when it needs to output a block (FIG. 62) that references this block definition to a web browser. The render module 410, when executed, returns the HTML output for a block (FIG. 62) that uses this block definition. The render module has access to each of the block's (FIG. 62) field 570 values 578 and attributes 574 and references them to aid in constructing the HTML output for this block. When a block is output by the render module 410, any required support media, such as the block definition's style 408 file and script 409 files, will be returned by the block definition's render module so that they can be linked within the HTML output of the webpage (FIG. 59).

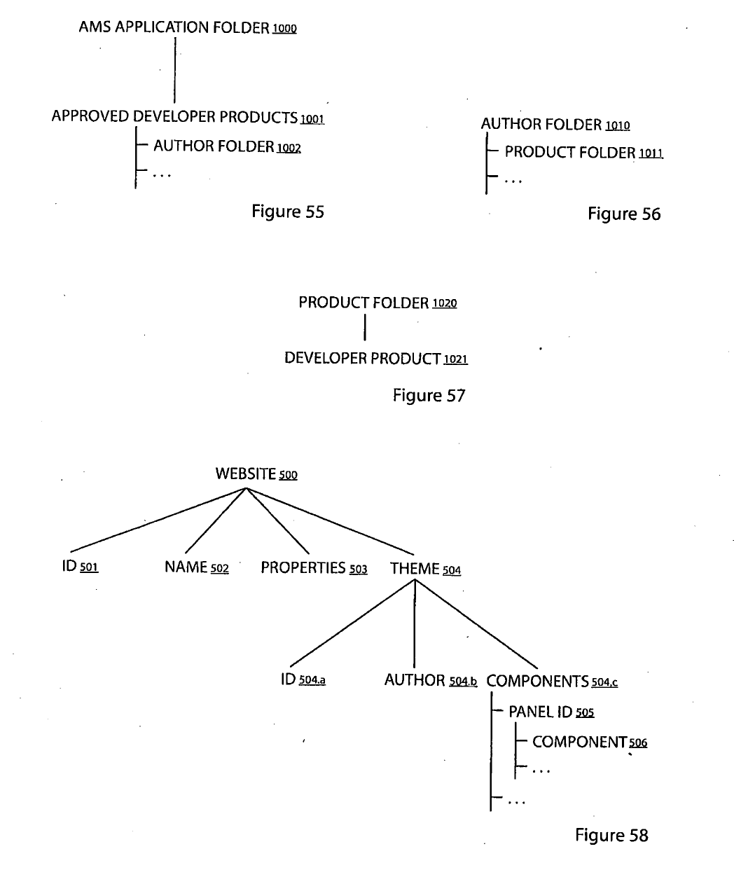

FIG. 55 is a diagram of the structure and contents of the AMS application folder. The AMS application folder 1000 is a physical folder located on a computer storage medium, such as a hard disk drive, within which the AMS (FIG. 2) application 230 operates. The AMS (FIG. 2) application 230 is responsible for managing the physical files and folders within the AMS application folder. The approved developer products 1001 folder contains a copy of all the published developer products (FIG. 49) (see FIG. 2, reference number 235). The author folder 1002 is an author folder (FIG. 56) that is used to group published developer products by folders of the users who created the products.

FIG. 56 is a diagram of the structure and contents of the author folder. An author folder 1010 contains a product folder 1011 (see FIG. 57) for each developer product (FIG. 49) created by a specific developer. The author folder is named using the unique ID of the developer whose products are contained within this folder.

FIG. 57 is a diagram of the structure and contents of the product folder. A product folder 1020 contains a single developer product 1021 (see FIG. 49). The product folder is named using the unique ID of the developer product 1021 contained within the folder.

E. Data Formats (FIGS. 58-74)

FIG. 58 is a diagram of the structure of a website file. A website 500 file is an XML-formatted file used to define a website's settings and properties through the ID 501, name 502, properties 503 and theme 504 XML nodes. The ID 501 node is a unique ID that is assigned to this website at the time it is created. The name 502 node is a name that is assigned to this website by the author of the website, and it is used to help the author identify this website when presented in a listing of multiple websites. The properties 503 node contains each of the standard website properties (FIG. 48, notation 303.c), as well as any imported website properties (FIG. 52, notation 383). This scheme allows the XWM application 130 to provide a global set of properties to all websites while allowing additional, theme definition (FIG. 52) specific properties to be associated with individual websites. The theme 504 node references a specific theme definition (FIG. 52) with its id 504.a and author 504.b attributes. The id 504.a attribute references the theme definition's (FIG. 54) unique ID and the author 504.b attribute references the unique ID of the author of the theme definition (FIG. 54).

The components 504.c node contains each of the components 506 used throughout the webpages (FIG. 59) in this website, grouped by the default panel 505 within which the component 506 should be placed on the webpages (FIG. 59). Components 506 are blocks (FIG. 62) that are shared by all webpages within the website. Any block (FIG. 62) on any webpage (FIG. 59) can be converted to a component at any time. Components 506 are represented in webpages (FIG. 59) in the form of block instances (FIG. 63) rather than regular blocks (FIG. 62). A block instance (FIG. 63) references a component 506, and the block instance displays the referenced component on a webpage in the form of a block tool (FIG. 6). A block instance (FIG. 63) can be converted to a regular block (FIG. 62) at will; however, converting a block instance (FIG. 63) back to a regular block (FIG. 62) will remove the component 506 represented by that block instance (FIG. 63) and, as such, remove the block instances (FIG. 63) for that component 506 from every other webpage (FIG. 59) in the website. Alternatively, block instances (FIG. 63) can be deleted from individual webpages (FIG. 59) without deleting the component 506 and without deleting the block instances (FIG. 63) from the other webpages (FIG. 59).

The field 570 values 578 and attributes 574 for a component 506 are shared by all block instances (FIG. 63) referencing the component 506. Components 506 have several settings to define their behavior, including: properties, automatic placement, and existing pages. Properties are the properties of a component 506 that are shared by all block instances (FIG. 63) that reference the component 506 by default. Individual block instances (FIG. 63) do not maintain unique properties for the component 506. Components 506 can be configured to allow individual block instances (FIG. 63) to maintain their own unique properties for the component. As a supplement to this option, the component 506 can also be configured as to whether or not block instances (FIG. 63) should inherit properties from the component 506. If inheritance is enabled, any property field 570, value 578, or attribute 574 left blank by a block instance (FIG. 63) will inherit its value 578 from the component 506.

The automatic placement option, when enabled, forces components 506 to be placed automatically on all webpages (FIG. 59). Any webpage (FIG. 59) that does not have a block instance (FIG. 63) for this component 506 will have one automatically placed the next time the webpage (FIG. 59) is accessed. The component 506 can be configured to specify in which panel the block instance (FIG. 63) should be placed by default. Once the block instance (FIG. 63) is added, the user may specify a new panel within which it is to be placed.

If the existing pages option is activated, the component 506 will be added to any existing webpage (FIG. 59) that does not currently contain a block instance (FIG. 63) for this component 506. The block instances (FIG. 63) will be added to the component's 506 default panel, but the user or developer can manually place the block instances (FIG. 63) in new panels on an individual webpage (FIG. 59) basis.

The panel ID node is a text string that references the name of the layout (FIG. 60) panel 538 in which the components 506 should be placed by default.

FIG. 59 is a diagram of the structure of a webpage file. A webpage 520 is an XML-formatted file that contains a unique ID 521 for the webpage as well as properties 522 and content 523, such as text and images, that can be managed by the XWM (FIG. 1) application 130. The properties 522 node defines the global settings, behavior and attributes of the webpage, and it contains each of the standard webpage properties (FIG. 48, notation 303.b) that are imported automatically each time a webpage is created or any time the standard webpage properties are updated. This scheme allows the XWM application 130 to provide a global set of properties to all webpages.

Webpage content 523 is represented in the form of blocks (FIG. 62) and block instances (FIG. 63) that are placed and arranged within panel 524 nodes. Each panel 524 node references a layout (FIG. 60) panel 538 from the theme definition of which the webpage is a member. The order in which blocks (FIG. 62) and block instances (FIG. 63) appear within each panel 524 node is the same as that in which they appear when viewing the webpage (FIG. 59) in a web browser. The XWM (FIG. 1) application 130 is capable of rearranging the blocks (FIG. 62) and block instances (FIG. 63) within each panel 524 node and moving blocks (FIG. 62) and block instances (FIG. 63) from one panel 524 node to another.

FIG. 60 is a diagram of the structure of a layout file. A layout 530 is an XML-formatted file that defines the arrangement of content within a webpage (FIG. 59) and is composed of one or more panels 537. The layout ID 531 node is a text string containing a short name, with no spaces and only alpha-numeric characters, that is assigned to the layout by the developer who created it. The name 532 node is a text string containing the full title of this layout, and the description 533 node is a text string containing a short description of this layout. The panels 537 node contains each of the panels 538 (see also FIG. 61) that are available to webpages that use this layout.

FIG. 61 is a diagram of the structure of a panel. A panel 540 is an XML-formatted data structure that defines the areas within a layout (FIG. 60) in which content such as blocks (FIG. 62) and block instances (FIG. 63) can be placed. When a panel is displayed within a webpage content editor component (FIG. 42), it is represented as a panel tool (FIG. 43), which is the GUI mechanism that allows the user to manage the order and types of content that are within the panel. The panel ID 541 node is a text string containing a short name, with no spaces and only alpha-numeric characters, that is assigned to the panel by the developer who created it. The info 542 node contains basic information about this panel, including its name 543 and description 544. The name 543 node is a text string that contains the full title of this panel as defined by the developer who created it. The description 544 node is a text string that contains a short description of this panel as defined by the developer who created it.

FIG. 62 is a diagram of the structure of a block. A block 550 is an XML-formatted data structure that defines the basic component that is used to store content within a webpage's (FIG. 59) panel 524. The block ID 551 node is a text string containing a unique ID for the block that is automatically generated and assigned at the time the block is created. The name 552 node is a text string containing a short name, with no spaces and only alpha-numeric characters, that is assigned to the block by the developer who created it. The info 553 node contains basic information about this block, including its label 553.a and description 553.b. The label 553.a node is a text string that contains the full title of this panel as defined by the developer who created it. The description 553.b node is a text string that contains a short description of this block as defined by the developer who created it. The properties 556 node contains each of the standard block properties (FIG. 48, notation 303.a), as well as any imported block properties (FIG. 54, notation 401). This scheme allows the XWM application 130 to provide a global set of properties to all blocks while allowing additional, block definition (FIG. 54) specific properties to be associated with individual blocks. The fields 557 node contains one or more field 554 (see also FIG. 64) nodes, and the field sets 558 node contains one or more field set 555 (see also FIG. 65) nodes. The class 559 node is a text string that contains an arbitrary, optional text value used to describe the namespace or behavior of this block. When a block is displayed within a webpage content editor component (FIG. 42), it is represented as a block tool (FIG. 43), which is the GUI mechanism that allows the user to manage the values of the fields 557 and field sets 558 that are contained within the block.

FIG. 63 is a diagram of the structure of a block instance. A block instance is an XML-formatted data structure used to reference a component (FIG. 58, reference number 504.c) that is placed within a webpage's (FIG. 59) panel 524. The referenced component 504.c will be output on the webpage (FIG. 59) in the place of the block instance. The ID 561 node is a unique ID that is assigned to the block instance at the time it is first added to a webpage (FIG. 59), and the instance ID 562 node is the unique ID of the component 504.c that the block instance references.

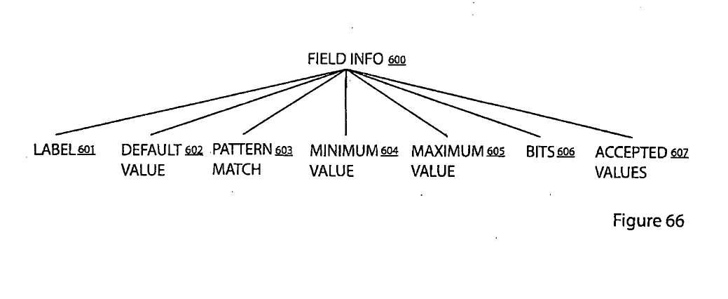

FIG. 64 is a diagram of the structure of a field. A field 570 is an XML-formatted data structure containing a scalar data type and value with one or more optional, arbitrary attribute and value pairs. A field 570 is always a member of a block (FIG. 62, notation 554). The field ID 571 node is a unique ID that is automatically generated and assigned to this field when the block (FIG. 62) to which this field belongs is first created. The name 572 node is a text string containing the full title of the field as defined by the developer who created it. The field info 579 node represents a field info (FIG. 66) data structure, which defines additional parameters of this field. The required 573 attribute is a text string that can have a value of either ‘yes’ 573.a or ‘no’ 573.b, which represents whether or not the field is required to have a value 578 that is not empty.

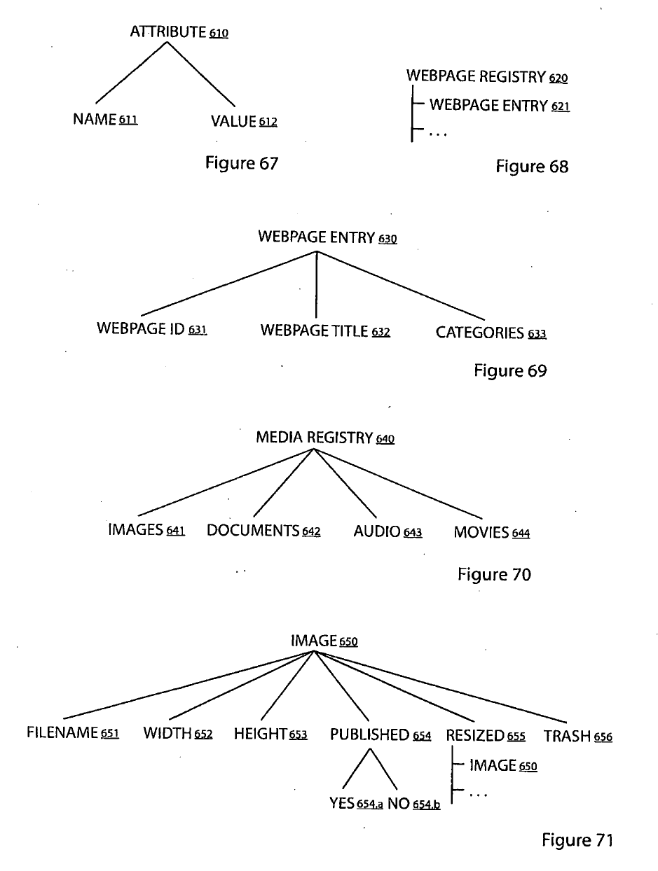

The attributes 574 node contains one or more attributes (see FIG. 67), which contain arbitrary name and value pairs. The data type 577 node is the type of data that this field's value 578 is expected to have. The data type 577 node may contain any value, and it is up to the client application and the XWM application 130 to process this field's value 578 based on its data type 577. If an unrecognized data type 577 is specified, the XWM application 130 and the client application may choose not to validate the field's value 578 or to make other decisions as to how to act on the field's value 578. By allowing any value for the data type 577, developers are given an opportunity to write custom field processing plugins for the XWM application 130 or the client application.

Some of the data types recognized by the XWM application 130 are: (1) integer, a natural number including zero and negatives; (2) float, a string of digits that represent a real number; (3) plain text, an unformatted single line of text (i.e., the text will not be marked up as HTML or other formatting and will not contain breaks or new lines); (4) rich text, a single line of text that supports markup such as HTML; (5) plain text area, one or more lines of text that does not support markup such as HTML; (6) rich text area, one or more lines of text that supports markup such as HTML; (7) CSS font, which describes the properties of a font in such a way that it can be applied to a CSS; (8) CSS background, which describes the properties of a background in such a way that it can be applied to a CSS; (9) CSS padding, which describes padding in such a way that it can be applied to a CSS; (10) CSS margins, which describes margins in such a way that it can be applied to a CSS; and (11) CSS border, which describes the properties of a border in such a way that it can be applied to a CSS.

A field 570 with a CSS font data type does not contain a value 578, but instead uses attributes 574 to describe the font. Attributes 574 include: (a) family, the font family such as verdana or times; (b) size, the size of the font measured in em units; (c) color, a hexadecimal value describing the red-green-blue (RGB) color of the font; (d) weight, the weight of the font such as bold, bolder, lighter or normal; and (e) decoration, extra styles applied to the font such as underline, overline, strikethrough or blink. A field 570 with a CSS background data type does not contain a value 578, but instead uses attributes 574 to describe the background. Attributes 574 include: (a) bgcolor, a hexadecimal value describing the RGB color of the background; (b) bgimage, a URL to an image to be used for the background; and (c) bgposition, the alignment of the background image such as top left, top center, top right, center left, center center, center right, bottom left, bottom center, or bottom right. A field 570 with a CSS padding data type does not contain a value 578, but instead uses attributes 574 to describe the padding. Attributes 574 include: (a) top, the amount of top padding measured in pixels; (b) right, the amount of right padding measured in pixels; (c) bottom, the amount of bottom padding measured in pixels; and (d) left, the amount of left padding measured in pixels. A field 570 with a CSS margins data type does not contain a value 578, but instead uses attributes 574 to describe the margins. Attributes 574 include: (a) top, the size of the top margin measured in pixels; (b) right, the size of the right margin measured in pixels; (c) bottom, the size of the bottom margin measured in pixels; and (d) left, the size of the left margin measured in pixels. A field 570 with a CSS border data type does not contain a value 578, but instead uses attributes 574 to describe the border. Attributes 574 include: (a) color, a hexadecimal value describing the RGB color of the border; (b) size, the thickness of the border measured in pixels; and (c) style, the visual style of the border, such as ‘none’, ‘solid’, ‘dotted’, ‘dashed’, ‘double’, ‘groove’, ‘ridge’, ‘inset’, or ‘outset’. The value 578 node is a text string that contains the value of this field 570.

FIG. 65 is a diagram of the structure of a field set. A field set 590 is an XML-formatted data structure that provides the ability for a block (FIG. 62) to group one or more fields (FIG. 64) or blocks (FIG. 62) together as a single set of related data. A field set is always a member of a block (FIG. 62, notation 555). The field set ID 591 node is a unique ID that is automatically generated and assigned to this field set when the block (FIG. 62) to which this field set belongs is first created. The name 592 node is a text string containing the full title of the field set as defined by the developer who created it. The required 593 attribute is a text string that can have a value of either ‘yes’ 593.a or ‘no’ 593.b, which represents whether or not the field set is required to have a at least one field 595 or block 596 contained within its fields 594.a or blocks 594.b nodes, respectively. The data type 594 node is a text string that may be set to either ‘field’ or ‘block’, which is used to specify whether this field set is composed of fields 595 or blocks 596.

For a field set with a data type (595) of ‘field’, the data type should be the same as a field's 570 data type 577. For a field set with a type 595 of ‘block’, the data type should be the name of a block (FIG. 62) that is defined within the theme definition (FIG. 52) used by the user website (FIG. 51) within which this field set resides.

Notation 595.a fields is an XML node that contains each of the fields 570 that have been added to this field set. This is only applicable for field sets with a type 595 of ‘field’.

Notation 595.b blocks is an XML node that contains each of the blocks (FIG. 62) that have been added to this field set. This is only applicable for field sets with a type 595 of ‘block’.

FIG. 66 is a diagram of the field info data structure. Field info 600 is an XML-formatted data structure that describes the parameters of a field (FIG. 64). A field info data structure is always a member of a field (FIG. 64, reference number 579). The parameters contained within the field info data structure are defined and set by the developer who created the field info data structure and are applied to the field. The label 601 node is a text string that contains the full title to be used for the field. The default value 602 node is a text string that contains the default value to be used for the field when no value is entered by the user. The pattern match 603 node is an optional text string that contains a regular expression pattern that is used to validate the value of the field; if the pattern does not match against the field's value, the value will not be set. The minimum value 604 node is a numeric value that contains the minimum value accepted for the field and is only applicable to fields with numeric data types. The maximum value 605 node is a numeric value that contains the maximum value accepted for the field and is only applicable to fields with numeric data types. The bits 606 node is a numeric value that represents the maximum number of bits that the field's value may use. The accepted values 607 node is a comma-separated text string that contains a list of values that are accepted for the field; if the field's value is not found within the list of accepted values 607, the value will not be set.

FIG. 67 is a diagram of the attribute data structure. An attribute 610 is an XML-formatted data structure that consists of a single name 611 and value 612 pair. The name 611 node is a text string that contains the name of the attribute represented as a text string with no white space or special characters. The value 612 node is a text string that contains the actual value of the attribute.

FIG. 68 is a diagram of the webpage registry data structure. A webpage registry 620 is an XML-formatted data structure that contains zero or more webpage entries 621 (see FIG. 69). The XWM application 130 maintains a webpage registry for each user website (FIG. 51) that contains one webpage entry (FIG. 69) for each webpage (FIG. 59) within the user website (FIG. 51). Each time a webpage (FIG. 59) is created, deleted or updated, the webpage registry is also updated to reflect the changes.

FIG. 69 is a diagram of the webpage entry data structure. A webpage entry 630 is an XML-formatted data structure that represents a single webpage (FIG. 59) within the webpage registry (FIG. 68). The webpage ID 631 node is the unique ID of the webpage (FIG. 59) to which this webpage entry refers. The webpage title 632 node is a text string that contains the full title of the webpage (FIG. 59) to which this entry refers. The categories 633 node is a text string containing a comma-separated list of unique IDs of webpages (FIG. 59) that serve as the parents of the webpage (FIG. 59) to which this webpage entry refers. This allows for a hierarchy of webpages (FIG. 59) to be created and allows each webpage (FIG. 59) to have one or more parent webpages (FIG. 59).

FIG. 70 is a diagram of the media registry data structure. A media registry 640 is an XML-formatted data structure that contains a registry of all files within a user website (FIG. 51) media 362 folder. The XWM 100 application 130 maintains the media registry and includes each file within the user website (FIG. 51) media 362 folder. Any time a file is added or deleted from the website's (FIG. 51) media 362 folder, the media registry is updated by the XWM 100 application 130. Each user website (FIG. 51) may contain files such as images 641, documents 642, audio 643, and movies 644. All files within a user website (FIG. 51) are globally accessible to the website. Files are kept in the user website's (FIG. 51) central media 362 folder and can be referenced and shared by any component of the user website (FIG. 51).

Files are identified, managed and retrieved by their unique filenames. When a new file is added, the XWM 100 application 130 checks to see if the filename is already in use by another file and, if so, will create a new unique filename for the file by appending a numeric sequence onto the filename. Files can be retrieved by client applications 180 via the XWM 100 media retrieval 166 web service 150, which allows, for instance, a client application 180 to display an image from the user website (FIG. 51) to the user within a web browser. The images 641 node contains zero or more image (FIG. 71) entries. The documents 642, audio 643 and movies 644 nodes each contain zero or more file (FIG. 72) entries. All files managed by the XWM application can be assigned tags, which allow files to be searched and filtered. Tags, and the files assigned to them, are stored within the media tags (FIG. 73) file. The XWM application manages the media tags (FIG. 73) file, adding and removing tags and adding and removing media registry filename references from tags.

FIG. 71 is a diagram of the image data structure. An image 650 is an XML-formatted data structure that represents an entry for the media registry's (FIG. 70) images 641 node. The filename node is a text string that contains the filename of the file for this image file as it appears within the user website (FIG. 51) media 362 folder. The width 652 node is a numeric value that is set to the width, in pixels, of the image file that is associated with this image entry. The height 653 node is a numeric value that is set to the height, in pixels, of the image file that is associated with this image entry. The published 654 attribute is a text string that can have a value of either ‘yes’ 654.a or ‘no’ 654.b, which represents whether or not the image has been published to the remote host where the user website (FIG. 51) is published. The resized 655 node contains zero or more image 650 entries for each version of this image that has been sized to different width and height dimensions than this image; one image 650 entry exists for each uniquely sized version of this image. The trash 656 attribute is a numeric value that, if set to ‘1’, signifies that this image has been marked for deletion.

FIG. 72 is a diagram of the file data structure. A file 660 is an XML-formatted data structure that represents an entry for the media registry's (FIG. 70) documents 642, audio 643 or movies 644 nodes. The filename node is a text string that contains the filename of this file as it appears within the user website (FIG. 51) media 362 folder. The published 662 attribute is a text string that can have a value of either ‘yes’ 662.a or ‘no’ 662.b, which represents whether or not the image has been published to the remote host where the user website (FIG. 51) is published. The trash 663 attribute is a numeric value that, if set to ‘1’, signifies that this image has been marked for deletion.

FIG. 73 is a diagram of the structure of the media tags file. Media tags 670 is an XML-formatted file that offers a way to assign keywords or terms (also referred to as “tags”) to files that are present within the media registry. The media tags file contains a registry of each of the tags that has been created for this user website (FIG. 51), as well as each of the media 362 files that has been assigned to each tag. The tags 671 node contains one tag entry (FIG. 74) for each media tag in this user website (FIG. 51).

FIG. 74 is a diagram of the structure of the tag data structure. The tag data structure is an XML-formatted data structure that represents a single tag within the media tags (FIG. 73) file. The tag 680 node has an ID attribute that contains the name of this tag, which is referenced when performing keyword file searches. The search results will contain any filenames 681 listed within each tag 680 node whose ID attribute matches the search term(s). The filename 681 node is a text string that contains the name of the file that is assigned to this tag 680. The filename 681 corresponds to one of the files in the user website's (FIG. 51) media registry 640. Each tag 680 can have multiple filename 681 entries.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A method for creating and editing a website comprising:
(a) providing an extensible website manager application that allows non-technical users to create and edit websites using website components, wherein the website components comprise themes, layouts and blocks;
(b) providing a developer registry of themes, layouts and blocks created by developers and managed by the extensible website manager application;
(e) installing the extensible website manager application on a computer storage medium;
(d) utilizing a web service as an interface between the extensible website manager application and a client application, wherein the client application provides a graphical user interface for the web service;
(e) allowing the non-technical user to add content to a webpage by dragging and dropping content onto the webpage;
(f) allowing the non-technical user to edit content on a webpage using a toolset that is physically located on the webpage itself; and
(g) displaying the webpage to the non-technical user in real time during creation and/or editing of the webpage exactly as it will be displayed to end users after it is published.

2. The method of claim 1, further comprising creating a user website folder and populating it with a registry file, a webpages folder, a media folder, a media registry file, and a media tags file for each new website created by the non-technical user.

3. The method of claim 1, further comprising providing a site tools tool palette that is represented as a movable tool palette on top of other HTML elements within a webpage and is accessible to the user, wherein the site tools tool palette is a dynamic HTML element.

4. The method of claim 3, wherein the site tools tool palette comprises a publish site tool that is used to publish the website.

5. The method of claim 3, wherein each webpage within the website is associated with a set of properties, and wherein the site tools tool palette comprises a page properties tool that retrieves the set of properties for a given webpage and allows the user to edit the webpage properties.

6. The method of claim 5, wherein each webpage property has a data format, and the data format of all of the webpage properties is the same.

7. The method of claim 3, wherein the site tools tool palette comprises a preview page tool that displays the webpage as it will appear after it is published.

8. The method of claim 3, wherein a block is a dynamic HTML element, wherein the webpage comprises panel tools and block tools, wherein the site tools tool palette comprises an add to this page tool that allows the user to add blocks to the webpage by clicking on a block icon and releasing it on a specific portion of the webpage, and wherein the release of the block icon creates an instance of the block within the specific portion of the webpage in which the block icon was released.

9. The method of claim 3, wherein the site tools tool palette comprises a delete this page tool that allows the user to delete the webpage.

10. The method of claim 3, wherein the site tools tool palette comprises a create new page tool that allows the user to create a new webpage.

11. The method of claim 10, wherein the create new page tool comprises a layout chooser that lists layout definitions from which the user selects a layout definition for the website, and wherein the layout definitions are DHTML elements.

12. The method of claim 3, wherein the website comprises multiple webpages, and wherein the site tools tool palette comprises a go to page tool that allows the user to navigate to any webpage within the website.

13. The method of claim 3, wherein the website comprises a set of website properties, and wherein the site tools tool palette comprises a settings tool that allows the user to retrieve and edit the website properties.

14. The method of claim 13, wherein each website property has a data format, and the data format of all of the website properties is the same.

15. The method of claim 14, wherein each webpage within the website is associated with a set of properties, wherein the site tools tool palette comprises a page properties tool that retrieves the set of properties for a given webpage and allows the user to edit the webpage properties, wherein each webpage property has a data format, wherein the data format of all of the webpage properties is the same, and wherein the data format of the webpage properties is the same as the data format of the website properties.

16. The method of claim 13, wherein the website properties are loaded into a properties dialog that allows the user to make changes to and save the website properties.

17. The method of claim 1, further comprising providing an edit tools palette that is represented as a movable tool palette on top of other HTML elements within a webpage and is accessible to the user, wherein the edit tools palette is a dynamic HTML element.

18. The method of claim 17, wherein each webpage comprises one or more blocks, wherein each block comprises properties and field values, and wherein the edit tools palette is used to manage the properties and field values of blocks within a webpage.

19. The method of claim 17, wherein the webpage comprises editable field tools, and when the user clicks a mouse on an editable field tool, the edit tools tool palette becomes active and visible.

20. The method of claim 1, further comprising providing block tool overlays, wherein a block tool overlay is a graphical toolset for managing a block.

21. The method of claim 20, wherein each webpage has a body HTML Document Object Model element, wherein each block corresponds to a block tool, and wherein the block tool overlay is comprised of one or more HTML Document Object Model elements that are created dynamically using Javascript, appended to the webpage's body HTML DOM element, and configured to be positioned over the block tool that corresponds with the block that is managed by the block tool overlay.

22. The method of claim 20, wherein the webpage comprises one or more panels, wherein each block has a structure and appearance, wherein each block has a block definition, wherein each block definition contains files that describe the structure and appearance of a block, wherein each block definition comprise one or more property files, and wherein the property files are imported to any webpage that references the block definition in one or more of its panels.

23. The method of claim 1, wherein each block comprises one or more fields, and wherein each block is associated with a developer-defined render module that communicates to the extensible website manager application how to display the fields of the block on a webpage.

24. The method of claim 1, wherein blocks are stored in webpage files, wherein each block has a component property, wherein if the component property changes from inactive to active, then the block is moved from the webpage file to a website file and becomes a component, wherein a block instance is created and stored in the webpage file where the block was stored before it was moved to the website file, and wherein the block instance references the component that was used to the webpage file.

25. The method of claim 24, wherein the component appears on every page of the website in the form of a block instance.

26. The method of claim 1, wherein at least one block comprises a field, wherein the field appears on a webpage, wherein the field comprises a css attribute, wherein the css attribute references a CSS property with a value,
further comprising providing a toolset that allows the user to change the value of the CSS property, thereby causing the webpage on which the field appears to change in real time to reflect the value assigned by the user to the CSS property.

27. A system for creating and editing a website comprising:
(a) an extensible website manager application that allows non-technical users to create and edit websites using website components, wherein the website components comprise themes, layouts and blocks, and wherein the extensible website manager application is installed on a computer storage medium;
(b) a developer registry of themes, layouts and blocks created by developers and managed by the extensible website manager application; and
(c) a web service that acts as an interface between the extensible website manager application and a client application, wherein the client application provides a graphical user interface for the web service;
wherein the non-technical user adds content to a webpage by dragging and dropping content onto the webpage;
wherein the non-technical user edits content on a webpage using a toolset that is physically located on the webpage itself; and
wherein the webpage is displayed to the non-technical user in real time during creation and/or editing of the webpage exactly as it will be displayed to end users after it is published.

28. The system of claim 27, further comprising a user website folder that is populated with a registry file, a webpages folder, a media folder, a media registry file, and a media tags file for each new website created by the non-technical user.

29. The system of claim 27, further comprising a site tools tool palette that is represented as a movable tool palette on top of other HTML elements within a webpage and is accessible to the user, wherein the site tools tool palette is a dynamic HTML element.

30. The system of claim 29, wherein the site tools tool palette comprises a publish site tool that is used to publish the website.

31. The system of claim 29, wherein each webpage within the website is associated with a set of properties, and wherein the site tools tool palette comprises a page properties tool that retrieves the set of properties for a given webpage and allows the user to edit the webpage properties.

32. The system of claim 31, wherein each webpage property has a data format, and the data format of all of the webpage properties is the same.

33. The system of claim 29, wherein the site tools tool palette comprises a preview page tool that displays the webpage as it will appear after it is published.

34. The system of claim 29, wherein a block is a dynamic HTML element, wherein the webpage comprises panel tools and block tools, wherein the site tools tool palette comprises an add to this page tool that allows the user to add blocks to the webpage by clicking on a block icon and releasing it on a specific portion of the webpage, and wherein the release of the block icon creates an instance of the block within the specific portion of the webpage in which the block icon was released.

35. The system of claim 29, wherein the site tools tool palette comprises a delete this page tool that allows the user to delete the webpage.

36. The system of claim 29, wherein the site tools tool palette comprises a create new page tool that allows the user to create a new webpage.

37. The system of claim 36, wherein the create new page tool comprises a layout chooser that lists layout definitions from which the user selects a layout definition for the website, and wherein the layout definitions are DHTML elements.

38. The system of claim 29, wherein the website comprises multiple webpages, and wherein the site tools tool palette comprises a go to page tool that allows the user to navigate to any webpage within the website.

39. The system of claim 29, wherein the website comprises a set of website properties, and wherein the site tools tool palette comprises a settings tool that allows the user to retrieve and edit the website properties.

40. The system of claim 39, wherein each website property has a data format, and the data format of all of the website properties is the same.

41. The system of claim 40, wherein each webpage within the website is associated with a set of properties, wherein the site tools tool palette comprises a page properties tool that retrieves the set of properties for a given webpage and allows the user to edit the webpage properties, wherein each webpage property has a data format, wherein the data format of all of the webpage properties is the same, and wherein the data format of the webpage properties is the same as the data format of the website properties.

42. The system of claim 39, wherein the website properties are loaded into a properties dialog that allows the user to make changes to and save the website properties.

43. The system of claim 27, further comprising an edit tools palette that is represented as a movable tool palette on top of other HTML elements within a webpage and is accessible to the user, wherein the edit tools palette is a dynamic HTML element.

44. The system of claim 43, wherein each webpage comprises one or more blocks, wherein each block comprises properties and field values, and wherein the edit tools palette is used to manage the properties and field values of blocks within a webpage.

45. The system of claim 43, wherein the webpage comprises editable field tools, and when the user clicks a mouse on an editable field tool, the edit tools tool palette becomes active and visible.

46. The system of claim 27 further comprising one or more block tool overlays, wherein a block tool overlay is a graphical toolset for managing a block.

47. The system of claim 46, wherein each webpage has a body HTML Document Object Model element, wherein each block corresponds to a block tool, and wherein the block tool overlay is comprised of one or more HTML Document Object Model elements that are created dynamically using Javascript, appended to the webpage's body HTML DOM element, and configured to be positioned over the block tool that corresponds with the block that is managed by the block tool overlay.

48. The system of claim 46, wherein the webpage comprises one or more panels, wherein each block has a structure and appearance, wherein each block has a block definition, wherein each block definition contains files that describe the structure and appearance of a block, wherein each block definition comprise one or more property files, and wherein the property files are imported to any webpage that references the block definition in one or more of its panels.

49. The system of claim 27, wherein each block comprises one or more fields, and wherein each block is associated with a developer-defined render module that communicates to the extensible website manager application how to display the fields of the block on a webpage.

50. The system of claim 27, wherein blocks are stored in webpage files, wherein each block has a component property, wherein if the component property changes from inactive to active, then the block is moved from the webpage file to a website file and becomes a component, wherein a block instance is created and stored in the webpage file where the block was stored before it was moved to the website file, and wherein the block instance references the component that was used to the webpage file.

51. The system of claim 50, wherein the component appears on every page of the website in the form of a block instance.

52. The system of claim 27, wherein at least one block comprises a field, wherein the field appears on a webpage, wherein the field comprises a css attribute, wherein the css attribute references a CSS property with a value,
further comprising a toolset that allows the user to change the value of the CSS property, thereby causing the webpage on which the field appears to change in real time to reflect the value assigned by the user to the CSS property.

53. A computer program for creating and editing a website comprising:
(a) an extensible website manager application that allows nontechnical users to create and edit websites using website components, wherein the website components comprise themes, layouts and blocks, and wherein the extensible website manager application is installed on a computer storage medium;
(b) a developer registry of themes, layouts and blocks created by developers and managed by the extensible website manager application; and
(c) a web service that acts as an interface between the extensible website manager application and a client application, wherein the client application provides a graphical user interface for the web service;
wherein the non-technical user adds content to a webpage by dragging and dropping content onto the webpage;
wherein the non-technical user edits content on a webpage using a toolset that is physically located on the webpage itself; and
wherein the webpage is displayed to the non-technical user in real time during creation and/or editing of the webpage exactly as it will be displayed to end users after it is published.

54. The computer program of claim 53, further comprising a user website folder that is populated with a registry file, a webpages folder, a media folder, a media registry file, and a media tags file for each new website created by the non-technical user.

55. The computer program of claim 53, further comprising a site tools tool palette that is represented as a movable tool palette on top of other HTML elements within a webpage and is accessible to the user, wherein the site tools tool palette is a dynamic HTML element.

56. The computer program of claim 55, wherein the site tools tool palette comprises a publish site tool that is used to publish the website.

57. The computer program of claim 55, wherein each webpage within the website is associated with a set of properties, and wherein the site tools tool palette comprises a page properties tool that retrieves the set of properties for a given webpage and allows the user to edit the webpage properties.

58. The computer program of claim 57, wherein each webpage property has a data format, and the data format of all of the webpage properties is the same.

59. The computer program of claim 55, wherein the site tools tool palette comprises a preview page tool that displays the webpage as it will appear after it is published.

60. The computer program of claim 55, wherein a block is a dynamic HTML element, wherein the webpage comprises panel tools and block tools, wherein the site tools tool palette comprises an add to this page tool that allows the user to add blocks to the webpage by clicking on a block icon and releasing it on a specific portion of the webpage, and wherein the release of the block icon creates an instance of the block within the specific portion of the webpage in which the block icon was released.

61. The computer program of claim 55, wherein the site tools tool palette comprises a delete this page tool that allows the user to delete the webpage.

62. The computer program of claim 55, wherein the site tools tool palette comprises a create new page tool that allows the user to create a new webpage.

63. The computer program of claim 62, wherein the create new page tool comprises a layout chooser that lists layout definitions from which the user selects a layout definition for the website, and wherein the layout definitions are DHTML elements.

64. The computer program of claim 55, wherein the website comprises multiple webpages, and wherein the site tools tool palette comprises a go to page tool that allows the user to navigate to any webpage within the website.

65. The computer program of claim 55, wherein the website comprises a set of website properties, and wherein the site tools tool palette comprises a settings tool that allows the user to retrieve and edit the website properties.

66. The computer program of claim 65, wherein each website property has a data format, and the data format of all of the website properties is the same.

67. The computer program of claim 66, wherein each webpage within the website is associated with a set of properties, wherein the site tools tool palette comprises a page properties tool that retrieves the set of properties for a given webpage and allows the user to edit the webpage properties, wherein each webpage property has a data format, wherein the data format of all of the webpage properties is the same, and wherein the data format of the webpage properties is the same as the data format of the website properties.

68. The computer program of claim 65, wherein the website properties are loaded into a properties dialog that allows the user to make changes to and save the website properties.

69. The computer program of claim 53, further comprising an edit tools palette that is represented as a movable tool palette on top of other HTML elements within a webpage and is accessible to the user, wherein the edit tools palette is a dynamic HTML element.

70. The computer program of claim 69, wherein each webpage comprises one or more blocks, wherein each block comprises properties and field values, and wherein the edit tools palette is used to manage the properties and field values of blocks within a webpage.

71. The computer program of claim 69, wherein the webpage comprises editable field tools, and when the user clicks a mouse on an editable field tool, the edit tools tool palette becomes active and visible.

72. The computer program of claim 53 further comprising one or more block tool overlays, wherein a block tool overlay is a graphical toolset for managing a block.

73. The computer program of claim 72, wherein each webpage has a body HTML Document Object Model clement, wherein each block corresponds to a block tool, and wherein the block tool overlay is comprised of one or more HTML Document Object Model elements that are created dynamically using Javascript, appended to the webpage's body HTML DOM element, and configured to be positioned over the block tool that corresponds with the block that is managed by the block tool overlay.

74. The computer program of claim 72, wherein the webpage comprises one or more panels, wherein each block has a structure and appearance, wherein each block has a block definition, wherein each block definition contains files that describe the structure and appearance of a block, wherein each block definition comprise one or more property files, and wherein the property files are imported to any webpage that references the block definition in one or more of its panels.

75. The computer program of claim 53, wherein each block comprises one or more fields, and wherein each block is associated with a developer-defined render module that communicates to the extensible website manager application how to display the fields of the block on a webpage.

76. The computer program of claim 53, wherein blocks are stored in webpage files, wherein each block has a component property, wherein if the component property changes from inactive to active, then the block is moved from the webpage file to a website file and becomes a component, wherein a block instance is created and stored in the webpage file where the block was stored before it was moved to the website file, and wherein the block instance references the component that was used to the webpage file.

77. The computer program of claim 76, wherein the component appears on every page of the website in the form of a block instance.

78. The computer program of claim 53, wherein at least one block comprises a field, wherein the field appears on a webpage, wherein the field comprises a css attribute, wherein the css attribute references a CSS property with a value, further comprising a toolset that allows the user to change the value of the CSS property, thereby causing the webpage on which the field appears to change in real time to reflect the value assigned by the user to the CSS property.
